(19) United States
(12) Patent Application Publication
(10) Pub. No.: US 2024/0306648 A1
(43) Pub. Date: Sep. 19, 2024

(54) MICROALGAE AND MYCORRHIZAE-BASED PLANT NUTRITION COMPOSITIONS

(71) Applicant: AE Agribiologicals S.L., Madrid (ES)

(72) Inventors: Douglas Ry WAGNER, Pleasant Hill, OR (US); Fabricio BENATTI, Sao Paulo (BR)

(21) Appl. No.: 18/673,088

(22) Filed: May 23, 2024

Related U.S. Application Data
(63) Continuation of application No. PCT/EP2022/083066, filed on Nov. 23, 2022.
(60) Provisional application No. 63/283,165, filed on Nov. 24, 2021.
(60) Provisional application No. 63/353,931, filed on Jun. 21, 2022.

(51) Int. Cl. A01N 63/30; A01N 25/12; A01N 65/03; A01P 21/00

(52) U.S. Cl. CPC A01N 63/30; A01N 25/12; A01N 65/03; A01P 21/00

(57) ABSTRACT

The present disclosure relates to novel granule compositions and seed coatings comprising microalgae and mycorrhizae components. The compositions are used to improve a growing parameter, production parameter, and/or biostimulant parameter of an agricultural crop. The compositions can be used to decrease the level of exogenous macronutrient supplementation applied to agricultural crops.

### CROSS-REFERENCE TO RELATED APPLICATIONS

This application claims the benefit of and priority to U.S. Provisional Patent Application No. 63/283,165, filed on Nov. 24, 2021 and U.S. Provisional Patent Application No. 63/353,931, filed on Jun. 21, 2022, the contents of each of which are herein incorporated by reference in their entireties.

### FIELD OF THE DISCLOSURE

The present disclosure relates to agricultural compositions for use in improving one or more growing parameters, production parameters, and/or biostimulant parameters of a host plant, e.g., an agricultural crop. The agricultural compositions comprise microalgae-derived components and mycorrhizal fungi in granules and seed coatings. The compositions may be used to decrease reliance on exogenous nitrogen and/or phosphorous supplementation.

### BACKGROUND

With ever-increasing demands for the production of food crops, a growing global concern is the ability to produce sufficient volumes and quality of food to meet the needs of increasing populations sustainably and efficiently. To meet these demands, intensive agricultural practices to date have included the use of high-yielding, disease-resistant crop varieties, and the constant input of agrochemicals such as chemical fertilizers and pesticides. The application of such chemicals can adversely affect the dynamic equilibrium of the soil, detriment the environment, and decrease agricultural biodiversity by destroying useful microorganisms that provide critical nutrition and active natural compounds to promote crop growth and development.

There is a growing and unmet need for powerful, sustainable solutions for improving agricultural crop performance.

### BRIEF SUMMARY

In one aspect, the present disclosure provides an agricultural granule composition, comprising: a) microalgae: b) mycorrhizae: and c) a carrier granule.

In some embodiments, the composition comprises multiple species of microalgae.

In some embodiments, the composition comprises microalgae from a phylum selected from the list consisting of: Chlorophyta, Cryptophyta, Cyanophyta, Euglenophyta, Heterokontophyta, or Rhodophyta.

In some embodiments, the composition comprises microalgae from a genus selected from the list consisting of: Chlorella, Scenedesmus, Nannochloropsis, Muriellopsis, Isochrysis, Tisochrysis, Desmodesmus, Haematococcus, Arthrospira, and Anabaena.

In some embodiments, the microalgae are dried and/or lysed.

In some embodiments, the composition comprises microalgae in the form of a digested microalgae solution (“DMS”) or whole-cell microalgae powder (“WCMP”). In some embodiments, the composition comprises about 0.5% to 5.0% w/w DMS.

In some embodiments, the composition comprises about 0.5% to 5.0% w/w DMS, and wherein the DMS comprises about 5% to 15% w/w dry matter.

In some embodiments, the dry weight of the composition comprises about 0.05% to 5% w/w microalgae dry matter.

In some embodiments, the dry weight of the composition comprises about 0.5-5.0% w/w mycorrhizae.

In some embodiments, the mycorrhizae comprise 100-10,000 spores/gram.

In some embodiments, the composition comprises 500-500,000 spores of mycorrhizae per kg of composition.

In some embodiments, the mycorrhizae comprise a combination of ectomycorrhizae and endomycorrhizae.

In some embodiments, the mycorrhizae comprise predominantly endomycorrhizae.

In some embodiments, the mycorrhizae comprise more than about 90% endomycorrhizae.

In some embodiments, the carrier granule is zeolite or bentonite.

In some embodiments, the carrier granule is zeolite, and wherein the dry weight of the composition comprises greater than 80% w/w zeolite.

In some embodiments, the composition is applied to an agricultural crop.

In some embodiments, the composition is applied to an agricultural crop that is a monocot or a dicot.

In some embodiments, the composition is applied to an agricultural crop selected from the list consisting of agronomical crops, horticultural crops, and ornamental crops.

In some embodiments, application of the composition to an agricultural crop results in an increase in a growth, production, or biostimulant parameter of the agricultural crop in comparison to a control agricultural crop without the composition.

In some embodiments, application of the composition to an agricultural crop results in an increase in a growth, production, or biostimulant parameter of the agricultural crop in comparison to a control agricultural crop without the composition, wherein the application occurs during or soon after planting.

In some embodiments, application of the composition to an agricultural crop results in an increase in a growth, production, or biostimulant parameter of the agricultural crop in comparison to a control agricultural crop without the composition, wherein the parameter is selected from the group consisting of: yield, height, nutrient concentration, and chlorophyl content of leaves.

In some embodiments, application of the composition to an agricultural crop results in an increase in the height of the agricultural crop in comparison to a control agricultural crop without the composition.

In some embodiments, application of the composition to an agricultural crop results in an increase in a nutrient concentration within the agricultural crop in comparison to a control agricultural crop without the composition.

In some embodiments, application of the composition to an agricultural crop results in an increase in a nutrient concentration within the agricultural crop in comparison to a control agricultural crop without the composition, wherein the nutrient is selected from the group consisting of: nitrogen content of leaves, magnesium content of roots, manganese content of roots, copper content of roots, and potassium content of roots.

In some embodiments, the combination of microalgae, mycorrhizae, and zeolite produces a synergistic improvement on a growth, production, or biostimulant parameter of an agricultural crop after application.

In some embodiments, the combination of the microalgae, mycorrhizae, and zeolite components of the compositions produces an improvement on a growth, production, or biostimulant parameter of an agricultural crop after application, wherein the improvement is greater than that observed for any one or two of the components alone.

In one aspect, the present disclosure provides a method for increasing the yield of an agricultural crop, the method comprising: a) applying the composition of the previous embodiments to the agricultural crop.

In one aspect, the present disclosure provides a method for increasing the yield of an agricultural crop, the method comprising: a) applying an agricultural granule composition to the agricultural crop, the composition comprising microalgae, mycorrhizae, and a carrier granule.

In one aspect, the present disclosure provides a method for improving a production, growth, or biostimulant parameter of an agricultural crop, the method comprising: a) applying an agricultural granule composition to the agricultural crop, the composition comprising microalgae, mycorrhizae, and a carrier granule.

In some embodiments, the composition comprises multiple species of microalgae.

In some embodiments, the composition comprises microalgae from a phylum selected from the list consisting of: Chlorophyta, Cryptophyta, Cyanophyta, Euglenophyta, Heterokontophyta, or Rhodophyta.

In some embodiments, the composition comprises microalgae from a genus selected from the list consisting of: Chlorella, Scenedesmus, Nannochloropsis, Muriellopsis, Isochrysis, Tisochrysis, Desmodesmus, Haematococcus, Arthrospira, and Anabaena.

In some embodiments, the microalgae are dried and/or lysed.

In some embodiments, the composition comprises microalgae in the form of a digested microalgae solution (“DMS”) or whole-cell microalgae powder.

In some embodiments, the composition comprises about 0.5% to 5.0% w/w DMS.

In some embodiments, the composition comprises about 0.5% to 5.0% w/w DMS, and wherein the DMS comprises about 5% to 15% w/w dry matter.

In some embodiments, the dry weight of the composition comprises about 0.05% to 0.5% w/w microalgae dry matter.

In some embodiments, the dry weight of the composition comprises about 0.5-5.0% w/w mycorrhizae.

In some embodiments, the mycorrhizae comprise 100-10,000 spores/gram.

In some embodiments, the composition comprises 500-500,000 spores of mycorrhizae per kg of composition.

In some embodiments, the mycorrhizae comprise a combination of ectomycorrhizae and endomycorrhizae.

In some embodiments, the mycorrhizae comprise predominantly endomycorrhizae.

In some embodiments, the mycorrhizae comprise more than about 90% endomycorrhizae.

In some embodiments, the carrier granule is zeolite or bentonite.

In some embodiments, the dry weight of the composition comprises greater than 80% w/w carrier granule.

In some embodiments, the agricultural crop is a monocot or a dicot.

In some embodiments, the agricultural crop is selected from the list consisting of agronomical crops, horticultural crops, and ornamental crops.

In some embodiments, application of the composition to the agricultural crop results in an increase in a growth, production, or biostimulant parameter of the agricultural crop in comparison to a control agricultural crop without the composition.

In some embodiments, application of the composition to the agricultural crop results in an increase in a growth, production, or biostimulant parameter of the agricultural crop in comparison to a control agricultural crop without the composition, wherein the application occurs during or soon after planting.

In some embodiments, application of the composition to the agricultural crop results in an increase in a growth, production, or biostimulant parameter of the agricultural crop in comparison to a control agricultural crop without the composition, wherein the parameter is selected from the group consisting of: yield, height, nutrient concentration, and chlorophyl content of leaves.

In some embodiments, application of the composition to the agricultural crop results in an increase in the height of the agricultural crop in comparison to a control agricultural crop without the composition.

In some embodiments, application of the composition to the agricultural crop results in an increase in a nutrient concentration within the agricultural crop in comparison to a control agricultural crop without the composition.

In some embodiments, application of the composition to the agricultural crop results in an increase in a nutrient concentration within the agricultural crop in comparison to a control agricultural crop without the composition, wherein the nutrient is selected from the group consisting of: nitrogen content of leaves, magnesium content of roots, manganese content of roots, copper content of roots, and potassium content of roots.

In some embodiments, the combination of microalgae, mycorrhizae, and zeolite produces a synergistic improvement on a growth, production, or biostimulant parameter of the agricultural crop after application.

In some embodiments, the combination of the microalgae, mycorrhizae, and zeolite components of the compositions produces an improvement on a growth, production, or biostimulant parameter of the agricultural crop after application, wherein the improvement is greater than that observed for any one or two of the components alone.

In some embodiments, the composition is applied to the soil around the agricultural crop.

In some embodiments, the composition is applied to the soil around the agricultural crop via mechanized and/or hand broadcast.

In some embodiments, the composition is applied to the soil around the agricultural crop at a rate of about 5-15 kg/ha or about 100,000-2,000,000 mycorrhizae spores/ha.

In one aspect, the present disclosure provides a powdered microbial seed coating composition, comprising: a) microalgae: and b) mycorrhizae and/or Rhizobium.

In some embodiments, the composition comprises multiple species of microalgae.

In some embodiments, the composition comprises microalgae from a phylum selected from the list consisting of: Chlorophyta, Cryptophyta, Cyanophyta, Euglenophyta, Heterokontophyta, or Rhodophyta.

In some embodiments, the composition comprises microalgae from a genus selected from the list consisting of: Chlorella, Scenedesmus, Nannochloropsis, Muriellopsis, Isochrysis, Tisochrysis, Desmodesmus, Haematococcus, Arthrospira, and Anabaena. In some embodiments, the microalgae are dried and ground.

In some embodiments, the microalgae comprises whole-cell microalgae powder.

In some embodiments, the microalgae comprises whole-cell microalgae powder having an average particle size of about 100-1,000 microns.

In some embodiments, the composition comprises about 10-90% w/w microalgae.

In some embodiments, the composition comprises about 80% w/w microalgae.

In some embodiments, the mycorrhizae comprise a combination of ectomycorrhizae and endomycorrhizae.

In some embodiments, the mycorrhizae comprise predominantly endomycorrhizae.

In some embodiments, the mycorrhizae comprise more than about 90% endomycorrhizae.

In some embodiments, the composition comprises about 10-90% w/w mycorrhizae.

In some embodiments, the composition comprises about 20% w/w mycorrhizae.

In some embodiments, the mycorrhizae comprise 100-10,000 spores/gram.

In some embodiments, the composition comprises about 10-9,000 spores of mycorrhizae per gram of composition.

In some embodiments, the mass ratio of microalgae to mycorrhizae is about 2:1, 3:1, 4:1, or 5:1.

In some embodiments, the mass ratio of microalgae to mycorrhizae is about 4:1.

In some embodiments, the composition comprises a diazotrophic bacterium.

In some embodiments, the composition comprises a bacterium of the genus Anabaena, Azoarcus, Azorhizobium, Azospirillum, Azotobacter, Bacillus, Bradyrhizobium, Burkholderia, Clostridium, Frankia, Gluconacetobacter, Herbaspirillum, Klebsiella, Mesorhizobium, Nitrosospira, Nostoc, Paenibacillus, Parasponia, Pseudomonas, Rhizobium, Rhodobacter, Sinorhizobium, Spirillum, or Xanthomonus.

In some embodiments, the composition comprises a bacterium of the genus Azospirillum, Rhizobium, or Bradyrhizobium.

In some embodiments, the composition comprises a bacterium of the species Bradyrhizobium japonicum.

In some embodiments, the composition comprises a binder.

In some embodiments, the composition comprises a binder, and wherein the binder is a hydrocolloid binder.

In some embodiments, the composition comprises a binder, and wherein the binder comprises about 10-30% of the composition.

In some embodiments, application of the composition to a seed of an agricultural crop prior to planting improves the agricultural crop's survival against abiotic stress.

In some embodiments, application of the composition to a seed of an agricultural crop prior to planting improves the agricultural crop's survival against abiotic stress, and wherein the abiotic stress is selected from temperature stress, water stress, and salt stress.

In some embodiments, application of the composition to a seed of an agricultural crop prior to planting improves a growing parameter, production parameter, or biostimulant parameter of the agricultural crop.

In some embodiments, application of the composition to a seed of an agricultural crop prior to planting improves a growing parameter, production parameter, or biostimulant parameter of the agricultural crop, and wherein the parameter is selected from the list consisting of: biomass, number of roots, root mass, number of secondary roots, uniformity of flowering, yield, productivity, chlorophyl content, carotenoid profile, water absorption capacity, nutrient absorption, and degree of inoculation by diazotrophic bacteria.

In some embodiments, the composition is comprised as a coating on a seed from an agricultural crop.

In some embodiments, the composition is comprised as a coating on a seed from an agricultural crop, and wherein the agricultural crop is a monocot or dicot.

In some embodiments, the composition is comprised as a coating on a seed from an agricultural crop, and wherein the agricultural crop is an agronomical crop, horticultural crop, or ornamental plant.

In one aspect, the present disclosure provides a seed of an agricultural crop comprising a composition according to any one of the previous embodiments.

In one aspect, the present disclosure provides a method for increasing the yield of an agricultural crop, the method comprising: a) applying the composition of the previous embodiments to a seed of the agricultural crop prior to planting.

In one aspect, the present disclosure provides a method for increasing the yield of an agricultural crop, the method comprising: a) applying a powdered microbial seed coating composition to a seed of the agricultural crop before planting, wherein the composition comprises microalgae and mycorrhizae.

In one aspect, the present disclosure provides a method for improving a production, growth, or biostimulant parameter of an agricultural crop, the method comprising: a) applying a powdered microbial seed coating composition to a seed of the agricultural crop before planting, wherein the composition comprises microalgae and mycorrhizae.

In some embodiments, the composition comprises multiple species of microalgae.

In some embodiments, the composition comprises microalgae from a phylum selected from the list consisting of: Chlorophyta, Cryptophyta, Cyanophyta, Euglenophyta, Heterokontophyta, or Rhodophyta.

In some embodiments, the composition comprises microalgae from a genus selected from the list consisting of: Chlorella, Scenedesmus, Nannochloropsis, Muriellopsis, Isochrysis, Tisochrysis, Desmodesmus, Haematococcus, Arthrospira, and Anabaena.

In some embodiments, the microalgae are dried and ground.

In some embodiments, the microalgae comprises whole-cell microalgae powder.

In some embodiments, the microalgae comprises whole-cell microalgae powder having an average particle size of about 100-1,000 microns.

In some embodiments, the composition comprises about 10-90% w/w microalgae.

In some embodiments, the composition comprises about 80% w/w microalgae.

In some embodiments, the mycorrhizae comprise a combination of ectomycorrhizae and endomycorrhizae.

In some embodiments, the mycorrhizae comprise predominantly endomycorrhizae.

In some embodiments, the mycorrhizae comprise more than about 90% endomycorrhizae.

In some embodiments, the composition comprises about 10-90% w/w mycorrhizae.

In some embodiments, the composition comprises about 20% w/w mycorrhizae.

In some embodiments, the mycorrhizae comprise 100-10,000 spores/gram.

In some embodiments, the composition comprises about 10-9,000 spores of mycorrhizae per gram of composition.

In some embodiments, the mass ratio of microalgae to mycorrhizae is about 2:1, 3:1, 4:1, or 5:1.

In some embodiments, the mass ratio of microalgae to mycorrhizae is about 4:1.

In some embodiments, the composition comprises a diazotrophic bacterium.

In some embodiments, the composition comprises a bacterium of the genus Anabaena, Azoarcus, Azorhizobium, Azospirillum, Azotobacter, Bacillus, Bradyrhizobium, Burkholderia, Clostridium, Frankia, Gluconacetobacter, Herbaspirillum, Klebsiella, Mesorhizobium, Nitrosospira, Nostoc, Paenibacillus, Parasponia, Pseudomonas, Rhizobium, Rhodobacter, Sinorhizobium, Spirillum, or Xanthomonus.

In some embodiments, the composition comprises a bacterium of the genus Azospirillum, Rhizobium, or Bradyrhizobium.

In some embodiments, the composition comprises a bacterium of the species Bradyrhizobium japonicum.

In some embodiments, the composition comprises a binder.

In some embodiments, the composition comprises a binder, and wherein the binder is a hydrocolloid binder.

In some embodiments, the composition comprises a binder, and wherein the binder comprises about 10-30% of the composition.

In some embodiments, the method improves the agricultural crop's survival against abiotic stress.

In some embodiments, the method improves the agricultural crop's survival against abiotic stress, and wherein the abiotic stress is selected from temperature stress, water stress, and salt stress.

In some embodiments, the method improves a growing parameter, production parameter, or biostimulant parameter of the agricultural crop.

In some embodiments, the method improves a growing parameter, production parameter, or biostimulant parameter of the agricultural crop, and wherein the parameter is selected from the list consisting of: biomass, number of roots, root mass, number of secondary roots, uniformity of flowering, yield, productivity, chlorophyl content, carotenoid profile, water absorption capacity, nutrient absorption, and degree of inoculation by diazotrophic bacteria.

In some embodiments, the agricultural crop is a monocot or dicot.

In some embodiments, the agricultural crop is an agronomical crop, horticultural crop, or ornamental plant.

In some embodiments, the method comprises applying about 50-200 g of the composition per quantity of seeds to be planted in one hectare.

In some embodiments, the method comprises applying an amount of composition sufficient to deliver about 1,000 to 1,000,000 spores per quantity of seeds to be planted in one hectare.

In some embodiments, the method increases a production, growth, or biostimulant parameter is selected from the list consisting of: biomass, number of roots, root mass, number of secondary roots, uniformity of flowering, yield, productivity, chlorophyl content, carotenoid profile, water absorption capacity, nutrient absorption, and degree of inoculation by diazotrophic bacteria.

In some embodiments, the method increases the yield of the agricultural crop.

In some embodiments, the method increases the yield of the agricultural crop compared to a control agricultural crop whose seeds were not treated with the composition prior to planting.

In some embodiments, the method increases the yield of the agricultural crop by 2-20% compared to a control agricultural crop whose seeds were not treated with the composition prior to planting.

### BRIEF DESCRIPTION OF THE SEVERAL VIEWS OF THE DRAWINGS

FIG. 1A shows a nutrient analysis of an illustrative digested microalgae solution (“DMS”) of the disclosure. FIG. 1B shows an image of zeolite granules, e.g., such as those of the present disclosure that are coated with mycorrhizae and DMS microalgae solutions and then dried.

FIG. 2 shows the visual results of a small-scale assay comparing application of combinations of microalgae, mycorrhizae, and zeolite for improving a parameter of an exemplary host plant, leek.

FIG. 3 shows photos with exemplary plant height results after application of different combinations of microalgae, mycorrhizae, and carriers, measured 30 days after application.

FIG. 4 shows averages plant height results 30 days after application of different combinations of microalgae, mycorrhizae, and carriers.

FIG. 5 shows averages plant leaf nitrogen content 30 days after application of different combinations of microalgae, mycorrhizae, and carriers.

FIG. 6 shows root magnesium content 30 days after application of different combinations of microalgae, mycorrhizae, and carriers.

FIG. 7 shows root manganese content 30 days after application of different combinations of microalgae, mycorrhizae, and carriers.

FIG. 8 shows root copper content 30 days after application of different combinations of microalgae, mycorrhizae, and carriers.

FIG. 9 shows root potassium content 30 days after application of different combinations of microalgae, mycorrhizae, and carriers.

FIG. 10A shows increases in hot pepper plant parameters after application of an illustrative granule composition of the disclosure. FIG. 10B shows increases in hot pepper plant parameters after application of a granule composition of the disclosure.

FIG. 11 shows rice yield results at final harvest for different applications of an illustrative granule composition of the present disclosure.

FIG. 12 shows average increases in rice plant parameters after application of an illustrative granule composition of the present disclosure.

FIG. 13A shows a visual comparison between rice plants treated with an illustrative composition of the present disclosure, control untreated plants, and plants treated with commercial fertilizer at Location 1. FIG. 13B shows a visual comparison of rice plant root mass at Location 1. FIG. 13C shows a table documenting results for the number of tillers at Location 1. FIG. 13D shows a table documenting results for the number of tillers at Location 2. FIG. 13E shows a table documenting results for the number of tillers at Location 3.

FIG. 14A shows results for total yield per hectare at Location 1. FIG. 14B shows results for total yield per hectare at Location 2.

FIG. 15A shows results for total yield per hectare. FIG. 15B shows results for average yield.

FIG. 16A shows results for total yield per hectare in Field 1. FIG. 16B shows results for total yield per hectare in Field 2.

FIG. 17A shows results for total yield per hectare in Field 1. FIG. 17B shows results for total yield per hectare in Field 2.

FIG. 18 shows improvements in wheat plant parameters after application of an illustrative granule composition of the present disclosure.

FIG. 19 shows improvements in potato plant parameters after application of an illustrative granule composition of the present disclosure.

FIG. 20A shows pictures comparing soy beans from treated and untreated conditions. FIG. 20B shows a table documenting the weight of soybeans from treated and untreated conditions.

FIG. 21 shows the increase in yield for soy beans that were treated with an illustrative seed coating of the present disclosure.

FIG. 22 shows the increase in yield for corn that was treated with an illustrative seed coating of the present disclosure.

FIG. 23 shows the effect of application of an illustrative composition of the disclosure on grain yield and exogenous phosphorous reliance in rice.

FIG. 24 shows the effect of application of an illustrative composition of the disclosure on grain yield and exogenous nitrogen reliance in rice.

FIG. 25 shows the increase in organic carbon in the soil following application of an illustrative granule composition of the disclosure with decreased reliance on exogenous nitrogen and phosphorous supplementation.

FIG. 26 shows the increase in available nitrogen and phosphorous in the soil following application of an illustrative granule composition of the disclosure, with decreased reliance on exogenous nitrogen and phosphorous supplementation.

FIG. 27A-27D show the results of reduced nitrogen and phosphorous assays in paddy rice. FIG. 27A shows the grain yield: FIG. 27B shows chlorophyl content: FIG. 27C shows available soil nitrogen content: and FIG. 27D shows grain protein content.

FIG. 28 shows an illustrative image of lettuce plants grown in a trial of DAP and MA/Myco granule application: a) Control, b) Chemical, c) 50% Chemical+MA/Myco, d) MA/Myco only.

FIG. 29A-29D show the results of application of an illustrative MA/Myco granule to sugarcane. FIG. 29A shows the cane yield results: FIG. 29B shows CCS results: FIG. 29C shows sugar content: and FIG. 29D shows sucrose content.

FIG. 30A-30C show the results of application of an illustrative MA/Myco granule to paddy rice. FIG. 30A shows the grain yield results: FIG. 30B shows chlorophyl content: and FIG. 30C shows microbial count.

FIG. 31 shows root mass results in soybean with various powdered seed coating treatments comprising Myco, WCMP, or both.

### DETAILED DESCRIPTION

### Definitions

The term “a” or “an” refers to one or more of that entity, i.e. can refer to plural referents. As such, the terms “a,” “an,” “one or more,” and “at least one” are used interchangeably herein. In addition, reference to “an element” by the indefinite article “a” or “an” does not exclude the possibility that more than one of the elements is present, unless the context clearly requires that there is one and only one of the elements.

Throughout this application, the term “about” is used to indicate that a value includes the inherent variation of error for the device or the method being employed to determine the value, or the variation that exists among the samples being measured. Unless otherwise stated or otherwise evident from the context, the term “about” means within 15% above or below the reported numerical value (except where such number would exceed 100% of a possible value or go below 0%). When used in conjunction with a range or series of values, the term “about” applies to the endpoints of the range or each of the values enumerated in the series, unless otherwise indicated. As used in this application, the terms “about” and “approximately” are used as equivalents.

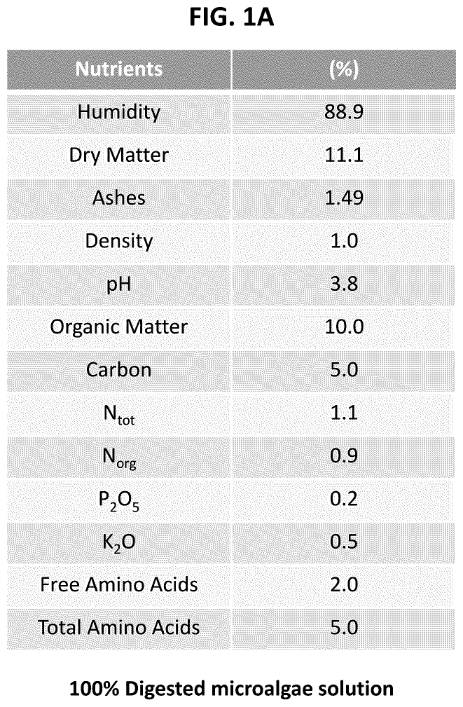

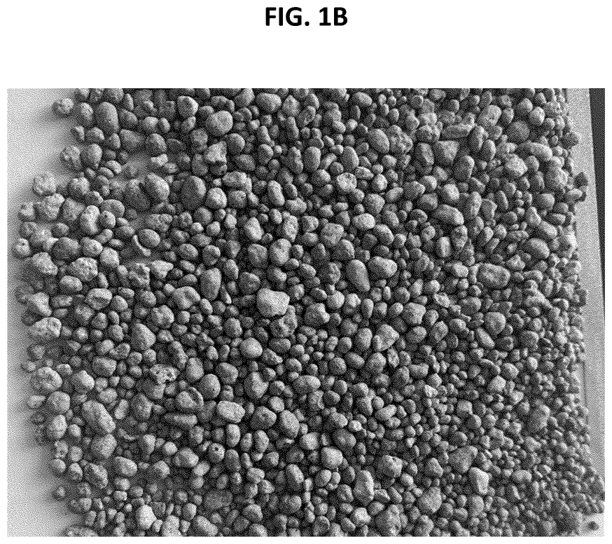

As used herein, “microalgae” are eukaryotic microbial organisms that contain a chloroplast or other plastid, and optionally, are capable of performing photosynthesis and prokaryotic microbial organisms capable of performing photosynthesis. Microalgae include obligate photoautotrophs, which are organisms that use light energy (e.g. from sunlight or other light source) to convert inorganic materials into organic materials for use in cellular functions such as biosynthesis and respiration. Microalgae also include heterotrophs, which can live solely off of a fixed carbon source. Microalgae include unicellular organisms that separate from sister cells shortly after cell division, as well as microbes such as, for example, Volvox, which is a simple multicellular photosynthetic microbe of two distinct cell types. Microalgae also include other microbial photosynthetic organisms that exhibit cell-cell adhesion, such as Agmenellum, Anabaena, and Pyrobotrys. In some embodiments, the microalgae of the present disclosure are selected from the phyla Chlorophyta, Cryptophyta, Cyanophyta, Euglenophyta, Heterokontophyta, and Rhodophyta. In some embodiments, the microalgae of the present disclosure are selected from the genera Chlorella, Scenedesmus, Nannochloropsis, Muriellopsis, Isochrysis, Tisochrysis, Desmodesmus, Haematococcus, Arthrospira, and Anabaena. As used in this description, the term microalgae encompasses any form of microalgae, whether in a natural and unprocessed whole state, dried, extracted, or otherwise processed. In some embodiments, the term “microalgae” is used to refer to a lysed, hydrolyzed. digested, pulverized, or otherwise processed form of microalgae. In some embodiments, microalgae used in the compositions herein has the nutrient analysis depicted in FIG. 1A. In some embodiments, microalgae is not macroalgae. In some embodiments, microalgae as used in the present compositions is not live microalgae.

As used herein, a “composition comprising microalgae” or “microalgae composition” refers to a composition comprising microalgae-derived components. Compositions comprising microalgae according to the present disclosure comprise, e.g., dried whole cell microalgae and/or lysed and digested microalgae. “Whole cell microalgae powder” or “WCMP” refers to microalgae that has been dried and ground after being harvested. “Digested microalgae solution” or “DMS” refers to microalgae that has been dried, ground, and then processed to degrade cell walls and release peptides and other nutrients. DMS can be formulated using chemical, physical, or biological means to degrade cell walls and release peptides. As used herein, “microalgae dry matter” or “dry matter of microalgae” refers to the non-liquid content of a composition comprising microalgae.

As used herein, the terms “mycorrhiza” and “mycorrhizae” refer to mycorrhizal fungi. A mycorrhiza is a mutual symbiotic association between a fungus and a plant and the term is also used herein to refer to the fungus itself. “Ectomycorrhizae” is used to refer to mycorrhizal fungi that colonize host plant root tissues extracellularly. “Endomycorrhizae” is used to refer to mycorrhizal fungi that colonize host plant tissues intracellularly. In some embodiments, the compositions of the present disclosure comprise both ectomycorrhizae and endomycorrhizae. In some embodiments, the compositions of the present disclosure comprise predominantly endomycorrhizae, e.g., more than 90% endomycorrhizae.

As used herein, a “granule” refers to a dry, granular composition having an average diameter of less than about 1 cm for administration to agricultural crops.

As used herein, a “seed coating” refers to a composition applied to the seeds of an agricultural crop before or during planting.

As used herein, an “agricultural crop” refers to any plant that is harvested for commercial purposes. Agricultural crops include agronomic crops, horticultural crops, and ornamental plants. “Agronomic crops” are those that occupy large acreage and are the bases of the world's food and fiber production systems, often mechanized. Examples are wheat, rice, corn, soy bean, alfalfa and forage crops, beans, sugar beets, canola, and cotton. “Horticultural crops” are used to diversify human diets and enhance the living environment. Vegetables, fruits, flowers, ornamentals, and lawn grasses are examples of horticultural crops and are typically produced on a smaller scale with more intensive management than agronomic crops. “Ornamental plants” are grown for decoration and include flowers, shrubs, grasses, and trees. Agricultural crops include both monocots and dicots. Monocots include most of the bulbing plants and grains, including agapanthus, asparagus, bamboo, bananas, corn, daffodils, garlic, ginger, grass, lilies, onions, orchids, rice, sugarcane, tulips, and wheat. Dicots include many garden flowers and vegetables, including legumes, the cabbage family, and the aster family. Examples of dicots are apples, beans, broccoli, carrots, cauliflower, cosmos, daisies, peaches. peppers, potatoes, roses, sweet pea, and tomatoes. Agricultural crops also include food crops, feed crops, cereal crops, oil seed crop, pulses, fiber crops, sugar crops, forage crops, medicinal crops, root crops, tuber crops, vegetable crops, fruit crops, and garden crops. The terms “host plant” and “agricultural crop” are used interchangeably herein.

As used herein, the term “carrier” is intended to include an “agronomically acceptable carrier.” An “agronomically acceptable carrier” is intended to refer to any material which can be used to deliver a composition as described herein, alone or in combination with one or more agriculturally beneficial ingredient(s), and/or biologically active ingredient(s), to a plant. a plant part (e.g., a leaf or a seed), or a soil. In some embodiments, the carrier can be added to the plant, plant part or soil without having an adverse effect on plant growth or soil fitness.

### Compositions Comprising Microalgae and Mycorrhizae

The present disclosure relates to compositions comprising microalgae and mycorrhizae for improving one or more parameters of a host plant. In some embodiments, the compositions comprise dried whole cell or digested microalgae and comprise mycorrhizae, e.g., predominantly endomycorrhizae. In some embodiments, the compositions are granules comprising microalgae and mycorrhizae. In some embodiments, the granules comprise a clay or mineral based carrier. In some embodiments, the compositions are seed coatings comprising microalgae and mycorrhizae. In some embodiments, the seed coatings are powdered seed coatings. The present compositions are based, in part, on the surprising synergy between microalgae-derived components and mycorrhizae for improving plant parameters.

### Microalgae

Within the present compositions, microalgae are eukaryotic microbial organisms that contain a chloroplast or other plastid, and optionally, are capable of performing photosynthesis, and prokaryotic microbial organisms capable of performing photosynthesis. Microalgae may exist individually, or in chains or groups and can range in size from a few micrometers to a few hundred micrometers. Microalgae do not have roots, stems, or leaves. Microalgae capable of performing photosynthesis are important for life on earth: they produce approximately half of the atmospheric oxygen and use simultaneously the greenhouse gas carbon dioxide to grow photoautotrophically. Microalgae, together with bacteria, form the base of the food web and provide energy for all the trophic levels above them. Microalgae biomass is often measured with chlorophyll a concentrations and can provide a useful index of potential production. Microalgae include obligate photoautotrophs, which cannot metabolize a fixed carbon source as energy, as well as heterotrophs, which can live solely off of a fixed carbon source.

The compositions of the present disclosure comprise microalgae. In some embodiments, the compositions comprise microalgae of a phylum selected from the list consisting of: Cyanobacteria, Chlorophyta, Rhodophyta, Bacillariophyta, Cryptophyta, Dinophyta, Euglenozoa, Haptophyta, Ochrophyta, Cyanophyta, Euglenophyta, Heterokontophyta, and Rhodophyta. In some embodiments, the microalgae included in compositions of the present disclosure are selected from the phyla Chlorophyta, Cryptophyta, Cyanophyta, Euglenophyta, Heterokontophyta, and Rhodophyta.

In some embodiments, the microalgae are of a genus selected from the list consisting of: Anabaena, Aphanizomenon, Arthrospira, Auxenochlorella, Botryococcus, Carteria, Chaetoceros, Chlamydomonas, Chlorella, Chlorococcum, Chroomonas, Coccomyxa, Crypthecodinium, Cryptomonas, Cyclotella, Desmodesmus, Dicrateria, Dunaliella, Euglena, Haematococcus, Isochrysis, Microcystis, Micromonas, Monochrysis, Muriellopsis, Nannochloropsis, Navicula, Neochloris, Nitzschia, Nostoc, Olisthodiscus, Phaeodactylum, Pseudoisochrysis, Pyramimonas. Rhodomonas, Scenedesmus, Schizochytrium, Skeletonema, Spirulina, Synechococcus, Tetraselmis, Thalassiosira, Tisochrysis, and Tolypothrix. In some embodiments, the microalgae of the present disclosure are selected from the genera Chlorella, Scenedesmus, Nannochloropsis, Muriellopsis, Isochrysis, Tisochrysis, Desmodesmus, Haematococcus, Arthrospira, and Anabaena. In some embodiments, the compositions of the present disclosure comprise microalgae of a single genus or species. In some embodiments, the compositions of the present disclosure comprise microalgae of a consortia of microalgae genera or species.

Methods for culturing microalgae are known in the art. In some embodiments, the microalgae are grown according to conventional means for culturing microalgae. In some embodiments, initial microalgae strains and inoculum are generated and maintained in small volumes. Microalgae strains and cells intended for inclusion in the compositions can be selected based on the desired nutrient profile. In some embodiments, microalgae are grown through intensive and controlled culture of microalgae using photobioreactors. Photobioreactors allow the passage of light so that photosynthesis can occur while microalgae grow in optimized culture media. Any form of photobioreactor can be used to grow the microalgae of the present disclosure, include flat panel and tubular photobioreactors. Raceways may also be used for culturing microalgae. During microalgae growth, parameters such as pH, temperature, nutrients, dissolved oxygen and carbon dioxide injection can be maintained in order to ensure maximum production rates.

In some embodiments, microalgae are grown until biomass reaches 0.5-5.0 g/L. Microalgae are then harvested. In some embodiments, microalgae biomass is separated from the liquid culture, e.g., by centrifugation, settling, and/or filtration. Following separation of the biomass, the microalgae biomass is processed, in some embodiments, to ensure that microalgae are not living and/or to make available nutrients from within the microalgal cells. For example, in some embodiments, the biomass is dried. In some embodiments, the biomass is baked, dehydrated, dessicated, freeze-dried, and/or exposed to evaporative drying. In some embodiments, the microalgae is ground after drying to achieve a smaller particle size. In some embodiments, the dried microalgae is ground to a size of 1-10,000 microns. In some embodiments, the dried microalgae is ground to a size of 100-1,000 microns. A dried, ground composition of microalgae cells is referred to herein as “whole cell microalgae powder.” In some embodiments, a composition herein comprises 0.1-50 g/L of whole cell microalgae powder. In some embodiments. a composition herein comprises 0.8-20 g/L of whole cell microalgae powder.

In some embodiments, after separation of the biomass of the microalgae cells from the liquid solution, the microalgae is further processed to degrade cell walls and release nutrients, producing a digested microalgae solution or “DMS” of the present disclosure. Microalgae cells can be degraded by physical, mechanical, chemical, enzymatic, or biological means. In some embodiments, microalgae cells are physically disrupted, e.g., using high pressure and/or mechanical lysis. In some embodiments, microalgae cells are chemically disrupted, e.g., using acids. In some embodiments, microalgae cells are biologically disrupted, e.g., using enzymatic processes including proteolysis.

In some embodiments, the DMS has a nutrient profile as shown in FIG. 1A. In some embodiments, humidity, e.g., water content, of DMS is about 75-95% w/w. In some embodiments, humidity is about 90% w/w. In some embodiments, dry matter is about 5-25% w/w: In some embodiments, dry matter is about 10% w/w. In some embodiments, the content of organic matter is about 5-20% w/w. In some embodiments, the content of organic matter is about 10% w/w. In some embodiments, the carbon content is about 1-15% w/w. In some embodiments, the carbon content is about 5% w/w. In some embodiments, the total nitrogen content of DMS is about 0.1-3.0% w/w. In some embodiments, the total nitrogen content of DMS is about 1-1.5% w/w. In some embodiments, the phosphorous content of DMS is about 0.05-0.5% w/w. In some embodiments, the phosphorous content of DMS is about 0.1% w/w. In some embodiments, the P₂O₅ content of DMS is about 0.05-0.5% w/w. In some embodiments, the P₂O₅ content of DMS is about 0.2% w/w. In some embodiments, the potassium content of DMS is about 0.1-1.0% w/w. In some embodiments, the potassium content of DMS is about 0.4% w/w. In some embodiments, the K₂O content of DMS is about 0.1-1.0% w/w. In some embodiments, the K₂O content of DMS is about 0.5% w/w. In some embodiments, the total nitrogen, phosphorous, and potassium (“NPK”) content including the weight of P₂O₅ and K₂O is about 0.5-5.0% w/w. In some embodiments, the total NPK content including the weight of P₂O₅ and K₂O is about 1.8% w/w. In some embodiments, the total amino acid content of DMS is about 1-15% w/w. In some embodiments, the total amino acid content of DMS is about 5% w/w. In some embodiments, the free amino acid content of DMS is 0.1-10% w/w. In some embodiments, the free amino acid content of DMS is about 2% w/w. In some embodiments, the density of DMS is about 1-1.1 g/mL. In some embodiments, the density of DMS is similar to that of water, i.e., around 1 g/mL. In some embodiments, the pH of DMS is acidic or is adjusted to be acidic. In some embodiments, the pH of DMS is or is adjusted to be about pH 3.5-pH 4.5. In some embodiments, the pH of DMS is adjusted to be around pH 6.0-6.5 or to match the pH of a carrier composition.

In some embodiments, the whole cell microalgae powder comprises the same amounts and/or ratios of components as DMS but with significantly less water content. In some embodiments, the whole-cell microalgae powder comprises less than 10% humidity by weight. In some embodiments, the whole-cell microalgae powder comprises less than 5% humidity by weight. In some embodiments, the whole-cell microalgae powder comprises 1-3% w/w humidity.

In some embodiments, the microalgae components of the present compositions comprise proteins, peptides, amino acids, plant hormones, phytohormones, carbohydrates, fatty acids, vitamins, minerals, polysaccharides, carotenoids, pigments, fibers, and other natural nutrients.

In some embodiments, the compositions disclosed herein differ from macroalgae and other biostimulant products in that the disclosed microalgae-derived compositions comprise a richer and more balanced biochemical composition. In some embodiments, the microalgae components of the present compositions provide all the essential free amino acids. In some embodiments, the microalgae components provide micronutrients, macronutrients, polyunsaturated fatty acids, antioxidants, carotenoids, and vitamins, as well as a high content and wide range of phytohormones. In some embodiments, the microalgae components help maintain the organic carbon in the soil and improve nutrient uptake. In some embodiments, the microalgae components provide a complete nutritional package to growing plants and help fight against abiotic stresses, improving the quality of the produce and the marketable yield.

In some embodiments, a composition of the disclosure, e.g., a granule composition, comprises 0.1%-10.0% w/w DMS. In some embodiments, a composition of the disclosure comprises 0.5%-5.0% w/w DMS.

In some embodiments, a composition of the disclosure, e.g., a liquid composition, comprises 10-100% w/w DMS. In some embodiments, a liquid composition comprising DMS is diluted to 0.3%-0.5% v/v in water prior to application.

In some embodiments, in terms of dry matter of microalgae, a composition comprises 0.01%-20% dry matter of microalgae. In some embodiments, in terms of dry matter of microalgae, a composition comprises 0.5%-5% dry matter of microalgae. In some embodiments, in terms of dry matter of microalgae, a composition comprises 0.05%-0.5% dry matter of microalgae. In some embodiments, in terms of dry matter of microalgae, a composition comprises 0.03%-0.05% dry matter of microalgae.

In some embodiments, a composition of the disclosure, e.g., a seed coating, comprises 5-95% w/w whole-cell microalgae powder. In some embodiments, a composition of the disclosure comprises 10-90% w/w whole-cell microalgae powder. In some embodiments, a composition of the disclosure comprises 20-80% w/w whole-cell microalgae powder.

In some embodiments, a composition of the disclosure, e.g., a liquid formulation, comprises 0.1-40 g/L whole-cell microalgae powder. In some embodiments, a composition of the disclosure, e.g., a liquid formulation, comprises 0.8-20 g/L whole-cell microalgae powder.

### Mycorrhizae

A mycorrhiza is a symbiotic association between a fungus and the roots of a vascular plant. As used herein, the terms mycorrhiza and mycorrhizae are also used to refer to the mycorrhizal fungi. This type of association is found in 85% of all plant families in the wild, including many crop species such as grains. In the association between mycorrhizae and plant roots, the fungus colonizes the host plant's roots, either intracellularly or extracellularly. The functional symbiosis provides a suitable and sufficient carbohydrate source for the fungal symbiont. The plant symbiont benefits can be numerous and include improved nutrient and water uptake, additional carbon acquisition, increased sink strength for photosynthate translocation, increased production of phytohormones, improved resistance to pathogens, and heavy metal tolerance. Mycorrhizae are critically important organs for resource uptake by most terrestrial plants. In the absence of an appropriate fungal symbiont, many terrestrial plants suffer from resource limitations and ultimately reduced growth, and poor fitness. Mycorrhizae protect plants from adverse conditions, such as lack of water and nutrients.

Mycorrhizal fungi are commonly divided into “ectomycorrhiza” (the hypha of fungi do not penetrate individual cells with in the root) and “endomycorrhiza” (the hypha of fungi penetrate the cell wall and invaginate the cell membrane). In the case of endomycorrhizae, fungal hyphae grow into the intercellular wall spaces of the cortex and penetrate individual cortical cells. As they extend into the cell, they do not break the plasma membrane or the tonoplast of the host cell. Instead, the hypha is surrounded by these membranes and forms structures known as arbuscules, which participate in nutrient ion exchange between the host plant and the fungus. (Mauseth, 1988). Calculations show that a root associated with mycorrhizal fungi can transport phosphate at a rate more than four times higher than that of a root not associated with mycorrhizae (Nye and Tinker, 1977).

Endomycorrhizae are variable and are further classified as arbuscular, ericoid, arbutoid. monotropoid and orchid mycorhizae. Arbuscular mycorrhizal fungi (“AMF”) are ubiquitous in soil habitats and form beneficial symbiosis with the roots of angiosperms and other plants. AMF are typically associated with the roots of herbaceous plants, but may also be associated with woody plants. AMF are an example of a mycorrhiza that involves entry of the hyphae into the plant root cell walls to produce structures that are either balloon-like (vesicles) or dichotomously-branching invaginations (arbuscules). The fungal hyphae do not in fact penetrate the protoplast (i.e., the interior of the cell), but invaginate the cell membrane. The structure of the arbuscules greatly increases the contact surface area between the hypha and the cell cytoplasm to facilitate the transfer of nutrients between them.

Of the symbiotic associations of plant and fungi, those involving an association between plants and Glomeromycota fungi has the widest distribution in the nature. Arbuscular mycorrhiza fungi inhabit a variety of ecosystems including agricultural lands, forests, grasslands and many stressed environments, and these fungi colonize the roots of most plants, including bryophytes, pteridophytes, gymnosperms and angiosperms. Arbuscular mycorrhizal fungi belong to the family Endogonaceae, of the order Muccorales, of the class Zygomycetes. The arbuscular mycorrhizal forming genera of the family includes Acaulospora, Entrophospora, Gigaspora, Glomus, Sclerocystis and Scutellospora.

In some embodiments, the compositions of the present disclosure comprise both ectomycorrhizae and endomycorrhizae. In some embodiments, the compositions of the present disclosure comprise predominantly endomycorrhizae. In some embodiments, the compositions of the present disclosure comprise more than 50%, 60%, 70%, 80%, or 90% endomycorrhizae as a percentage of overall mycorrhizae content. In some embodiments, the compositions of the present disclosure comprise more than 95% endomycorrhizae as a percentage of overall mycorrhizae content. In some embodiments, only endomycorrhiza are used in the coating mixture, while in some embodiments, a combination of ectomycorrhiza and endomycorrhiza is used. In some embodiments, a mycorrhiza mixture is used in which the mixture contains at least 95 percent, or at least 97 percent endomycorrhiza content and the balance to achieve 100 percent is comprised of ectomycorrhiza content.

In some embodiments, the present compositions comprise arbuscular, ericoid, arbutoid, monotropoid, or orchid mycorrhizae. In some embodiments, the compositions comprise arbuscular mycorrhizal fungi. In some embodiments, the compositions comprise Glomeromycota fungi. In some embodiments, the compositions comprise mycorrhizae of the genus Acaulospora, Entrophospora, Gigaspora, Glomus, Rhizophagus, Sclerocystis or Scutellospora. In some embodiments, the endomycorrhiza content comprises any one of the following species of endomycorrhizal fungi: Rhizophagus Sp., Glomus Sp., Acaulospora Sp., Scutellospora Sp. and Glomus Sp. In some embodiments, the endomycorrhiza content comprises a mixture of the foregoing endomycorrhizal fungi.

In some embodiments, combinations of the foregoing endomycorrhiza are created to produce desired results in plant growth. Rhizophagus Sp. are able to penetrate the cells of the root to form tree-like structures (arbuscular) for the exchange of sugars and nutrients with the host plant and are highly efficient in nutrient-deficient soil. Glomus Sp. obtain carbon from the host plant in exchange for nutrients and other benefits, and help in soil detoxification processes (for example, detoxifying arsenic-laced soils). Examples of Glomus species include Glomus aggregatum, Glomus brasilianum, Glomus clarum, Glomus deserticola, Glomus etunicatum, Glomus fasciculatum, Glomus intraradices, Glomus monosporum, and Glomus mossede. They also improve soil nodulation and nutrient uptake to the plant, increase the surface area for absorption of water, phosphorus, amino acids, and nitrogen, and are more resistant to certain soil-borne diseases. Acaulospora Sp. are able to interact with and change the environment in the favor of the host plants, improving soil structure and quality. Scutellospora Sp. create humic compounds, polysaccharides, and glycoproteins that bind soils, increase soil porosity, and promote aeration and water movement into the soil. Alternatively, yet other versions of endomycorrhizal fungi may be used.

Ectomycorrhizae typically form between the roots of woody plants and fungi belonging to the divisions Basidiomycota, Ascomycota, or Zygomycota. These are external mycorrhizas that form a cover on root surfaces and between the root's cortical cells. Besides the mantle formed by the mycorrhizae, most of the biomass of the fungus is found branching into the soil, with some extending to the apoplast, stopping short of the endodermis. Ectomycorrhizae are found in 10% of plant families, mostly woody species, including the oak, pine, eucalyptus, dipterocarp, and olive families. In some embodiments, the composition comprises ectomycorrhizae. In some embodiments, the ectomycorrhizae are of the phylum Basidiomycota. In some embodiments, the ectomycorrhizae comprise a strain of Laccaria bicolor, Laccaria laccata, Pisolithus tinctorius, Rhizopogon amylopogon, Rhizopogon fulvigleba, Rhizopogon luteolus, Rhizopogon villosuli, Scleroderma cepa, or Scleroderma citrinum. In some embodiments, the ectomycorrhiza content comprises Pisolithus Sp., or others. Such ectomycorrhiza are efficient in uptake of inorganic and organic nutrient resources, and enhance the capability to utilize organic nitrogen sources efficiently. They further create structures that host nitrogen-fixing bacteria that contribute to the amount of nitrogen taken up by plants in nutrient-poor environments. They are also highly nickel-tolerant, and work efficiently in ultramafic soil.

In some embodiments, the mycorrhizae are ericoid mycorrhizae. In some embodiments, the mycorrhizae are of the phylum Ascomycota, such as Hymenoscyphous ericae or Oidiodendron sp. In some embodiments, the mycorrhiza are arbutoid mycorrhizae. In some embodiments, the mycorrhizae are of the phylum Basidiomycota. In some embodiments, the mycorrhizae are monotripoid mycorrhizae. In some embodiments, the mycorrhizae are of the phylum Basidiomycota. In some embodiments, the mycorrhizae are orchid mycorrhiza. In some embodiments, the mycorrhizae are of the genus Rhizoctonia.

The active component of the mycorrhiza may be the spores, hyphae, extramatrix arbuscular mycelium, glomalin and rootlets, colonized by the fungus in question.

In some embodiments, the compositions of the present disclosure comprise a commercially available mycorrhizae powder. In some embodiments, the composition comprises mycorrhizae powder on an inert carrier, such as a sugar, starch, clay-based carrier, mineral-based carrier, or the like.

Mycorrhizal products comprise different elements of mycorrhizae. In some embodiments, products are characterized based on the quantity of infective propagules. Propagules include spores, vesicles, pieces of mycelium, and colonized roots. In some embodiments, the mycorrhizae is quantified in terms of number of spores. In some embodiments, the mycorrhizae has a concentration of 100 to 10,000 infective spores per gram. In some embodiments, the mycorrhizae has a concentration of 300 to 6,000 infective spores per gram. Mycorrhizae may also be quantified based on propagules. In some embodiments, a mycorrhizae composition comprises 50 to 50,000 infectivity propagules per gram. In some embodiments, the mycorrhizae has 80-6,000 infectivity propagules per gram.

In some embodiments, a composition of the disclosure comprises 0.5-5.0% w/w mycorrhizae powder. In some embodiments, a composition of the disclosure comprises about 0.5-500 spores/gram. In some embodiments, a composition of the disclosure comprises about 10-300 spores/gram. In some embodiments, a composition of the disclosure is formulated to comprise 50,000-2,000,000 spores per amount to be distributed to one hectare. For example, in some embodiments where 10 kg of composition are to be distributed per one hectare, the composition comprises 5,000-200,000 spores per kg.

### Diazotrophic Bacteria

The ability of specific bacterial species to promote plant growth has long been recognized. For example, nitrogen-fixing bacteria such as Rhizobium species provide plants with essential nitrogenous compounds. Species of Azotobacter and Azospirillum have also been shown to promote plant growth and increase crop yield, promoting the accumulation of nutrients in plants.

In some embodiments, a composition of the disclosure comprises plant-beneficial bacteria. In some embodiments, the composition comprises nitrogen-fixing, i.e., diazotrophic, bacteria. In some embodiments, the composition comprises symbiotic diazotrophic bacteria. In some embodiments, the composition comprises gram positive or gram negative diazotrophic bacteria.

In some embodiments, a composition of the disclosure comprises a bacterium of the genus Anabaena, Azoarcus, Azorhizobium, Azospirillum, Azotobacter, Bacillus, Bradyrhizobium, Burkholderia, Clostridium, Frankia, Gluconacetobacter, Herbaspirillum, Klebsiella, Mesorhizobium, Nitrosospira, Nostoc, Paenibacillus, Parasponia, Pseudomonas, Rhizobium, Rhodobacter, Sinorhizobium, Spirillum, and Xanthomonus. Additional genera and species of plant beneficial bacteria are known in the art. See, e.g., U.S. Patent Publication Nos. 2014/0256547, 2015/0239789, 2016/0100587, and 2019/0124917, each of which is incorporated by reference herein in its entirety.

In some embodiments, the composition comprises a diazotrophic bacterium of the genus Bacillus, Rhizobium, Bradyrhizobium, or Azospirillum. Examples of species for inclusion in the compositions of the disclosure include: Azospirillum lipoferum, Azospirillum brasilense, Azospirillum amazonense, Azospirillum halopraeferens, Azospirillum irakense, Bacillus itcheniformis, Bacillus megaterium, Bacillus pumilus, Bacillus amyloliquefaciens, Bacillus licheniformis, Bacillus oleronius, Bacillus megaterium, Bacillus mojavensis, Bacillus pumilus, Bacillus subtilis, Bacillus circulans, Bacillus globisporus, Bacillus firmus, Bacillus thuringiensis, Bacillus cereus, Bradyrhizobium japonicum, Bradyrhizobium elkanii, or Bradyrhizobium diazoefficiens, and Rhizobium meliloti. In some embodiments, the composition comprises Bradyrhizobium japonicum.

In some embodiments, a composition of the present disclosure includes a diazotrophic bacterium, i.e., the bacterium is mixed with the microalgae and mycorrhizae. In some embodiments, a composition of the present disclosure is administered alongside a diazotrophic bacterium, i.e., simultaneously with, shortly after, or shortly before administration of the diazotrophic bacterium.

### Carriers

In some embodiments, the composition comprises a solid substrate or carrier. In some embodiments, carrier granules are prepared as a substrate or carrier for the combined solution. In some embodiments, granules are prepared prior to the mixture of the solution, or simultaneous with or after the solution preparation. In some embodiments, the carrier is a natural clay granule or mineral-or organic-based granule. In some embodiments, the carrier is limestone, silica, talc, kaolin, dolomite, calcium sulfate, calcium carbonate, magnesium sulfate, magnesium carbonate, magnesium oxide, diatomaceous earth, zeolite, bentonite, dolomite, leonardite, attapulgite, trehalose, chitosan, shellac, pozzolan, diatomite, or diatomaceous earth, or any combination thereof. In some embodiments, the carrier is a solid substrate formed as granules or extruded pellets of other materials such as synthetic fertilizer.

In some embodiments, the granules have a diameter of about 1-10 mm. In some embodiments, the granules have a diameter of about 2-4 mm.

Natural clay based granules are inert, biodegradable, resistant to attrition due to mixing. and have a neutral pH. Accordingly, in some embodiments, the acidity of a coating solution is matched to that of the carrier prior to coating. Clay granules are available in several size grades from 12/25 mesh to 10/20 & 16/35 mesh (ASTM). A range of carrier sizes are suitable for use in some embodiments of the disclosure.

In some embodiments, the granules are formed from zeolite. Zeolite is a soil conditioner that can control and raise the pH of the soil and improve soil moisture. Synthetic and natural zeolites are hydrated aluminosilicates with symmetrically stacked alumina and silica tetrahedra which result in an open and stable three-dimensional honeycomb structure with a negative charge. The negative charge within the pores is neutralized by positively charged ions (cations) such as sodium. Their aluminosilicate frameworks allows them to be used as cationic exchangers because of their high cation exchange capacity (CEC) due to the presence of trivalent Al atoms in the zeolite framework which induce negative charges that are compensated by the presence of cations. In some embodiments, the zeolite is a natural zeolite. In some embodiments, the zeolite is a synthetic zeolite. In some embodiments, the zeolite is Clinoptilolite.

In some embodiments, the granules are formed from dolomite. Dolomite can be used for soil neutralization to correct acidity. Adding zeolite or dolomite to manure improves the nitrification process. These materials are commonly used as slow release substances for pesticides, herbicides and fungicides. In some embodiments, zeolite or dolomite particles, or combinations of the two, may be used for the carrier granules.

In some embodiments, attapulgite is used as the carrier granule. Attapulgite is a magnesium aluminum phyllosilicate which occurs in a type of clay soil, and it is used as a processing aid and functions as a natural bleaching clay for the purification of vegetable and animal oils. It is available in both colloidal and non-colloidal forms. In some embodiments, attapulgite particles or granules are used as carrier granules in the present compositions.

Leonardite is an oxidation product of lignite coal, mined from near surface pits. Leonardite is a high quality humic material soil conditioner which acts as a natural chelator. It is typically soft, dark colored, and vitreous, containing high concentrations of the active humic acid and fulvic acid. In some embodiments, leonardite is used, alone or in combination with other materials, as a carrier granule.

Bentonite pellets are used in agriculture for soil improvement, livestock feed additives, pesticide carriers, and other purposes. Bentonite mixed with chemical fertilizer can fix ammonia and can act as a buffer for fertilizers. The inherent characteristics of water retention and absorbency makes it an ideal addition to improve the fertility of soil. The prevalence of sandy soil in many regions that suffer from low water and nutrient holding characteristics, can be significantly enhanced by the addition and blending of calcined bentonite. In some embodiments, bentonite, or calcined bentonite, is used as a carrier granule.

In some embodiments, the carrier granules comprise a mix of different materials such as clay, leonardite, attapulgite, zeolite, and/or bentonite.

In some embodiments, the composition comprises more than 50% w/w solid carrier. In some embodiments, the composition comprises more than 70, 80, 90, or 95% w/w solid carrier. In some embodiments, the composition comprises about 80-95% w/w solid carrier.

In some embodiments, the composition comprises a liquid carrier. Non-limiting examples of liquids useful as carriers for compositions disclosed herein include water, an aqueous solution, or a non-aqueous solution. In some embodiments, a carrier is water. In some embodiments, a carrier is an aqueous solution. In some embodiments, a carrier is a non-aqueous solution. For example, in embodiment involving a soil drench, foliar spray, or other liquid composition, suitable liquid carriers include water, buffered water, and oils.

In some embodiments, the composition comprises more than about 90% w/w liquid carrier. In some embodiments, the composition comprises about 95-99.9% w/w liquid carrier. In some embodiments, the composition comprise about 99.5-99.7% w/w liquid carrier.

### Additional Ingredients

In some embodiments, the composition comprises ingredients in addition to microalgae and mycorrhizae components. In some embodiments, the composition comprises an excipient, surfactant, diluent, binder, disintegrant, inert filler, pH stabilizer, spreader, fixative, defoamer, carrier, antimicrobial agent, fertilizer, nutrient composition, pesticide, herbicide, fungicide, insecticide, nematicide, molluscicide, antifreeze agent, antioxidant, preservative, or anti-aggregation agent. One of ordinary skill in the art will appreciate that additional agrochemically acceptable excipients are available for inclusion in the present compositions without departing from the scope of the disclosure. Agriculturally acceptable excipients are commercially manufactured and available through a variety of companies.

In some embodiments, the composition comprises a binder. In some embodiments, the composition comprises a hydrocolloid. In some embodiments, the composition comprises a vinasse, lignosulfonate, cellulose, anhydrite, sugar, starch, or clay.

In some embodiments, the composition is mixed with one of the aforementioned additional ingredients. In some embodiments, the composition is administered at the same time as one of the aforementioned additional ingredients. In some embodiments, the composition is administered shortly before or shortly after one of the aforementioned additional ingredients.

### Exemplary Formulations of the Disclosure

The present disclosure provides agricultural compositions in the form of granules or seed coatings comprising microalgae and mycorrhizae for use in improving one or more plant parameters.

### Methods of Formulating Compositions Comprising Microalgae and Mycorrhizae

The present invention is directed to compositions comprising microalgae and mycorrhizae. The microalgae and mycorrhizae may be combined in the composition by any suitable means. In some embodiments, the composition is a granule formulation comprising 0.5-5.0% w/w DMS and 0.5-5.0% w/w mycorrhizae. In some embodiments, the composition comprises 0.05-0.5% w/w microalgae dry matter. In some embodiments, the composition comprises 0.5-500 mycorrhizae spores/gram.

In some embodiments, the microalgae and mycorrhizae components are suspended in a liquid coating solution before being applied to a granule carrier. The granule carrier may be any of the solid carriers describe herein. In some embodiments, the liquid coating solution comprises water and one or more buffers. In some embodiments, a buffered microalgae solution and a buffered mycorrhizae solution are prepared together. In some embodiments, the buffered solutions are prepared separately. In some embodiments. DMS has an acidic pH, e.g., below pH 4, while mycorrhizae solution has a pH of greater than 7. In some embodiments, to improve the mixing of the mycorrhizal and microalgae components of the composition, without negatively impacting the viability of the mycorrhizae, coating solutions of microalgae and mycorrhizae are prepared separately, adjusted to a similar pH level, then combined with a solid carrier.

In some embodiments, the buffered coating solution comprising microalgae and the buffered coating solution comprising mycorrhizae are combined after separate preparation. The coating solutions may be mixed by any suitable means. In some embodiments, the combined coating solution is mixed using a mixing stirrer in an appropriate vessel. In some embodiments, the ingredients are mixed for between one and thirty minutes using either stirring or agitation.

In some embodiments, the buffered solutions are in the range of pH 5-7. In some embodiments, the buffered solutions are in the range of pH 6.0-6.5. Any suitable buffers may be used for adjusting the pH of the coating solution(s). Examples of suitable buffers include citrate buffer and phosphate buffer. In some embodiments, as needed, an amount of NaOH or HCl or other acids or bases are added to the mycorrhiza solution or the microalgae solution for the purpose of adjusting the pH level of the solutions to the final desired pH level, e.g., in the range of pH 6.0 to 6.5.

In some embodiments, the microalgae and mycorrhizae coating solution(s) are added to the solid carrier granules. In embodiments with separate coating solutions, the coating solutions may be added to the granules one after the other or simultaneously. In some embodiments, the solid carrier granules are dried after application of the coating solution(s). Means of drying the granules include drying at ambient temperature, drying via sunlight, drying via heat lamp, drying via sodium lamp, baking, dessicating, and the like.

In some embodiments, the amount of coating solution, i.e., the amount of buffer and/or water added to the microalgae and mycorrhizae components, is determined based on the moisture capacity of the solid carrier. In some embodiments, the coating solution is 5-20% w/w of the combined weight of the coating solution plus solid carrier. In some embodiments, the amount of liquid coating solution does not exceed the absorbent capacity of the solid carrier. In some embodiments, the solid carrier makes up about 80% to about 95% w/w of the granules.

A coating solution described herein may be added to a carrier granule by any suitable means. In some embodiments, the coating solution(s) are sprayed onto the carrier granules or other desired substrate, e.g., with the use of sprayer nozzles, spray dryers, rotary drums, booth mixing blenders, and the like. Blending of the granules and the coating solution may occur by any suitable means, e.g., tumbling, shaking, or other agitation.

In some embodiments, the granules are dried at ambient temperature or under a heater or dryer, such as a sodium lamp, before packing to avoid any moisture formation in final packed product. In some embodiments, drying occurs for at least 30 minutes and drying reaches a moisture level of 12 percent or less. In order to achieve the 12 percent concentration, in one version the initial moisture concentration of the granule is at six percent or less. Throughout the process, demineralized water may be added as necessary to produce the final moisture concentration level.

Granules may be screened before, during, or after coating to select for granules of a desired particle size. In some embodiments, the granules are screened using one or more mesh screens. After blending, drying, and optional screening, the granules may be transferred to a silo or other storage tank for later packaging, processing, or use.

### Granules

The present disclosure provides agricultural granule compositions comprising microalgae and mycorrhizae. In some embodiments, the composition comprises from about 0.5% to about 5.0% w/w digested microalgae solution (“DMS”). In terms of dry matter, in some embodiments, the composition comprises from about 0.05% to about 0.5% dry matter of microalgae. In some embodiments, the composition comprises up to 5% dry matter of microalgae.

In some embodiments, the granule composition comprises from about 0.5% to about 5.0% w/w mycorrhizae using a powder comprising the mycorrhizae. In some embodiments, the powder comprises 100-10,000 spores/gram. In some embodiments, the granule composition comprises 0.5-500 spores/gram. In some embodiments, the composition comprises 5-500 spores/gram. In some embodiments, the composition comprises 10-300 spores/gram.

In some embodiments, the granule composition is formulated with 0.5-5.0% w/w DMS and 0.5-5.0% mycorrhizae mixed with sufficient quantity of water, e.g., demineralized water, to provide moisture content less than or equal to the absorbent capacity of the solid carrier. In some embodiments, the moisture content is less than or equal to 20%, 15%, 10%, 5% or 1%. For example, in some embodiments, the moisture content is less than or equal to 12% w/w. In some embodiments, the composition comprises more than 50% of a solid carrier. In some embodiments, the composition comprises about 80% to about 95% w/w of a natural clay-based carrier, mineral-based carrier, or other solid substrate such as extruded pellets of organic composition or granules of mineral or synthetic fertilizer. In some embodiments, the composition comprises about 80-95% w/w zeolite or bentonite.

### Microalgae and Mycorrhizae Seed Coatings

The present disclosure provides powdered seed coatings comprising microalgae and mycorrhizae. In some embodiments, the powdered seed coating comprises a mycorrhizae powder mixed with a whole-cell microalgae powder. In some embodiments, the ratio of the mycorrhizae to the microalgae components varies. In some embodiments, the seed coating comprises 10-90% w/w mycorrhizae and 10-90% w/w microalgae components. In some embodiments, the seed coating comprises 10-90% w/w mycorrhizae powder and 10-90% w/w whole-cell microalgae powder. In some embodiments, the seed coating comprises 10-90,000 mycorrhizae spores/gram.

In some embodiments, the seed coating comprises 5-30% w/w mycorrhizae powder and 70-95% w/w microalgae powder. In some embodiments, the seed coating comprises about 20% mycorrhizae powder and 80% microalgae powder. In some embodiments, the seed coating comprises a binder. In some embodiments, the seed coating comprises a hydrocolloid binder. In some embodiments, the seed coating comprises a liquid carrier, such as water or oil. In some embodiments, the seed coating only comprise microalgae and mycorrhizae powders, including any inert carriers comprised by the mycorrhizae powder.

### Microalgae and Rhizobium Seed Coatings

In some embodiments, the present disclosure provides a seed coating comprising microalgae and Rhizobium.

For example, in some embodiments, a microalgae-Rhizobium seed coating is formulated according to the following description. A Rhizobium culture is acquired comprising a cell content of 10⁶-10¹⁰ cells/mL, or any suitable range known in the art. In some embodiments, the Rhizobium culture comprises about 10⁸ cells/mL of liquid. A DMS is formulated according to the description herein. In some embodiments, the seed coating is formulated to comprise 10-90% Rhizobium, 10-90% DMS and a carrier. In some embodiments, the seed coating is formulated to comprise about 20% Rhizobium culture, 20% DMS and 60% carrier. In some embodiments, the carrier can be any carrier described herein. In some embodiments, the carrier is a dry powder. In some embodiments, the carrier is a liquid carrier. In some embodiments, the carrier is a liquid solution that allows the seed coating to stick to the surface of the seeds.

The seed coating can be applied to seeds, seedlings, or soil. In some embodiments, the seed coating is applied at a rate of about 1-100 g per acre, e.g., per amount of seeds to be sown in an acre.

In some embodiments, the seed coating is applied to seeds. In some embodiments, the seed coating is applied to seeds at a rate of 1-50 g per 1 kg of seeds. In some embodiments, the seed coating is applied to seeds at a rate of about 20 g per 1 kg of seeds. In some embodiments, the seeds are coated with a liquid solution to adhere the seed coating to the surface of the seeds. In some embodiments, the seeds are dried, e.g., at ambient temperature, and then sowed. In some embodiments, the seed coating is applied to seedlings. In some embodiments, the seed coating is formulated as a liquid and is applied to the seedlings. In some embodiments, the seed coating is mixed with a liquid to form a slurry and is applied to seedlings. In some embodiments, the seed coating is applied directly to soil before sowing.

In some embodiments, the Rhizobium is any plant-beneficial species of Rhizobium known in the art. In some embodiments, the species is Rhizobium phaseoli, Rhizobium etli, Rhizobium grahamii, Rhizobium pisi, Rhizobium leguminosarum, Rhizobium miluonense, Rhizobium pusense, or Rhizobium rhizoryzae. In some embodiments, multiple species of Rhizobium are used.

### Methods of Using Compositions Comprising Microalgae and Mycorrhizae

The present disclosure provides methods of using the compositions described herein on an agricultural crop.

### Agricultural Crops

The methods of the present disclosure may be used on any agricultural crop. Agricultural crops include agronomic crops, horticultural crops, and ornamental plants. In some embodiments, a method of the present disclosure is employed on an agronomical crop selected from the list consisting of wheat, rice, corn, soy bean, alfalfa, forage crops, beans, sugar beets, canola, and cotton. In some embodiments, a method of the disclosure is employed on a horticultural crop selected from the list consisting of vegetables, fruits, flowers, ornamentals, and lawn grasses. In some embodiments, a method of the disclosure is employed on an ornamental plant selected from the list consisting of flowers, shrubs, grasses, and trees.

Agricultural crops include both monocots and dicots. In some embodiments, the methods of the disclosure are employed on monocots, such as agapanthus, asparagus, bamboo, bananas, corn, daffodils, garlic, ginger, grass, lilies, onions, orchids, rice, sugarcane, tulips, and wheat. In some embodiments, the methods of the disclosure are employed on dicots, such as apples, beans, broccoli, carrots, cauliflower, cosmos, daisies, peaches, peppers, potatoes, roses, sweet pea, and tomatoes. In some embodiments, the agricultural crop is a food crops, feed crop, cereal crop, oil seed crop, pulse, fiber crop, sugar crop, forage crop, medicinal crop, root crop, tuber crop, vegetable crop, fruit crop, or garden crop.

Compositions of the present invention may be applied to any plant or plant propagation material that may benefit from improved growth including agricultural crops, annual grasses, trees, shrubs, ornamental flowers and the like.

In some embodiments, the agricultural crop is selected from cereals, plantation crops, groundnut crops, grams, pulses, vegetables, fruits, proteaginous crops, citrus crops, berry crops, melon crops, vine crops. In some embodiments, the agricultural crop is selected from the list consisting of apple, barley, sunflower, plum, rice, paddy rice, agave, strawberry, watermelon, coffee, tomato, lentil, pea, chickpea, potato, cotton, sugarcane, wheat, banana, soy bean, corn, sorghum, onion, carrot, bean, zucchini, lettuce, chicory, fennel, sweet pepper, pear, peach, cherry, kiwifruit, soft wheat, durum wheat, grapevine, table grape, olive, almond, hazelnut, cotton, canola, and maize.

### Application Methods and Application Rates

In some embodiments, the methods comprise applying a dry granule formulation as described herein. The dry granule formulation can be applied to the crops by any suitable means. In some embodiments, the granules are broadcast onto the soil, e.g., by hand or by machine. In some embodiments, the granules are pre-mixed with sand, soil, and/or fertilizer before broadcast. In some embodiments, the compositions are spread, brushed, or sprayed onto the crops or the environs thereof by hand, by apparatus, or by machine. In some embodiments, the dry granule formulation is applied at the rate of 1-100 kg per hectare. In some embodiments. the dry granule formulation is applied at the rate of 5-50 kg per hectare. In some embodiments. the dry granule formulation is applied at the rate of about 10 kg per hectare.

In some embodiments, the present methods comprise applying a seed coating as described herein. In some embodiments, the seed coating is applied to the seeds before planting. e.g., using a mixer. In some embodiments, the seed coating is applied in furrow, e.g., via suitable broadcast or in-furrow application means. In some embodiments, the seed coating is applied using flow equipment after suspension in a liquid carrier. In some embodiments, the seed coating is applied at the rate of about 10 g to 1 kg of dry powder seed coating per quantity of seeds to be planted in one hectare. In some embodiments, the seed coating is applied at the rate of about 50-200 g of dry powder seed coating per quantity of seeds to be planted in one hectare. In some embodiments, the seed coating is applied at the rate of about 100 g of dry powder seed coating per quantity of seeds to be planted in one hectare.

In some embodiments, the present methods comprise applying a liquid formulation as described herein. In some embodiments, the liquid formulation is applied at a rate of 100 mL to 100 L per hectare. In some embodiments, the liquid formulation is applied at a rate of 0.5 L to 10 L per hectare. In some embodiments, the liquid formulation is applied at a rate of about 4-7 L per hectare. In some embodiments, the liquid formulations herein are diluted in water or a suitable liquid carrier prior to application. For example. In some embodiments, the liquid formulations are diluted to 0.1-1.0% v/v before application to the host plant, plant parts, or plant environs. In some embodiments, the liquid formulations are diluted to 0.3-0.5% v/v before application.

The compositions of the present disclosure may be applied to any part of a host plant or the environs thereof. In some embodiments, in the case of granules, the compositions are applied to the roots and/or the soil around the host plant. In some embodiments, in the case of seed coatings, the compositions are applied to the seeds of the host plant before, during or shortly after planting. In the case of liquid compositions, the compositions may be applied to the seeds, seedlings, plants, or plant parts. Plant parts include seeds, seedlings, plant tissues, leaves, branches, stems, bulbs, tubers, roots, root hairs, rhizomes, cuttings, flowers, and fruits. Compositions of the present invention may further be applied to any area where a plant will grow including soil, a plant root zone and a furrow.

The compositions of the present disclosure can be applied at any time during the host plant life cycle. In some embodiments, the compositions of the present disclosure are applied shortly after planting, tillering, or sowing. In some embodiments, the compositions of the present disclosure are applied as a seed coating or soil treatment around the time of planting. In some embodiments, the compositions are applied 0-30 days after planting, sowing, or tillering. In some embodiments, the compositions are applied pre-blooming. In some embodiments, the compositions are applied post-blooming. In some embodiments, the compositions are applied at rooting, sprouting, flowering, fruit setting, ripening, or fattening. in some embodiments, the compositions are applied before or during a peak period of metabolic activity. In some embodiments, the compositions are applied during a period of host plant stress.

In some embodiments, the compositions are applied more than once. In some embodiments, the composition is administered 3 to 5 times per growing cycle, depending on the type of crop, the intensity, and the planting. In some embodiments, the compositions are applied periodically throughout the growing cycle. The compositions may be applied once a day, once a week, once every two weeks, or once a month. In some embodiments, the timing of composition application is based on field studies assessing the efficacy of application at different time points. In some embodiments, the compositions are applied 1-10 times throughout the growing cycle of the host plant. In some embodiments, the compositions are applied 1-5 times throughout the growing cycle of the host plant.

In some embodiments, application to plants, plant parts, plant tissues, or plant environs comprises soil application pre-blooming and application to aerial biomass post-blooming. In some embodiments, compositions intended for soil are applied pre-blooming, such as granules or liquid soil treatments, and compositions intended for aerial dispersion are applied post-blooming, such as foliar sprays.

### Improving Growing, Production, or Biostimulant Parameters

The present disclosure provides methods for improving a growing parameter, production parameter, or biostimulant parameter of a host plant. The methods comprise applying a composition of the present disclosure to the host plant.

In some embodiments, the method increases a growing parameter of the host plant. A growing parameter is related to the growth of the host plant. Growing parameters include plant size, biomass (dry or wet), aerial biomass, height, number of branches, number of leaves, number of flowers, root biomass, number of roots, number of secondary roots, root volume, root length, and degree of inoculation by diazotrophic bacteria.

In some embodiments, the method increases a production parameter of the host plant. A production parameter is related to the plant part that is harvested from the plant for commercial purposes. Production parameters include, but are not limited to, yield, yield per plant, yield per area, harvested biomass, harvested weight, harvested volume, number of harvested plant parts, and size of harvested plant parts. In terms of the harvestable plant parts, production parameters include yield, weight, size, and number of harvestable plant parts. Harvestable plant parts include, for example, fruits, vegetables, roots, grains, tubers, leaves, flowers, seeds, and nuts. In some embodiments, e.g., for some grasses, lettuces, feed crops, and forage crops, a harvestable plant part is the entire aerial biomass of the plant. In some embodiments, the harvestable plant part is related to the intended use of the crop. For example, for oil crops, the harvestable plant parts are the components of the plant containing the oil to be harvested.

In some embodiments, the method increases a biostimulant parameter of the host plant. Biostimulant parameters include, but are not limited to, chlorophyl content, carotenoid content, micronutrient profile, and macronutrient profile. In some embodiments, the method increases the concentration of a chlorophyl, e.g., chlorophyl a or chlorophyl b. In some embodiments, the method increases the concentration of a carotenoid or improves the average carotenoid profile. In some embodiments, the method increases the micro and/or macro-nutrient profile of the harvested plant part, the plant leaves, or the plant roots. In some embodiments, the method increases the concentration of one or more micronutrients or one or more macronutrients in the roots, leaves, or fruits of the host plant. In some embodiments, the method increases the nitrogen content in the leaves of the host plant. Nitrogen stimulates plant growth and is directly related to the root system's ability to fix nitrogen and the host plant's nitrogen metabolism. In some embodiments, the method increases the concentration of magnesium, manganese, copper, or potassium in the roots. Manganese and Copper are highly effective micronutrients in plant resistance to diseases (Marschner, 2012). By affecting cell wall composition and lignin synthesis Mn and Cu suppress penetration of pathogens into plant tissue. Increases in chlorophyl content depend on Mg supply (Marschner, 2012). Plant Stem Growth is very sensitive to potassium concentration. Plant height increase can be related to potassium concentration in the root system. Potassium is also involved in tree growth and wood formation. In the cambial region and the xylem differention zone, a strong potassium demand has been shown. Differentiating xylem cells involved in wood formation represent a strong sink for potassium that provides the driving force for cell expansion (Langer et al., 2002: Plant Journal, 32: 997-1009).

In some embodiments, the method improves a growing parameter, production parameter, or biostimulant parameter compared to a control condition. In some embodiments, the method improves a parameter in terms of timing. i.e., the parameter is improved at a given time point compared to the control. For example, in some embodiments, the method may improve a growing parameter relative to a control early on, such as early flowering, faster maturation, increased height compared to control at the same time point.

In some embodiments, the methods yield synergistic improvements from the combination composition on a parameter of a host plant compared to the improvements yielded by any one of the components of the composition alone.

### Improvements in Host Plant Response to Abiotic Stress

The present disclosure provides methods of improving an agricultural crop's tolerance to abiotic stress.

Abiotic stress includes water stress, temperature stress, sun stress, salinity stress, wind stress, and heavy metal stress. Examples of abiotic stress include drought, heat, cold, excess salinity, strong winds, heavy metals, flooding, and excessive sunlight.

In some embodiments, the present methods improve resistance to abiotic stress. In some embodiments, the present methods improve resistance to temperature stress. In some embodiments, the present methods improve resistance to water stress. In some embodiments, the present methods improve resistance to salinity stress. In some embodiments, the present methods improve resistance to sun stress. In some embodiments, the present methods improve resistance to wind stress. In some embodiments, the present methods improve resistance to heavy metal stress.

### Reducing Reliance on Exogenous Macronutrient Supplementation

The present disclosure provides methods of reducing an agricultural crop's reliance on exogenous application of a macronutrient.

“Reliance on exogenous macronutrient supplementation” as used herein refers to the need for application of a macronutrient in order to obtain a higher production parameter, e.g., yield, of an agricultural crop. Present agricultural crop cultivation techniques require significant application of fertilizers comprising macronutrients to increase agricultural crop yield. These fertilizers typically comprise nitrogen, phosphorous, and potassium, i.e., “NPK.” Depending on the crop and other environmental factors, there is typically a recommended dose of fertilizer (i.e., “RDF”) comprising NPK at levels determined to increase or optimize a production parameter of the agricultural crop. This level can also be determined by a person of skill in the art by identifying the optimal level of NPK required to obtain higher yields, above which point additional NPK does not increase yield.

In some embodiments, the present disclosure provides methods of reducing an agricultural crop's reliance on exogenous application of a macronutrient. In some embodiments, the macronutrient is nitrogen. In some embodiments, the macronutrient is phosphorous. The methods disclosed herein reduce the reliance on application of an exogenous macronutrient via the application of the combination microalgae and mycorrhizae compositions disclosed herein. In some embodiments, the composition is a granule. In some embodiments, application of the composition results in a higher yield with less application of an exogenous macronutrient.

In some embodiments, the methods reduce the amount of exogenous macronutrient required to obtain a higher yield. For example, in some embodiments, the method comprises applying a composition disclosed herein, e.g., a granule, to an agricultural crop, with a level of macronutrient supplementation that is lower than the RDF, while maintaining or increasing the yield of the agricultural crop.

In some embodiments, the methods comprise reducing the macronutrient supplementation by at least 1-30% while maintaining or increasing the yield of the agricultural crop, i.e., in comparison to a control crop with RDF but without the application of the composition of the present disclosure. In some embodiments, the method comprises reducing the macronutrient supplementation by about 5%, 10%, 15%, 20%, 25%, 30%, 35%, 40%, 45%, or 50%, while maintaining or increasing the yield of the agricultural crop. In some embodiments, the method comprises reducing the macronutrient supplementation by about 10%. In some embodiments, the method comprises reducing the macronutrient supplementation by about 20%. In some embodiments, the method comprises reducing the macronutrient supplementation by about 30%.

In some embodiments, the methods increase a production parameter of the agricultural crop by 1-25% while reducing exogenous macronutrient supplementation. In some embodiments, the method increases a production parameter, e.g., yield, by about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, or 25% while reducing exogenous macronutrient supplementation. In some embodiments, the method increases a production parameter of the agricultural crop by 5-15% while reducing exogenous macronutrient supplementation.

In some embodiments, the methods comprise applying a composition as disclosed herein, while decreasing the level of exogenous macronutrient supplementation, and the method produces a higher level of available macronutrient in the soil. For example, in some embodiments, the method comprises reducing nitrogen supplementation, and the method results in higher available nitrogen in the soil. In some embodiments, the method comprises reducing phosphorous supplementation, and the method results in higher available phosphorous in the soil.

In some embodiments, the methods comprise applying a composition as disclosed herein, while decreasing the level of exogenous macronutrient supplementation, and the method produces a higher level of organic carbon content in the soil. For example, in some embodiments, the method comprises reducing nitrogen and/or phosphorous supplementation, and the method results in higher organic carbon content in the soil.

### References

Nye, P. H., and Tinker, P. B. (1977) Solute Movement in the Soil-Root 1-System. University of California Press, Berkeley.
Mauseth, J. D. (1988) Plant Anatomy. Benjamin/Cummings Pub. Co., Menlo Park, CA.
Mumpton, F. A. (1999). Uses of Natural Zeolites in Agriculture and Industry. Proc. Natl. Acad. Sci. USA., 96: 3463-70.

### EXAMPLES

### Example 1: Formulation of Illustrative Components of Compositions of the Disclosure

Whole-cell microalgae powder. A microalgae consortium comprising genera from the list of Chlorella, Scenedesmus, Nannochloropsis, Muriellopsis, Isochrysis, Tisochrysis, Desmodesmus, Haematococcus, Arthrospira, and Anabaena was cultured in photobioreactors supplemented with nutrients and CO₂. The microalgae were harvested once the biomass reached 0.5-5.0 g/L. Culture solids comprising whole microalgae cells were then separated from solution, dried, and ground to an average particle size of about 100-1000 microns in order to produce a mostly whole cell powder form of microalgae, i.e., “whole-cell microalgae powder.”

Digested microalgae solution. The whole cell microalgae powder was then processed to degrade cell walls and proteins, thereby increasing the concentration of accessible organic carbon, amino acids and peptides and producing a digested microalgae solution (“DMS”) of the disclosure. A nutrient analysis of an illustrative DMS is shown in FIG. 1A.

Liquid microalgae applications. For liquid microalgae-only applications, e.g., in the form of foliar sprays, the DMS was diluted to 0.3-0.5% v/v with demineralized water and optionally a buffer.

Mycorrhizae. A powdered composition comprising mycorrhizal fungi (“mycorrhizae”) was provided. The powder comprised 100-10,000 spores/g, along with inert ingredients, such as clay-based or mineral-based carriers, e.g., zeolite, and/or starch, e.g., dextrin, and/or sugars, among other inert ingredients known in the art.

Granule formulation. DMS was buffered (e.g., with 0.1 M citrate buffer) to adjust the pH level to the range of pH 6.0-6.5. An acid or base (e.g., NaOH or HCl) was titrated into the microalgae solution to adjust the pH level of the DMS to the final desired level in the range of 6.0 to 6.5.

Mycorrhizae powder was combined with demineralized water and a buffer (e.g., 0.1 M phosphate buffer) to adjust the pH level to the range of pH 6.0-6.5. An acid or base (e.g., NaOH or HCl) was titrated into the mycorrhizae solution to adjust the pH level of the mycorrhizae solution to the final desired level in the range of 6.0 to 6.5.

Clay or mineral based granules (e.g., zeolite, bentonite, leonardite, CaCO3) were obtained and optionally filtered based on size to preferentially select for granules in the 2-4 mm range.

The granules were coated with the DMS and mycorrhizae solutions. The total volume of pH-modified, buffered solution containing DMS and mycorrhizae applied to the granules was based on the absorbing capacity of the granule material: e.g., in the case of bentonite clay, approximately 12% by weight. The coated granules were then dried at ambient temperature and/or beneath a heat lamp. The granules were formulated to achieve 100 to 1000 mycorrhizal spores per gram. In other instances, the granules were formulated to achieve 100,000-2,000,000 spores/hectare. Typically, the granules were formulated to comprise 0.5-5.0% w/w microalgae solution, 0.5-5.0% w/w mycorrhizae solution, coating solution, and the balance of clay-based carrier. FIG. 1B shows an image of illustrative zeolite granules.

### Example 2: Illustrative Formulation of Zeolite-Based Granule Compositions

Granulation process. Raw materials are mixed in a drum, to produce granules with a specific size distribution between 2-4 mm in diameter. Optionally, solid or liquid binders are added to improve agglomeration and granule formation, such as hydrocolloids, vinasses, lignosulfonates, celluloses, anhydrites, or clays.

Spraying process. Fertilizer granules are sprayed with microalgae and/or mycorrhizae solutions.

Drying-cooling process. Fertilizer granules are dried, e.g., by flowing crosscurrent heated air, by exposure to ambient temperature, or by heat lamp.

Conditioning process. The granule is coated, e.g., via rotary drum, with anti-caking agents like clays, talc, and oils, which may contain hydrophobic compounds.

### Example 3: Increased Growth of Illustrative Host Plant after Application of Microalgae and Mycorrhizae Combination Compositions

### Materials

Granule formulation. Zeolite, leonardite, and CaCO3 granules comprising mycorrhizae were formulated by mixing the granules with mycorrhizae powder for small scale testing. The granules comprised a ratio of 1:3 mycorrhizae:carrier. The granules were about 2-4 mm in diameter and comprised about 300 propagules of Rhizophagus intraradices fungi per gram of granule. In conditions without mycorrhizae, granules were not mixed with mycorrhizae.

Microalgae solution. DMS was formulated as described in Example 1 and diluted to a concentration of 0.3% v/v in water.

### Methods

The following combinations of components and carriers were tested: no granules, no microalgae solution (“Control”): digested microalgae solution alone (“DMS”): nitrogen/phosphorous/potassium 7:7:2 fertilizer plus DMS (“NPK772+DMS”): mycorrhizae plus DMS (“Myco+DMS”): leonardite granules plus DMS (“Leo+DMS”): zeolite plus DMS (“Zeo+DMS”): CaCO3 plus DMS (“CaCO3+DMS”): zeolite plus mycorrhizae plus DMS (“Zeo+Myco+DMS”): CaCO3 plus mycorrhizae plus DMS (“CaCO3+Myco+DMS”): leonardite plus mycorrhizae plus DMS (“Leo+Myco+DMS”).

For each relevant condition, 6 g of granules (mycorrhizae and/or carrier/fertilizer) plus 50 mL of microalgae solution were added to 10 kg of soil, which was then added to 5 L pots for leek cultivation. The leek plants were grown and watered under standard conditions for all test conditions. Height and leaf composition were analyzed in the resulting leek plants.

Results

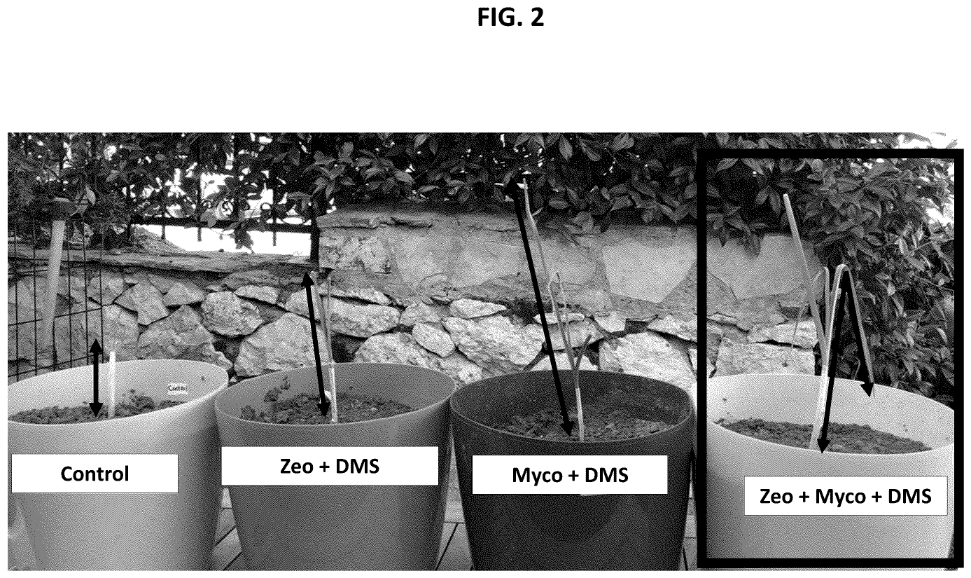

A side-by-side photo comparison of the height of the leek plants was taken at 14 days after application for the following conditions: Control, Zeo+DMS, Myco+DMS, and Zeo+Myco+DMS conditions. This photographic comparison (FIG. 2) visibly shows the surprising difference in height of the leek plants for both of the mycorrhizae and microalgae conditions compared to microalgae alone or compared to control. Both Myco+DMS and Zeolite+Myco+DMS conditions resulted in a significant increase in host plant height compared to either the control or the microalgae alone condition.

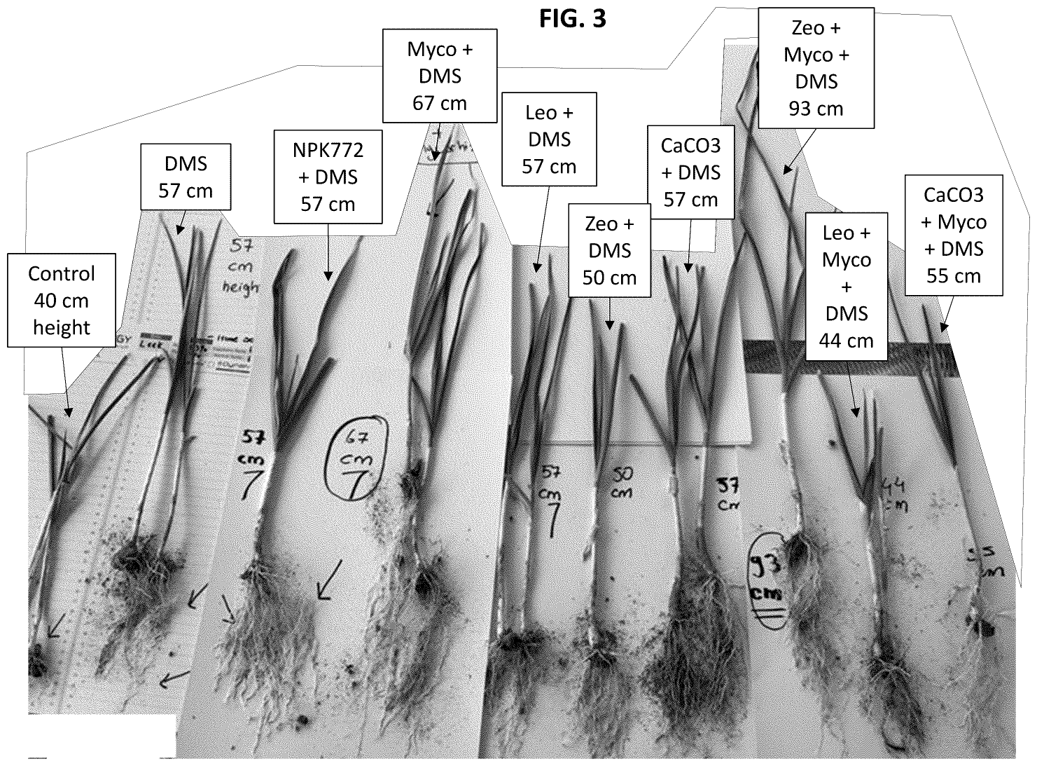

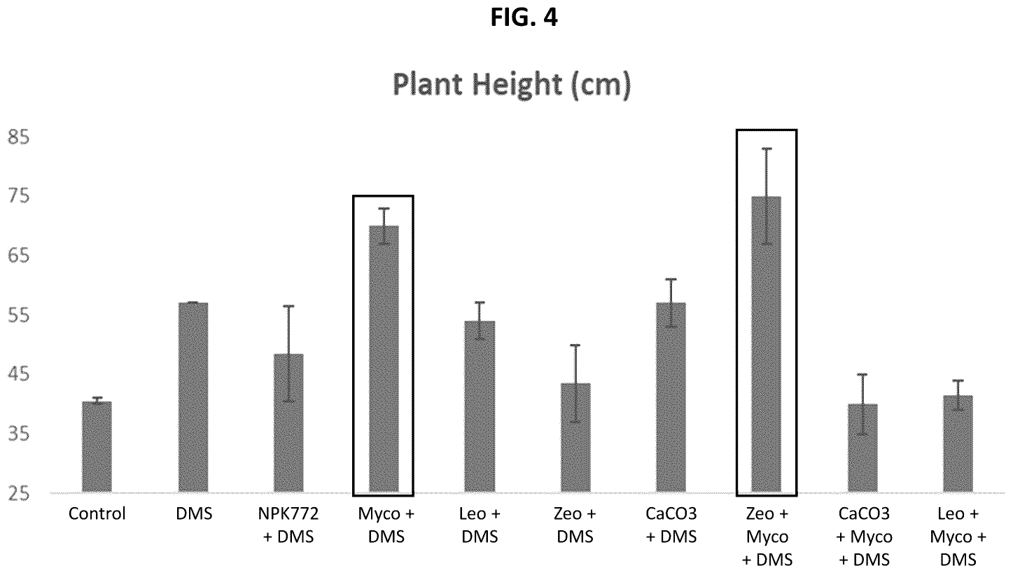

At 30 days, the heights of all leek plants (root+shoot) for each condition were measured, and the root mass was visually documented. FIG. 3 shows a photograph of an illustrative leek plant for each condition, demonstrating the increased height and root length/mass for the combination conditions of Myco+DMS and Zeolite+Myco+DMS. FIG. 4 shows a bar graph of the averaged height results among replicates measured at 30 days, demonstrating the significant increase in height for both the Myco+DMS condition and the Zeo+Myco+DMS condition. The combination of these components demonstrated a synergistic improvement in plant growth.

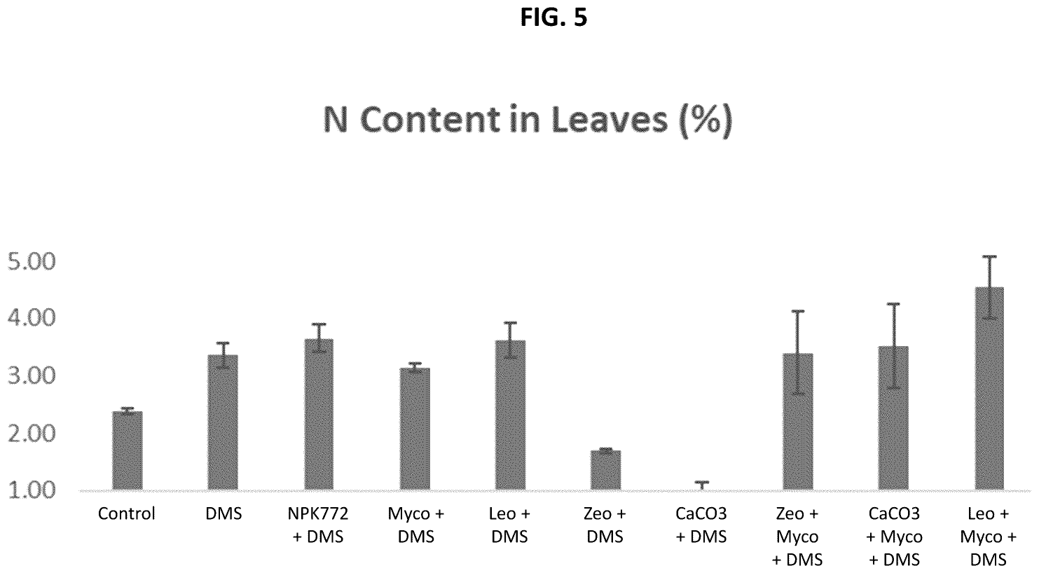

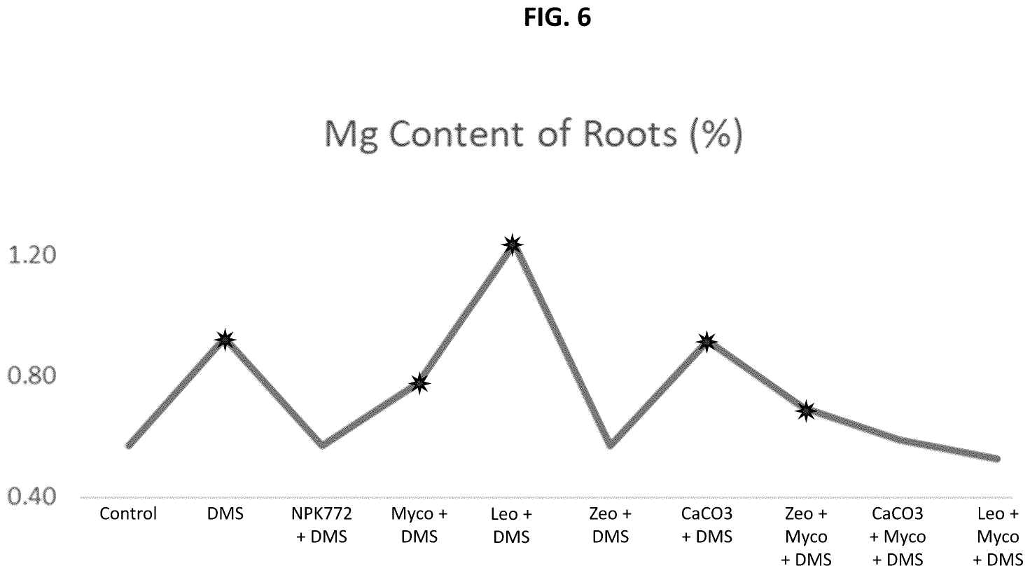

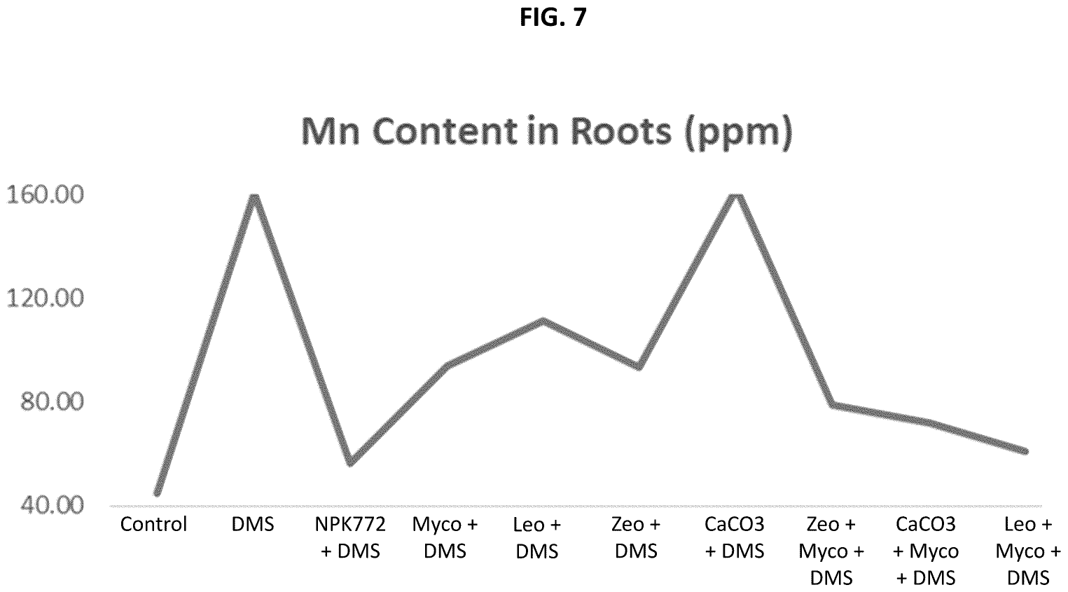

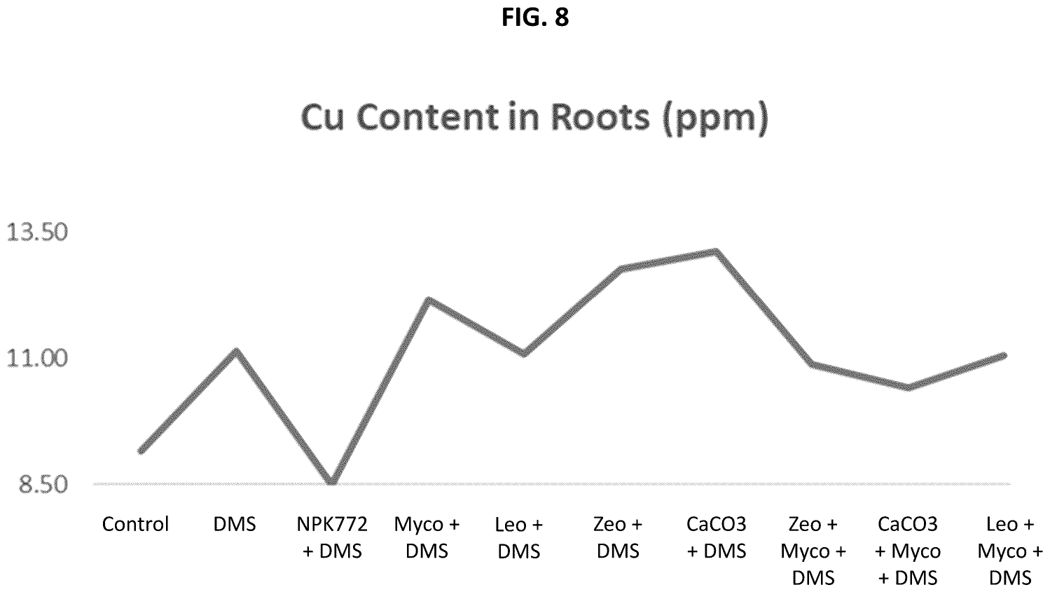

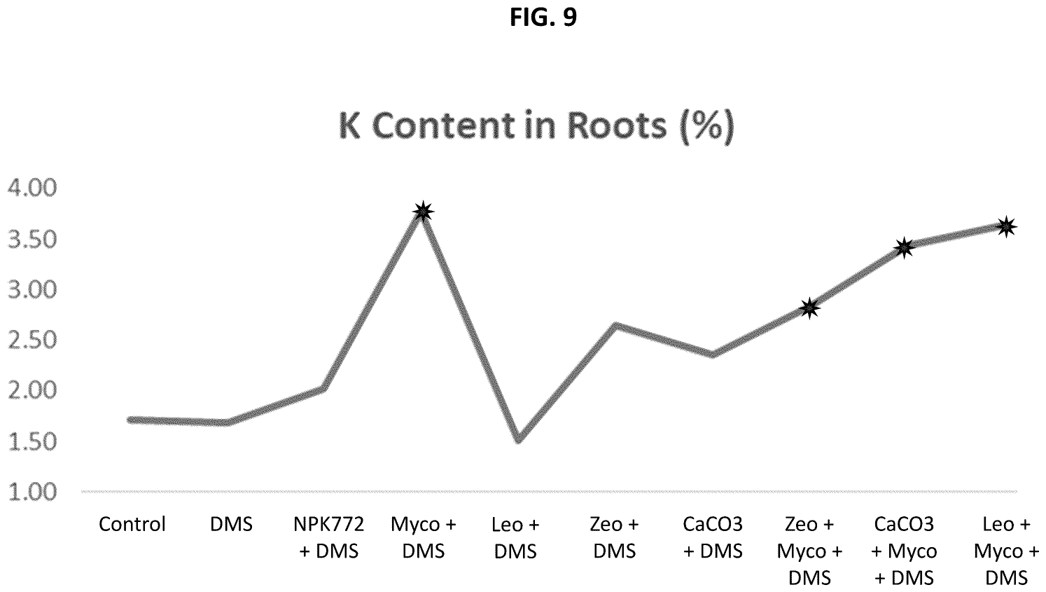

Micro and macro element composition of roots and leaves were analyzed in the plants at 30 days. The results of these analyses are shown in Tables 1-6 below and in FIGS. 5-9. FIG. 5 shows the nitrogen content of the leek leaves in each condition, demonstrating a significant increase in nitrogen content for most conditions compared to control. FIG. 6 shows the magnesium content of the roots for each condition, with a marker on each condition with Mg content at least 0.10% above the control value. FIG. 7 contains the results of the manganese analysis of the roots, demonstrating that every condition tested showed higher manganese concentration than the control. The copper results (FIG. 8) similarly showed that every condition except for NPK772 had higher copper content than the control. FIG. 9 shows that the Myco+DMS combination compositions, with or without carrier, produced the greatest increase in the potassium content of the roots.

TABLE 1
Plant height at day 30 after application.

| | Mean | | % Increase |
|---|---|---|---|
| Condition | Height (cm) | SEM (cm) | over Control |
| Control | 40.50 | 0.50 | 0.00 |
| LRM | 57.00 | 0.00 | 40.74 |
| NPK772 + LRM | 48.50 | 8.50 | 19.75 |
| AMF + LRM | 70.00 | 3.00 | 72.84 |
| Leonardite + LRM | 54.00 | 3.00 | 33.33 |
| Zeolite + LRM | 43.50 | 6.50 | 7.41 |
| CaCO3 + LRM | 57.00 | 4.00 | 40.74 |
| Zeolite + AMF + LRM | 75.00 | 18.00 | 85.19 |
| CaCO3 + AMF + LRM | 40.00 | 15.00 | −1.23 |
| Leonardite + AMF + LRM | 41.50 | 2.50 | 2.47 |

TABLE 2
Percent nitrogen in leaves.

| | | | % Increase |
|---|---|---|---|
| Condition | Mean N % | SEM N % | Over Control |
| Control | 2.38 | 0.06 | 0.00 |
| LRM | 3.35 | 0.22 | 40.92 |
| NPK772 + LRM | 3.65 | 0.24 | 53.12 |
| AMF + LRM | 3.13 | 0.07 | 31.48 |
| Leonardite + LRM | 3.62 | 0.30 | 52.19 |
| Zeolite + LRM | 1.69 | 0.04 | −29.22 |
| CaCO3 + LRM | 0.95 | 0.19 | −60.09 |
| Zeolite + AMF + LRM | 3.40 | 0.71 | 42.89 |
| CaCO3 + AMF + LRM | 3.53 | 0.73 | 48.12 |
| Leonardite + AMF + LRM | 4.54 | 0.55 | 90.80 |

TABLE 3
Concentration of magnesium in plant roots.

| | | | % Increase |
|---|---|---|---|
| Condition | Mean Mg % | SEM Mg % | Over Control |
| Control | 0.57 | 0.02 | 0.00 |
| LRM | 0.93 | 0.05 | 62.28 |
| NPK772 + LRM | 0.57 | 0.02 | 0.00 |
| AMF + LRM | 0.78 | 0.05 | 35.96 |
| Leonardite + LRM | 1.24 | 0.23 | 117.54 |
| Zeolite + LRM | 0.57 | 0.16 | 0.00 |
| CaCO3 + LRM | 0.92 | 0.03 | 60.53 |
| Zeolite + AMF + LRM | 0.70 | 0.01 | 21.93 |
| CaCO3 + AMF + LRM | 0.59 | 0.02 | 3.51 |
| Leonardite + AMF + LRM | 0.53 | 0.11 | −7.89 |

TABLE 4
Concentration of manganese in plant roots.

| | Mean | | % Increase |
|---|---|---|---|
| Condition | Mn (ppm) | SEM (ppm) | Over Control |
| Control | 44.63 | 0.97 | 0.00 |
| LRM | 160.61 | 56.34 | 259.87 |
| NPK772 + LRM | 56.48 | 1.05 | 26.55 |
| AMF + LRM | 94.13 | 11.25 | 110.91 |
| Leonardite + LRM | 111.11 | 10.49 | 148.96 |
| Zeolite + LRM | 93.65 | 55.20 | 109.84 |
| CaCO3 + LRM | 161.97 | 6.38 | 262.92 |
| Zeolite + AMF + LRM | 78.95 | 1.32 | 76.89 |
| CaCO3 + AMF + LRM | 71.92 | 19.39 | 61.15 |
| Leonardite + AMF + LRM | 60.93 | 18.29 | 36.51 |

TABLE 5
Concentration of copper in plant roots.

| | Mean | | % Increase |
|---|---|---|---|
| Condition | Cu (ppm) | SEM (ppm) | Over Control |
| Control | 9.15 | 0.38 | 0.00 |
| LRM | 19.13 | 6.93 | 109.13 |
| NPK772 + LRM | 8.50 | 1.91 | −7.11 |
| AMF + LRM | 12.14 | 0.82 | 32.75 |
| Leonardite + LRM | 11.08 | 2.24 | 21.16 |
| Zeolite + LRM | 12.76 | 0.52 | 39.48 |
| CaCO3 + LRM | 13.12 | 0.63 | 43.47 |
| Zeolite + AMF + LRM | 10.87 | 1.42 | 18.86 |
| CaCO3 + AMF + LRM | 10.42 | 4.55 | 13.94 |
| Leonardite + AMF + LRM | 11.06 | 3.71 | 20.89 |

TABLE 6
Concentration of potassium in plant roots.

| | | | % Increase |
|---|---|---|---|
| Condition | Mean K % | SEM K % | Over Control |
| Control | 1.72 | 0.12 | 0.00 |
| LRM | 1.68 | 0.00 | −2.33 |
| NPK772 + LRM | 2.02 | 0.12 | 17.15 |
| AMF + LRM | 3.77 | 0.09 | 119.19 |
| Leonardite + LRM | 1.52 | 0.15 | −11.92 |
| Zeolite + LRM | 2.65 | 0.88 | 53.78 |
| CaCO3 + LRM | 2.36 | 0.26 | 37.21 |
| Zeolite + AMF + LRM | 2.83 | 0.57 | 64.53 |
| CaCO3 + AMF + LRM | 3.44 | 0.36 | 100.00 |
| Leonardite + AMF + LRM | 3.64 | 0.78 | 111.34 |

### Example 4: Field Trial in Hot Peppers with Illustrative Microalgae and Mycorrhizae Combination

### Methods

A DMS and mycorrhizae combination granule composition was formulated as in Example 1 on a bentonite carrier. Granules were applied at 4-8 kg/acre with 1-3 applications at 15-20 days after planting (“DAP”), 50-60 DAP, and 90 DAP plus the recommended dose of fertilizer (“RDF”). Treatment groups were compared to a control with RDF only. Resulting crops were evaluated for growing parameters, production parameters, and biostimulant parameters.

### Results

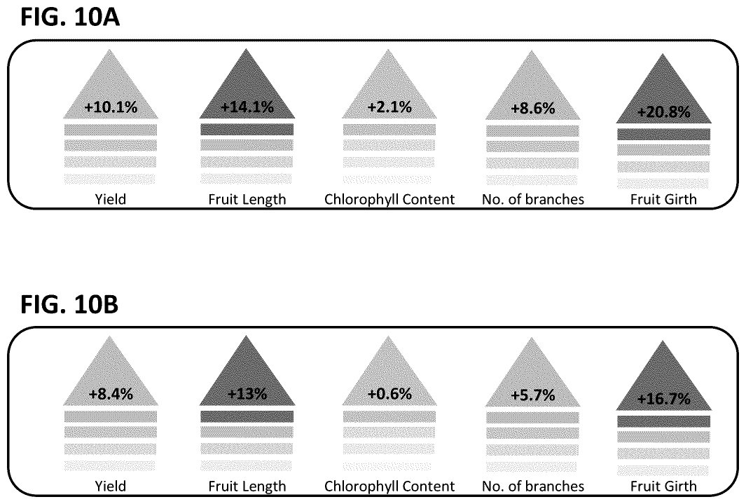

The application of an illustrative microalgae and mycorrhizae combination composition of the present disclosure produced substantial increases in growing parameters, production parameters, and biostimulant parameters in hot peppers relative to the control crops with RDF alone. The increased parameters included: yield, fruit length, chlorophyll content, number of branches, and fruit girth, as shown in FIG. 10A-10B and Table 7. Two-dose treatment with 8 kg/acre at both 15-20 days after planting (“DAP”) and 50-60 DAP produced the exemplary results displayed in FIG. 10A. Similar results were observed for a single dose treatment with 4 kg/acre at 15-20 DAP alone, results shown in FIG. 10B. Increases were also observed for plant height, plant spread, fruit length, root length, ASTA, percent red carotenoids, percent yellow carotenoids, and pungency in both treatment conditions compared to the control.

TABLE 7
Exemplary results from application of illustrative
compositions to hot peppers.

| | | Fruit | Chlorophyll | | Fruit |
|---|---|---|---|---|---|
| Treatment | Yield | length | content | Number of | girth |
| condition | (q/ha) | (cm) | (SPAD) | branches | (cm) |
| 4 kg/acre, 15-20 | 49.2 | 10.4 | 70.49 | 3.7 | 2.8 |
| DAP + RDF | | | | | |
| 8 kg/acre 15-20 | 50.0 | 10.5 | 71.54 | 3.8 | 2.9 |
| DAP and 50-60 | | | | | |
| DAP + RDF | | | | | |
| Control with RDF | 45.4 | 9.2 | 70.07 | 3.5 | 2.4 |
| alone | | | | | |

### Example 5: Field Trial in Rice with Illustrative Microalgae and Mycorrhizae Combination

### Methods

A DMS and mycorrhizae combination granule composition was formulated as in Example 1 on a bentonite carrier. Granules were applied at 10 kg/ha with 1-3 applications at less than 15 days after tilling (“DAT”), tillering, and booting. Treatment groups were compared to a control with farmer's practice. Resulting crops were evaluated for root length, number of tillers, and final yield, among other parameters.

### Results

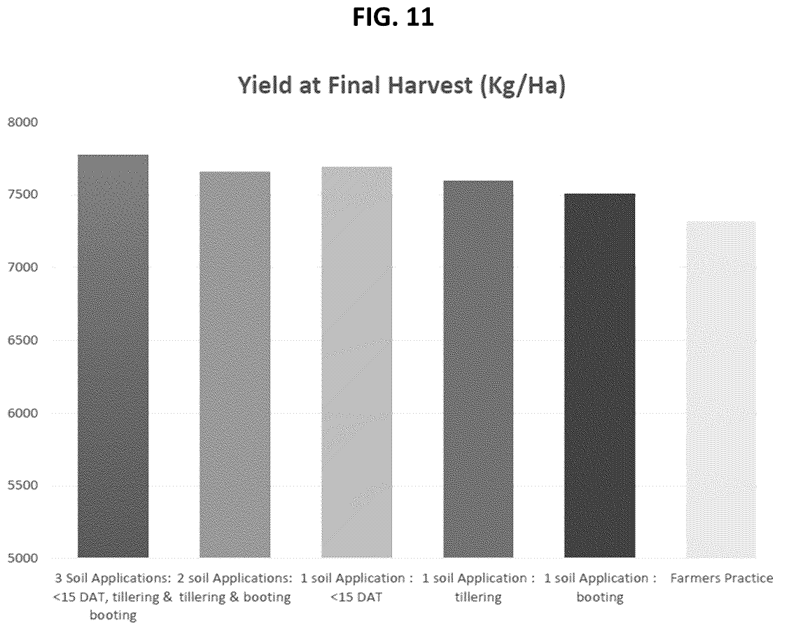

The application of an illustrative microalgae and mycorrhizae combination composition of the present disclosure produced statistically significant increases in root length, number of tillers per plant, and yield at final harvest for three treatment groups: single application at <15 DAT; two dose application at tillering and booting; and three dose application at <15 DAT, tillering and booting. The results for yield are shown in FIG. 11 across the different treatment groups. A single application at <15 DAT produced an average yield increase of 363 kg/Ha over control (˜5%).

### Example 6: Additional Field Trial in Rice with Illustrative Microalgae and Mycorrhizae Combination

### Methods

A DMS and mycorrhizae combination granule composition was formulated as in Example 1 on a bentonite carrier. Granules were applied at 10 kg/ha with 1-3 applications at 15 days after tilling (“DAT”), 30 DAT, and 45 DAT plus the recommended dose of fertilizer (“RDF”) or 75% RDF. Treatment groups were compared to a control with RDF only. Resulting crops were evaluated for growing parameters, production parameters, and biostimulant parameters.

### Results

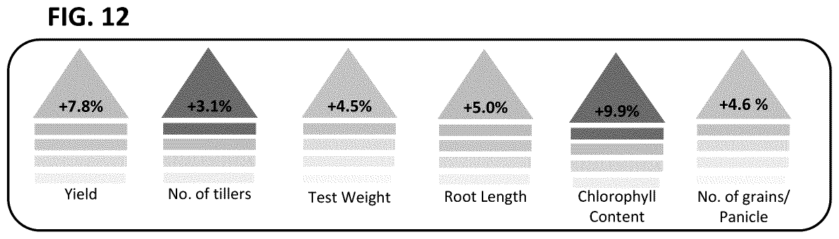

The application of an illustrative microalgae and mycorrhizae combination composition of the present disclosure produced substantial increases in growing parameters, production parameters, and biostimulant parameters in rice relative to the control crops with RDF alone. The increased parameters included: yield, number of tillers, test weight, root length, chlorophyll content, and number of grains/panicle with 3-dose application of 10 kg/ha at 15 DAT, 30 DAT, and 45 DAT, as shown in FIG. 12 and Table 8. Similar improvement in plant yield, number of tillers, chlorophyll content, number of grains/panicle, test weight statistically at par were also observed for single dose application of 10 kg/ha at 15 DAT+RDF, as shown in Table 8.

TABLE 8
Exemplary results from application of illustrative compositions to rice.

| | Grain | | Test | | Chlorophyll | No. |
|---|---|---|---|---|---|---|
| Treatment | yield | No. | weight | Root length | a, b content | grains/ |
| condition | (kg/ha) | tillers | (g) | (cm) | (mg/g) | panicle |
| 10 kg/ha, 15, 30, | 2342 | 15.33 | 15.67 | 23.11 | 2.33, 0.60 | 136 |
| 45 DAT + RDF | | | | | | |
| 10 kg/ha, 15 | 2281 | 15.10 | 15.67 | 21.91 | 2.43, 1.05 | 136 |
| DAT + RDF | | | | | | |
| Control with | 2172 | 14.87 | 15.00 | 22.00 | 2.12, 0.54 | 130 |
| RDF alone | | | | | | |

### Example 7: Farmer Field Trials in Rice with Illustrative Microalgae and Mycorrhizae Combination

### Methods

A DMS and mycorrhizae combination granule composition was formulated as in Example 1 on a bentonite carrier. Granules were applied at 10 kg/ha less than 15 days after tilling (“DAT”). Treatment groups were compared to a control with farmer's practice and/or commercial fertilizer. Resulting crops were evaluated for number of tillers and plant height at around 60 DAT, as well as qualitative appearance.

### Results

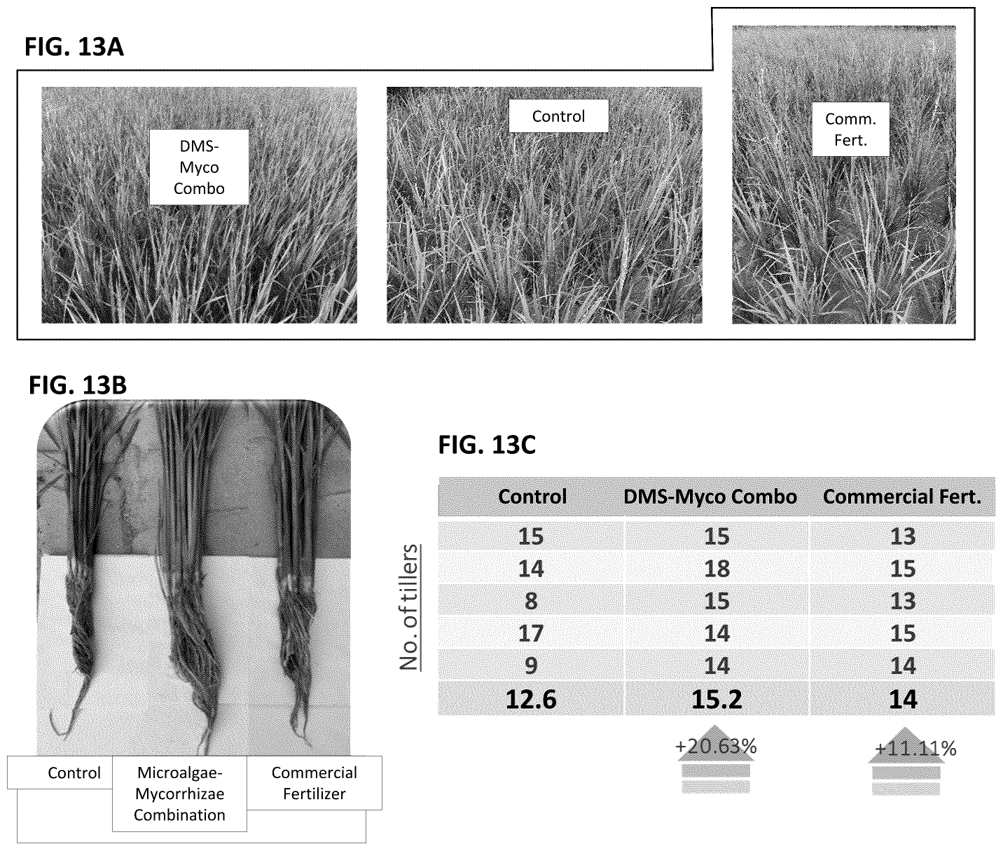

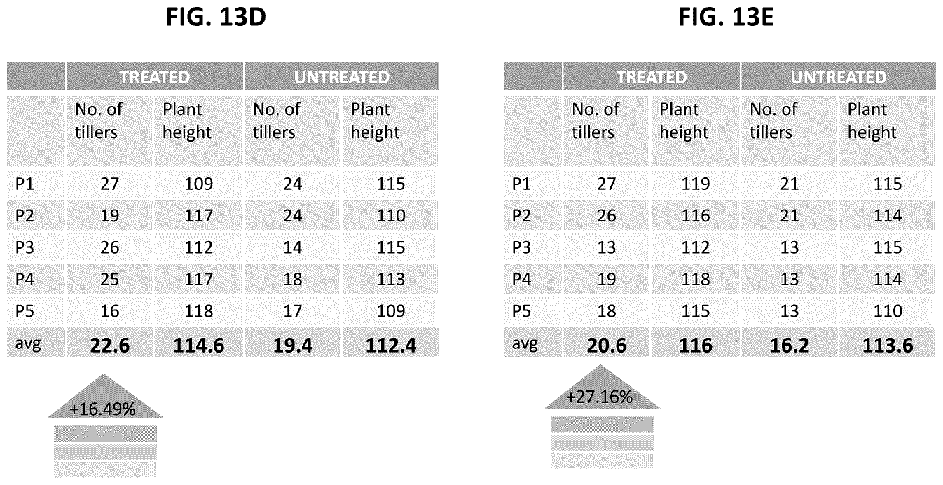

The application of an illustrative microalgae and mycorrhizae combination composition of the present disclosure produced increases in both number of tillers per plant and height. and yield at final harvest for three treatment groups: single application at <15 DAT: two dose application at tillering and booting: and three dose application at <15 DAT, tillering and booting. The results for number of tillers and qualitative appearance are shown for Location 1 in FIG. 13A-FIG. 13C, for Location 2 in FIG. 13D, and Location 3 in FIG. 13E. All three locations observed increases in number of tillers compared to control and/or commercial standard treatment. Location 1 also documented a qualitative increase in plant vigor (FIG. 13A) and root mass (FIG. 13B), while Locations 2 and 3 observed increases in plant height as well.

Example 8: Field Trial in Rice with Illustrative Microalgae and Mycorrhizae Combination Compared with Commercial Mycorrhizae Products.

Methods

A DMS and mycorrhizae combination granule composition was formulated as in Example 1 on a bentonite carrier. In two open field trials with half acre plots and two replicates, granules were applied at 10 kg/ha 25-30 days after transplanting the rice crop. This treatment was compared to two commercially available mycorrhizal-based products (Ralligold and Rutoz) and a commercial standard fertilizer. Resulting crops were evaluated for total yield and qualitative growth characteristics.

### Results

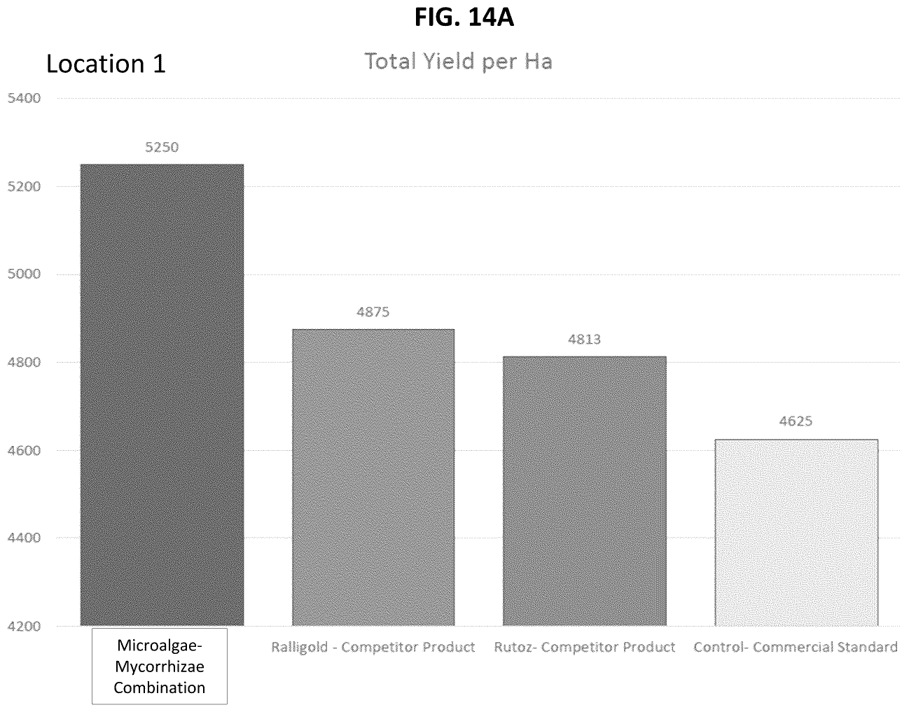

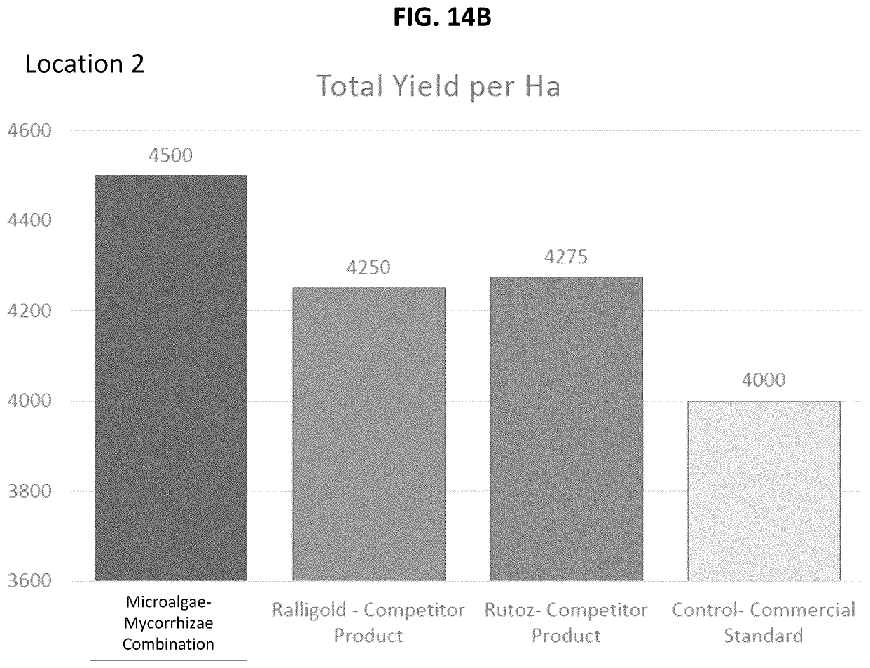

In both locations, the application of an illustrative microalgae and mycorrhizae combination composition of the present disclosure outperformed commercially available mycorrhizal products and commercial standard fertilizer in terms of total yield. These results are shown in FIG. 14A-14B. In addition, qualitatively, 4-5 days after application of the combination composition, plants showed significant dark green foliage with a presumed higher concentration of chlorophyll compared to control. 7-15 days after application, a significant increase in root mass with healthy white roots was observed in the combination treatment. The combination treatment resulted in an increase of 13.51% and 12.50% over control at each location, respectively, better than either commercial mycorrhizal product without microalgae.

### Example 9: Greenhouse Trial in Cucumber with Illustrative Microalgae and Mycorrhizae Combination Compared with Commercial Mycorrhizae Products

### Methods

A DMS and mycorrhizae combination granule composition was formulated as in Example 1 on a bentonite carrier. Granules were applied at 10 kg/ha near the root zone with sufficient soil moisture in a greenhouse based trial with 2 replicates and 120 plants comprised in the plot area. This treatment was compared to two commercially available mycorrhizal-based products (Ralligold and Rutoz) and a commercial standard fertilizer. Resulting crops were evaluated for total and average yield and qualitative growth characteristics.

Results

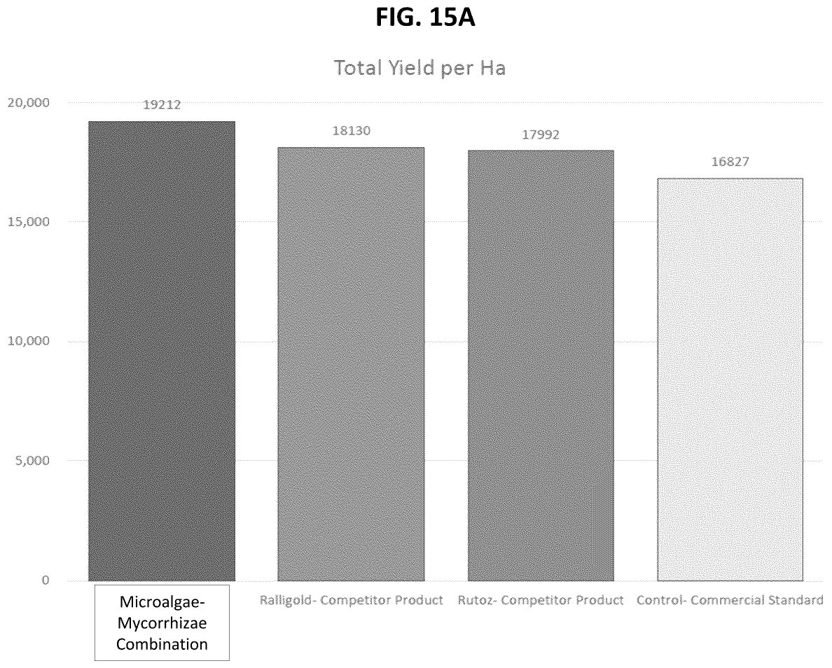

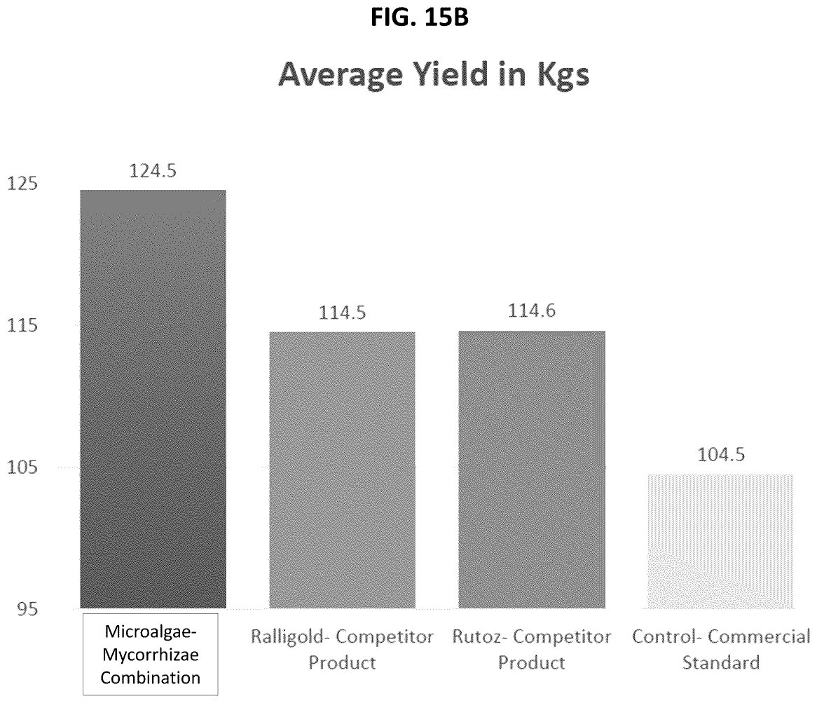

The application of an illustrative microalgae and mycorrhizae combination composition of the present disclosure outperformed commercially available mycorrhizal products and commercial standard fertilizer in terms of overall and average yield. See FIG. 15A-15B. Seven to ten days after application, profuse fruiting was observed in the microalgae/mycorrhizae combination treatment group with dark green foliage and better plant vigor than in the control. The overall yield data shows a 14.17% yield increase for the combination composition over control, while Ralligold and Rutoz products only produced a 7.74% and 6.92% increase over control, respectively.

### Example 10: Field Trial in Summer Maize with Illustrative Microalgae and Mycorrhizae Combination

### Methods

A DMS and mycorrhizae combination granule composition was formulated as in Example I on a bentonite carrier. In an open field trial with half acre plots and 2 replicates.

granules were applied at 10 kg/ha 20 days after sowing and were compared to a control with a commercial standard fertilizer. Resulting crops were evaluated for total yield and qualitative growth characteristics.

### Results

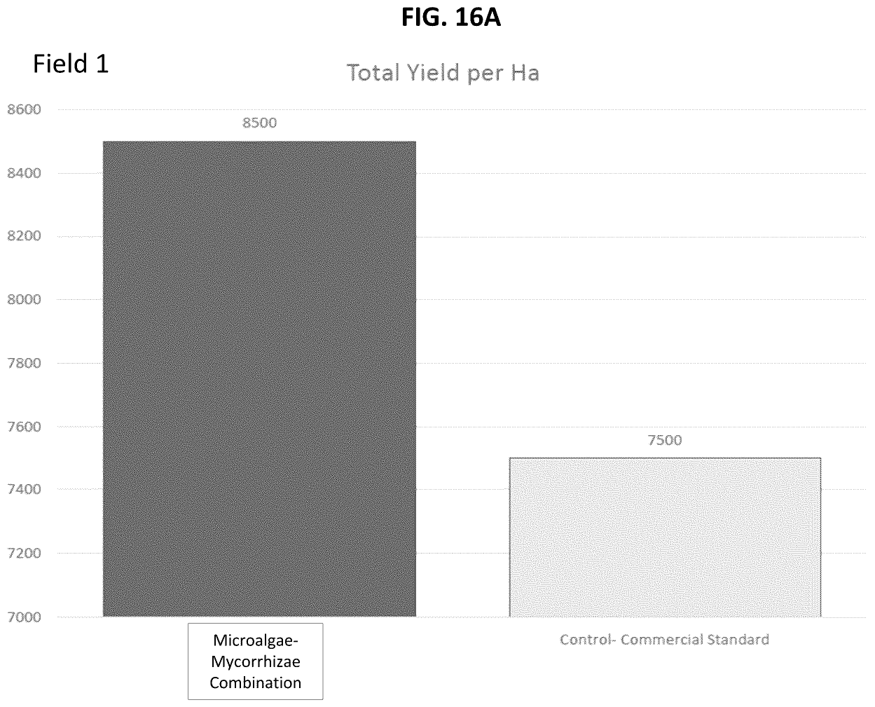

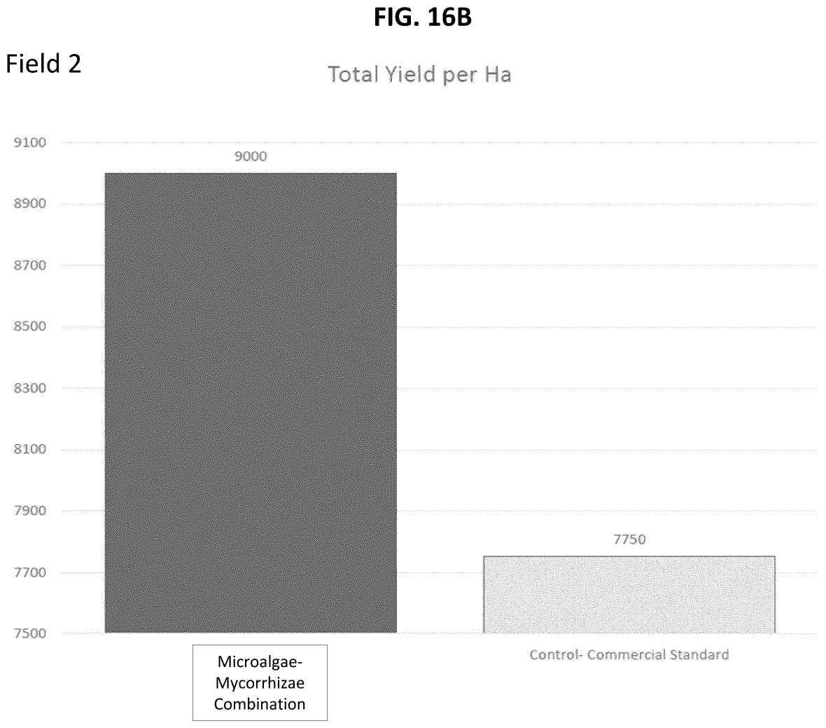

The application of an illustrative microalgae and mycorrhizae combination composition of the present disclosure produced a significant increase in total yield per hectare in both fields, as shown in FIG. 16A-16B. In field 1, the increase was 13.33% over control, and 16.13% over control in field 2. Qualitatively, 8-10 days after application, a visible difference in the amount of dark green foliage was observed compared to control. 20-25 days after application, there was a significant difference in growth, stem girth, root mass, and greener foliage. The number of days to 50% tasseling was 7-10 days earlier in the combination application compared to the control. Cob weight and tip filling was better in treated plants compared to control.

### Example 11: Field Trial in Wheat with Illustrative Microalgae and Mycorrhizae Combination

### Methods

A DMS and mycorrhizae combination granule composition was formulated as in Example 1 on a bentonite carrier. In an open field trial with half acre plots and 2 replicates, granules were applied at 10 kg/ha 25 days after sowing and were compared to a control with a commercial standard fertilizer. Resulting crops were evaluated for total yield and qualitative growth characteristics.

### Results

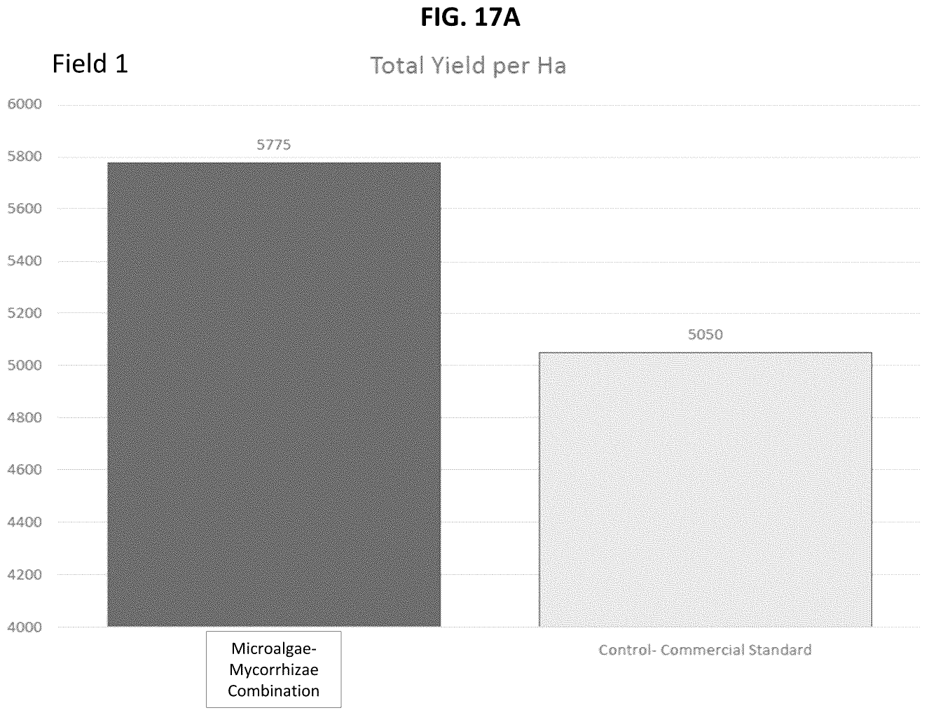

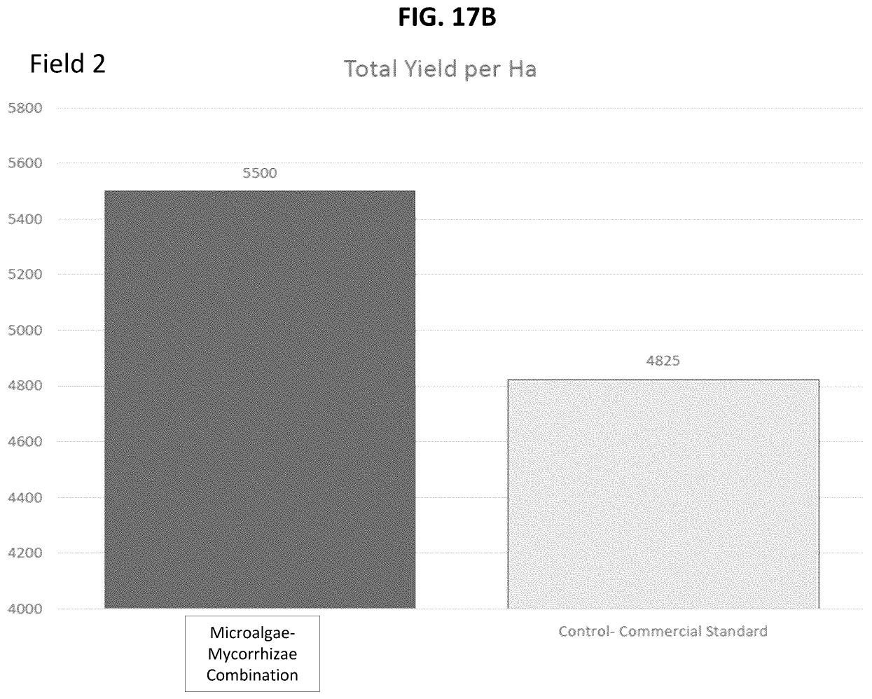

The application of an illustrative microalgae and mycorrhizae combination composition of the present disclosure produced a significant increase in total yield per hectare in both fields, as shown in FIG. 17A-17B. In field 1, the increase was 14.36% over control, and 13.99% over control in field 2. Qualitatively, 8-10 days after application, a visible difference in the amount of dark green foliage was observed compared to control. 15-20 days after application, more profuse root growth and overall plant growth was observed compared to control. The treated plants displayed earlier and more uniform panicle initiation, as well as more grains in spikes than the control plants.

### Example 12: Additional Field Trial in Wheat with Illustrative Microalgae and Mycorrhizae Combination.

### Materials & Methods

A DMS and mycorrhizae combination granule composition was formulated as in Example 1 on a bentonite carrier. Granules were applied at 4 kg/acre with 1-4 applications at sowing, 28-30 days after sowing (“DAS”), 45-50 DAS, and 65-75 DAS plus the recommended dose of fertilizer (“RDF”). Treatment groups were compared to a control with RDF only. Resulting crops were evaluated for growing parameters, production parameters, and biostimulant parameters.

### Results

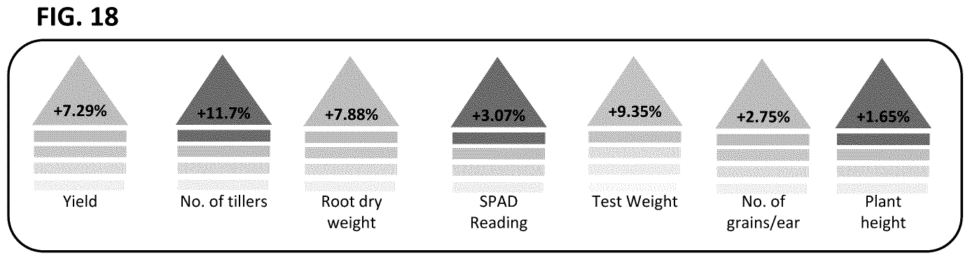

The application of an illustrative microalgae and mycorrhizae combination composition of the present disclosure produced increases in growing parameters, production parameters, and biostimulant parameters in wheat relative to the control crops with RDF alone. The increased parameters included: yield, number of tillers, test weight, root dry weight, SPAD reading (chlorophyll content), number of grains/ear, and plant height, as shown in FIG. 18 and Table 9. Three-dose treatment with 4 kg/acre at 28-30, 45-50, and 65-75 DAS produced the exemplary results displayed in FIG. 18. Similar results were observed for a single dose treatment with 4 kg/acre at 45-50 DAS, as shown in Table 9. Increases were also observed for shoot dry weight at 45 DAS, shoot dry weight at 60 DAS, total tillers at maturity, effective tillers at maturity, ear length, and 1000 grain weight in both treatment conditions compared to the control.

TABLE 9
Exemplary results from application of illustrative compositions to wheat

| | | | Total, | | | | |
|---|---|---|---|---|---|---|---|
| | | | Effective No. | | | | 1000 |
| | Plant | Root dry | of tillers/m | SPAD | Grain | No. | grain |
| Treatment | height | weight | row at | reading | yield | grains/ | weight |
| condition | (cm) | (mg/plant) | maturity | 60 DAS | (q/ha) | ear | (g) |
| 4 kg/acre, | 98.47 | 982.0 | 119.7, 114.3 | 56.4 | 49.75 | 262 | 41.72 |
| 30, 50, 70 | | | | | | | |
| DAS + RDF | | | | | | | |
| 4 kg/acre, | 98.71 | 954.7 | 119.0, 109.7 | 56.4 | 49.44 | 260 | 41.23 |
| 50, 70 DAS | | | | | | | |
| + RDF | | | | | | | |
| Control | 96.87 | 910.2 | 112.0, 102.3 | 55.3 | 46.37 | 255 | 38.15 |
| with RDF | | | | | | | |
| alone | | | | | | | |

### Example 13: Field Trial in Potato with Illustrative Microalgae and Mycorrhizae Combination.

### Materials & Methods

A DMS and mycorrhizae combination granule composition was formulated as in Example 1 on a bentonite carrier. Granules were applied at 4-8 kg/acre at planting along with 500 mL/acre of agricultural Azospirillum treatment at 25 and/or 45 days after planting. Treatment groups were compared to a control with RDF only. Resulting crops were evaluated for growing parameters, production parameters, and biostimulant parameters.

### Results

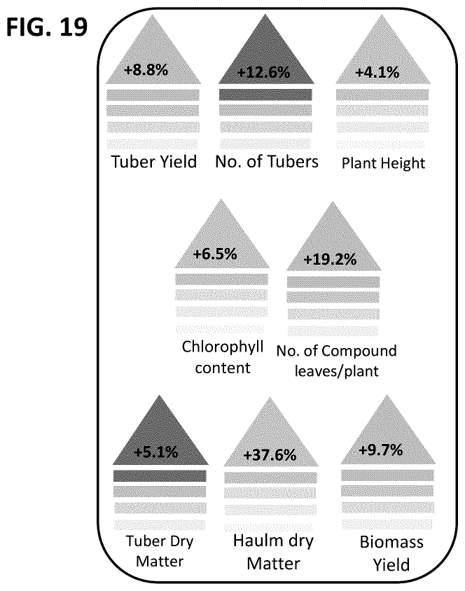

The application of an illustrative microalgae and mycorrhizae combination composition of the present disclosure in combination with Azospirillum produced increases in growing parameters, production parameters, and biostimulant parameters in potatoes relative to the control crops with RDF alone. The increased parameters included: tuber yield, number of tubers, plant height, SPAD reading (chlorophyll content), number of compound leaves/plant, tuber dry matter, haulm dry matter, and biomass yield, as shown in FIG. 19 and Table 10. Treatment with 4 kg/acre at planting plus Azospirillum at 25 and 45 DAP produced the exemplary results displayed in FIG. 19. Increases in this condition were also observed for emergence, number of shoots/plant, plant vigor, proportion of large tubers, and yield of large tubers, compared to the control. Increases in tuber yield, number of tubers, and chlorophyll content were observed for every treatment group compared to control.

TABLE 10
Exemplary results from application of illustrative compositions to potatoes.

| | | | | | | Tuber | Haulm | |
|---|---|---|---|---|---|---|---|---|
| | | | | | No. | dry | dry | |
| | Tuber | No. of | Plant | Chlorophyll | compound | matter | matter | Biomass |
| Treatment | yield | tubers/ | height | content | leaves/ | yield | yield | yield |
| condition | (t/ha) | ha | (cm) | (SPAD) | plant | (t/ha) | (t/ha) | (t/ha) |
| 4 kg/acre, | 37.0 | 769 | 55.9 | 42.5 | 62.7 | 6.85 | 1.50 | 8.35 |
| Azo 25, 45 | | | | | | | | |
| DAP | | | | | | | | |
| Control | 34.0 | 683 | 53.7 | 39.9 | 52.6 | 6.52 | 1.09 | 7.61 |
| with RDF | | | | | | | | |
| alone | | | | | | | | |

### Example 14: Field Trial in Soybean with Illustrative Microalgae and Mycorrhizae Combination

### Methods

A DMS and mycorrhizae combination granule composition was formulated as in Example 1 on a bentonite carrier. Granules were applied to soybean crops at a dose of 4 kg/acre 35 days after sowing. A foliar spray of DMS plus Azospirillum was applied at a dose of 500 mL/acre 56 days after sowing. Treatment was compared to a grower standard control. Resulting crops were evaluated for weight of pods/plant.

### Results

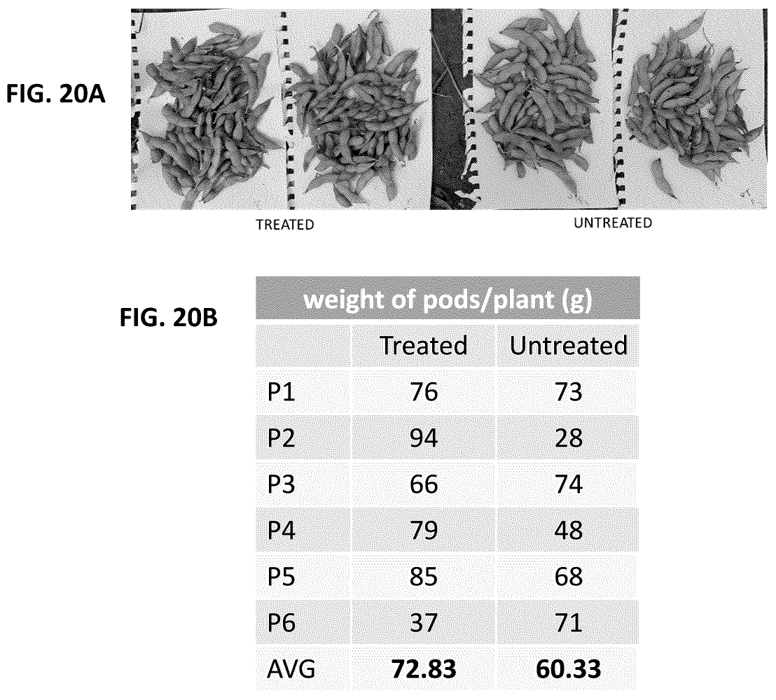

The application of an illustrative microalgae and mycorrhizae combination composition of the present disclosure produced increases in weight of pods per plant for soybean crops, as shown in FIG. 20A-20B.

### Example 15: Formulation of Illustrative Powdered Seed Coating Comprising Microalgae and Mycorrhizae

### Materials & Methods

A whole cell microalgae powder was formulated as in Example 1. The whole cell microalgae powder was mixed with a mycorrhizae powder having the features described in Example 1. The seed coating comprised 80% w/w whole cell microalgae powder and 20% w/w mycorrhizae powder.

Example 16: Field Trial in Soybean and Corn of Illustrative Powdered Seed Coating Comprising Microalgae and Mycorrhizae

Materials & Methods

A powdered seed coating was developed according to Example 15. The seed coating was applied at a dose of 100 g per mass of seeds to be planted in one hectare, regardless of seed weight and crop type: i.e., 100 g of seed coating per 45 kg of seeds for soy beans, and 100 g of seed coating per 40 kg of seeds for corn. Seeds were coated using a mixer at low speed for ten minutes. The treated and untreated planting areas comprised 5,000 m² each. Yield was compared for treated and untreated crops. Soybeans were also co-inoculated with Bradyrhizobium.

### Results

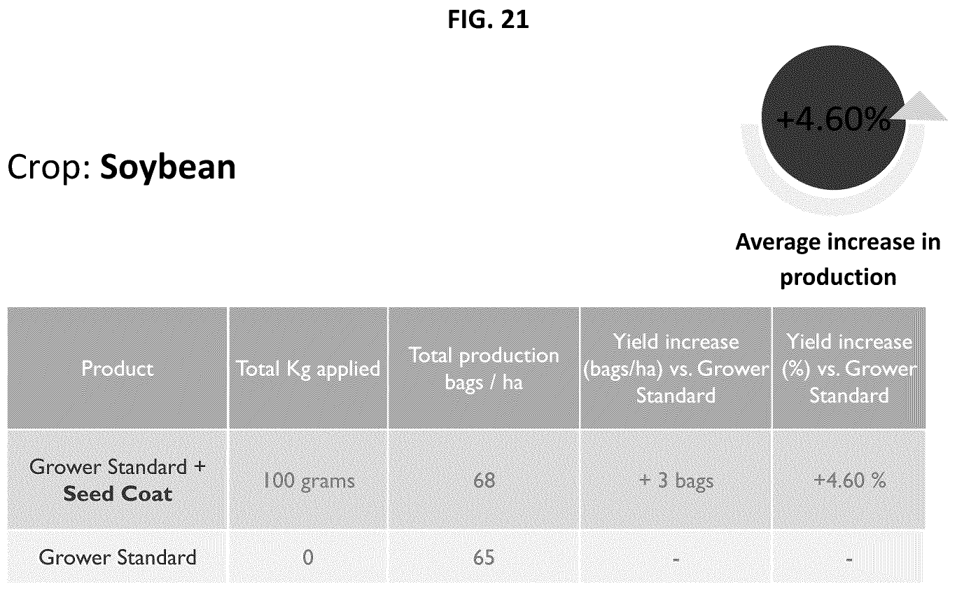

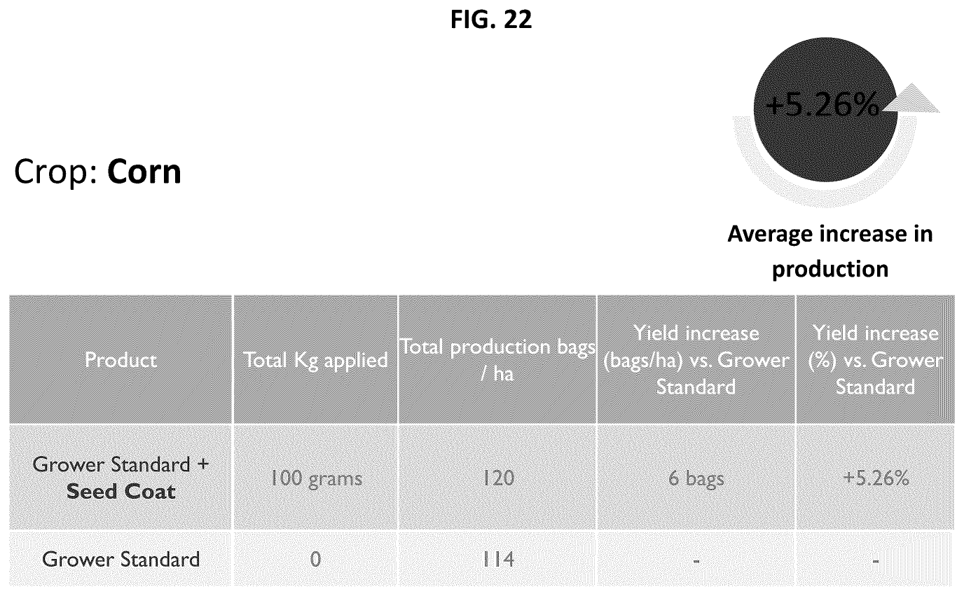

An illustrative application of an exemplary seed coat of the present disclosure comprising microalgae and mycorrhizae resulted in an increase in yield per hectare for each crop type. Results for each crop are summarized in FIG. 21 (soybean) and FIG. 22 (corn). In addition, treated crops were qualitatively observed to have enhanced root mass compared to control.

### Example 17: Reduced Reliance on Exogenous Nitrogen and Phosphorous Supplementation Following Application of Illustrative Granule Composition Comprising Microalgae and Mycorrhizae

### Materials & Methods

Trial 1. A DMS and mycorrhizae combination granule composition was formulated as in Example 1 on a bentonite carrier. Granules were applied to rice tillers at a dose of 4 kg/acre (10 kg/ha) within 15 days of tilling. The different treatments were applied with 3 replicates each. The treatment conditions were:
Control, with the recommended dose of fertilizer (“RDF”), i.e., 100% NPK:
100% NPK plus microalgae/mycorrhizae granules (“MA/Myco”):
90% N plus MA/Myco (P and K at 100%):
80% N plus MA/Myco (P and K at 100%);
70% N plus MA/Myco (P and K at 100%);
90% P plus MA/Myco (N and K at 100%);
80% P plus MA/Myco (N and K at 100%);
70% P plus MA/Myco (N and K at 100%).

Grain yield in q/ha was compared among the treatment conditions. The soil for each treatment group was also evaluated for organic carbon content, available nitrogen, and available phosphorous.

Trial 2. In a second trial in rice, the same granule application was performed. The treatment conditions were:
Control, with the recommended dose of fertilizer (“RDF”), i.e., 100% NPK:
100% NPK plus microalgae/mycorrhizae granules (“MA/Myco”);
80% N plus MA/Myco (P and K at 100%);
80% P plus MA/Myco (N and K at 100%);

Grain yield, chlorophyl content, available soil nitrogen, and grain protein content were compared among the treatment conditions.

### Results

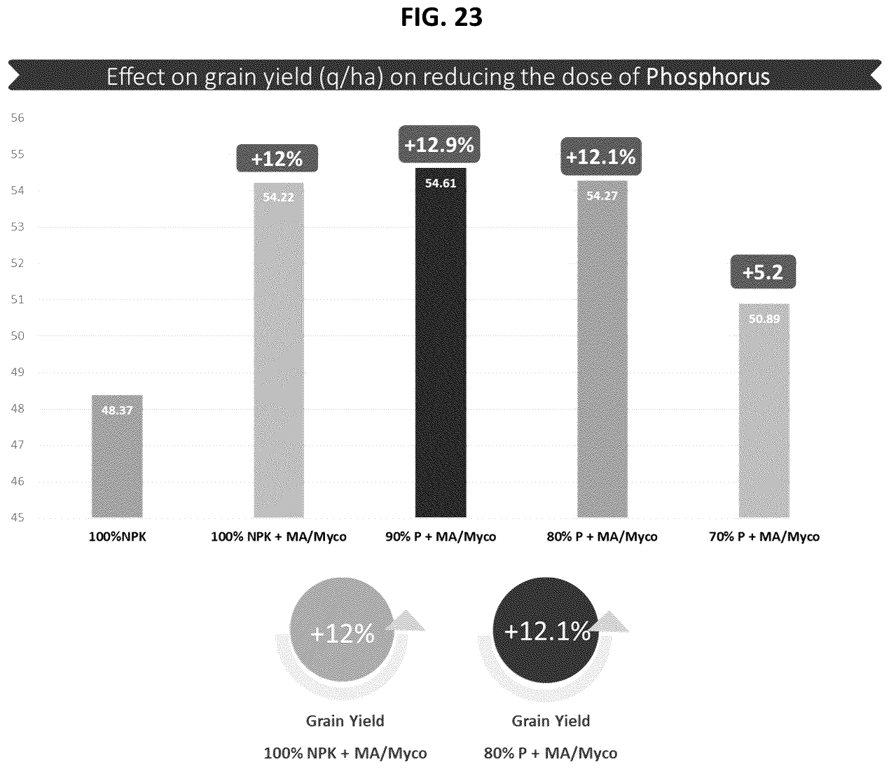

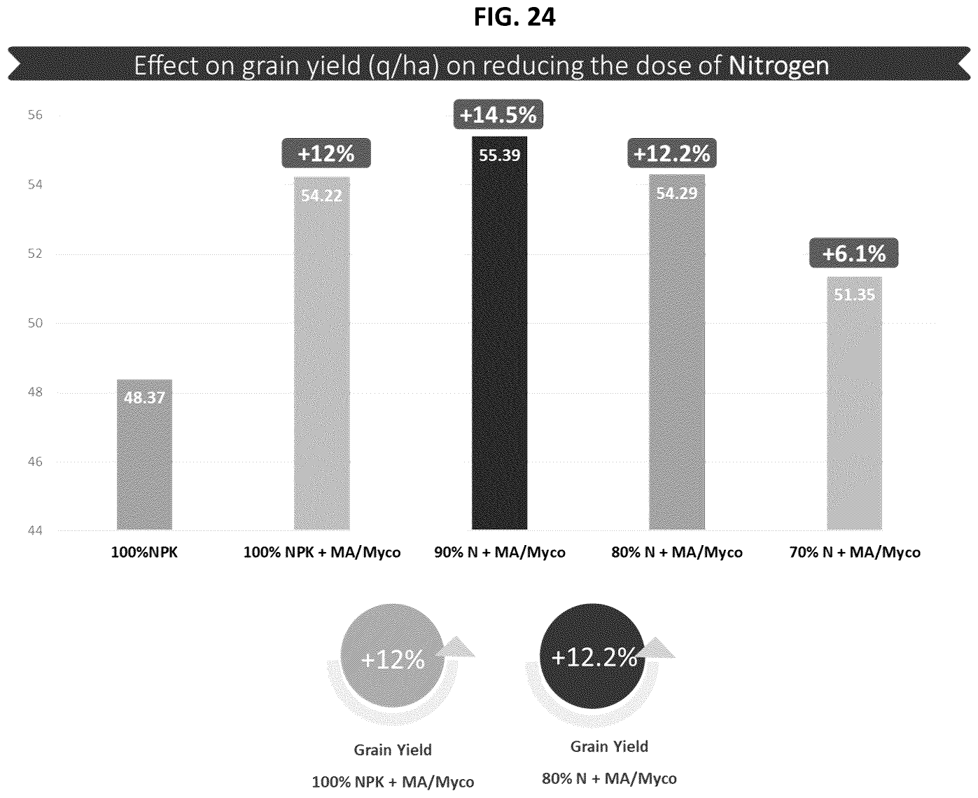

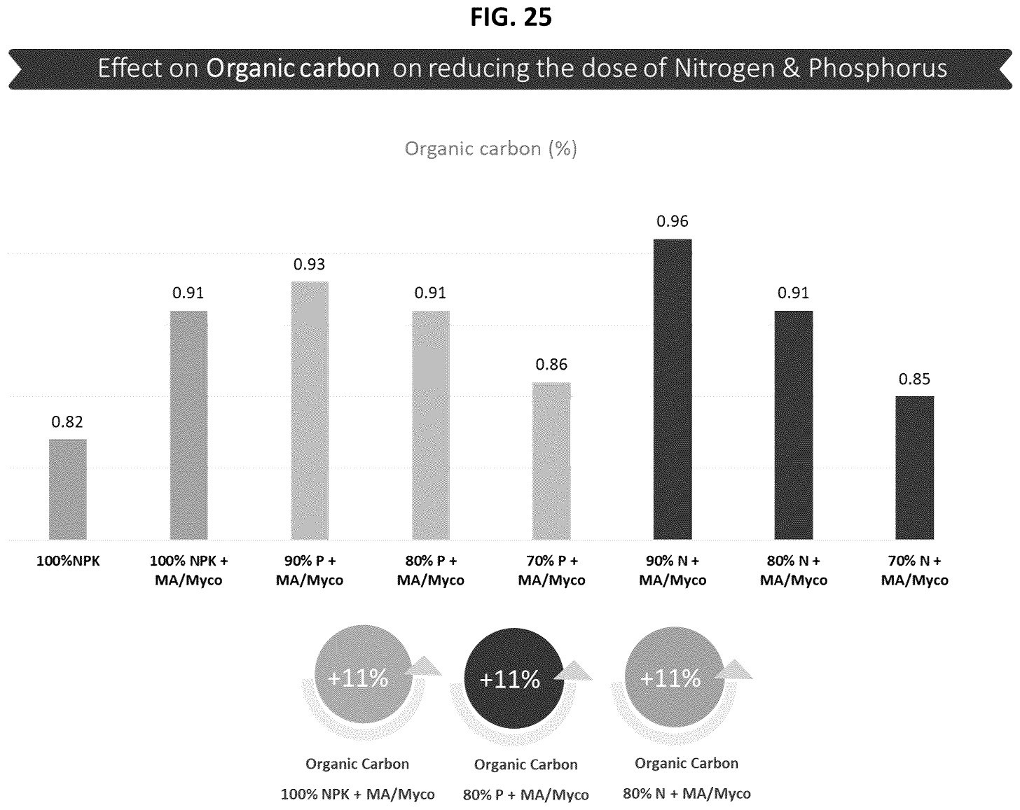

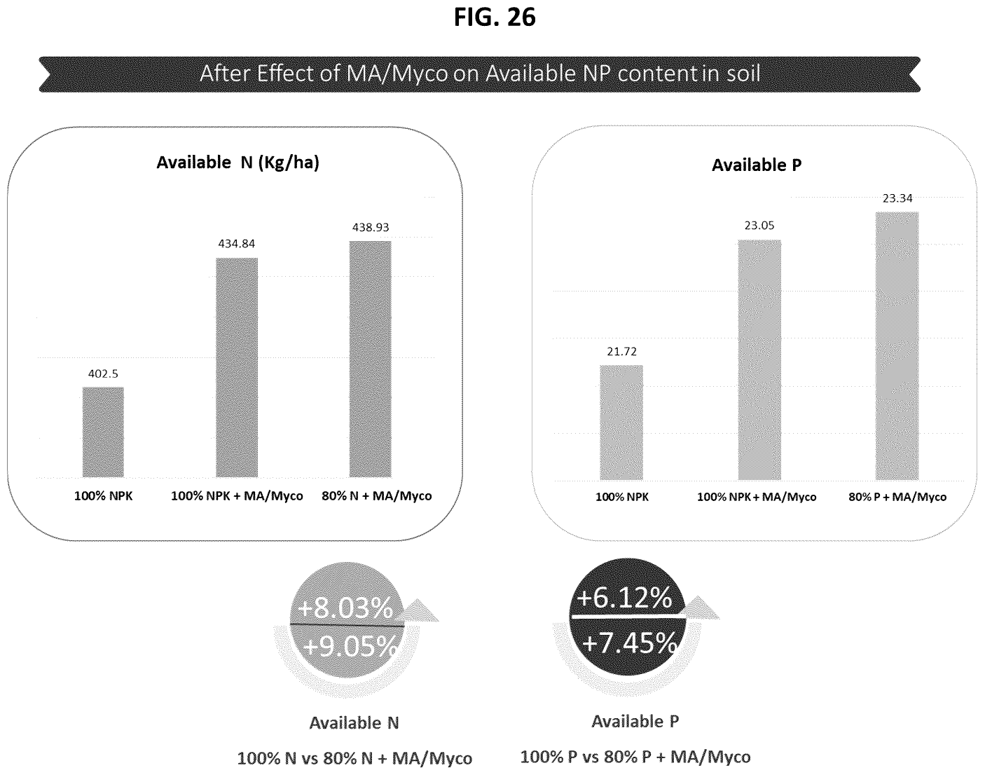

Trial 1. An illustrative application of an exemplary granule composition of the present disclosure comprising microalgae and mycorrhizae resulted in an increase in rice grain yield per hectare compared to RDF alone (i.e., 100% NPK alone). See FIG. 23-26. In addition, application of the microalgae and mycorrhizae granules resulted in less need for exogenous nitrogen or phosphorous application. In particular, FIG. 23 and FIG. 24 show that rice crops treated with MA/Myco granules exhibited greater grain yield than 100% NPK alone, and this remained true even when phosphorous or nitrogen administration was reduced to 70% of the recommended dose. At 80% phosphorous administration+MA/Myco (see FIG. 23) or at 80% nitrogen administration+MA/Myco (see FIG. 24), grain yield was virtually identical to the yield at 100% NPK+MA/Myco, demonstrating reduced reliance on exogenous phosphorous/nitrogen application to achieve higher yield. This decreased reliance on exogenous fertilizer supplementation has the potential to decrease the environmental toll from fertilizer application. FIG. 25 and FIG. 26 also show improved organic carbon, available nitrogen, and available phosphorous for the conditions with MA/Myco application and reduced exogenous nitrogen/phosphorous supplementation compared to RDF alone. In fact, FIG. 26 demonstrates higher available nitrogen and available phosphorous in the soil with 80% nitrogen or phosphorous administration, respectively, than with 100% nitrogen or phosphorous supplementation.

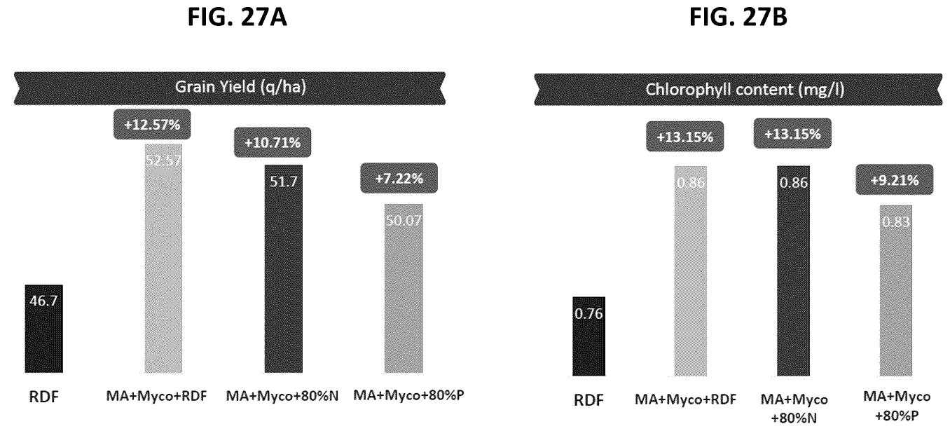

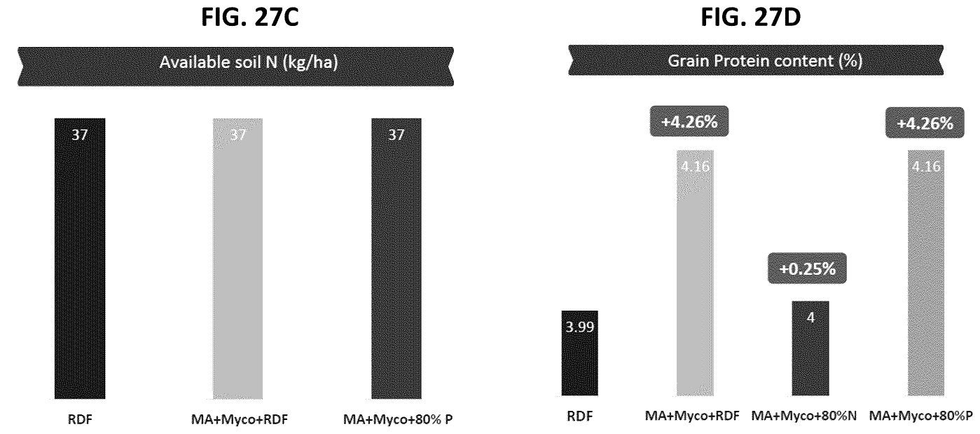

Trial 2. In a second trial testing reduced nitrogen and phosphorous supplementation in rice, grain yield for MA/Myco treatment conditions with RDF, 80% N or 80% P outperformed RDF alone (FIG. 27A). Chlorophyl content was similarly increased across all three MA/Myco treatment conditions, in spite of decreased nitrogen or phosphorous application (FIG. 27B). Available soil nitrogen did not differ between RDF alone, MA/Myco +RDF, and MA/Myco +80% P conditions (FIG. 27C). Grain protein content was raised in all MA/Myco treated conditions compared to control, with highest results in the MA/Myco +RDF and MA/Myco +80% P conditions (FIG. 27D). These results demonstrate that MA/Myco granule application allows for consistent increases in grain yield and other soil and biostimulant parameters, with decreased reliance on exogenous nitrogen and phosphorous fertilizers.

### Example 18: Improved Lettuce Plant Growth with Illustrative Granule Composition without Chemical Supplementation

### Materials and Methods

A granule composition comprising microalgae and mycorrhizae on a zeolite carrier (“MA/Myco”) was formulated as in Example 1. Lettuce seedlings were grown from seed, and seedlings were transplanted and grown to maturity at the test site. The test site temperature was maintained at 20° C., with 10 hours of light and 14 hours of darkness daily. Four treatment groups were tested:
A, Control: no chemical or MA/Myco composition supplementation:
B, Chemical fertilizer: diammonium phosphate (DAP) applied at 10 kg/da:
C, 50% chemical fertilizer+50% MA/Myco: 50% DAP, applied at 5 kg/da, along with MA/Myco application at 0.5 kg/da: and
D, MA/Myco: application of MA/Myco granule formulation only at 1 kg/da.

Treatments were applied three times. First, the treatments were applied immediately after planting seeds. Seedlings were obtained 2 weeks after sowing and were transferred to pots. Treatments were applied immediately after transfer. Treatments were applied again 3 weeks after sowing. All pots were watered the same amount every two days. The trial ended after 6 weeks, on day 42 after sowing. Plant height, root length, leaf length, leaf width, plant wet yield, plant dry yield, and chlorophyll content were measured at the end of the trial.

### Results

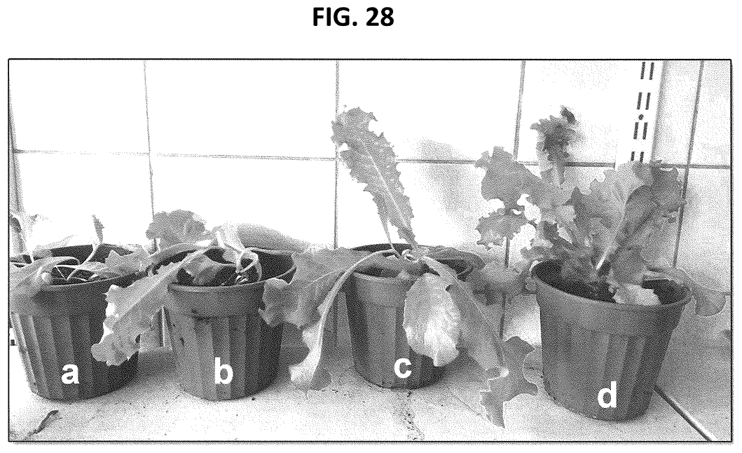

Results of this trial are shown in Table 11 below with different letters corresponding to different groupings of statistical significance. Images of representative plants are shown in FIG. 28.

TABLE 11
Results of DAP and MA/Myco Application to Lettuce Plants.

| | Plant | Root | | Leaf | Leaf | | | | | Chlorophyll |
|---|---|---|---|---|---|---|---|---|---|---|
| | Height | Length | | Length | Width | | Plant | Plant Dry | | Content |
| Application | (cm) | (cm) | | (cm) | (cm) | | Yield (g) | Yield (g) | | (SPAD) |
| Control | 22.86 C | 6.03 | | 15.86 C | 8.16 | d | 16.86 C | 5.66 | C | 33.63 C |
| Chemical | 32.10 b | 7.18 | b | 22.43 b | 11.76 | C | 30.40 b | 10.20 | b | 42.76 b |
| 50% | 34.96 b | 7.18 | b | 24.70 b | 14.26 | b | 33.33 b | 11.63 | b | 44.50 b |
| Chemical + | | | | | | | | | | |
| MA/Myco | | | | | | | | | | |
| MA/Myco | 46.80 m | 13.00 | a | 35.33 m | 23.00 | m | 63.87 m | 26.37 | m | 55.53 m |

Surprisingly, the results in Table 11 and FIG. 27 demonstrate that the treatment group with MA/Myco granules alone outperformed all other treatment groups along all tested parameters.

### Example 19: Field Trial in Sugarcane with Illustrative Microalgae and Mycorrhizae Combination

### Materials & Methods

Bentonite granules comprising 2.5% DMS and 2.0% mycorrhizae were applied at a rate of 20 kg/ha to sugarcane crops at different time points: planting, first fertilizer time point, and last fertilizer time point. These were compared to control farmer practice without MA/Myco granule application.

The different crop treatments were then evaluated for cane yield (t/ha), commercial cane sugar (CCS) (expressed as a %), sugar content (%), and sucrose content (%).

### Results

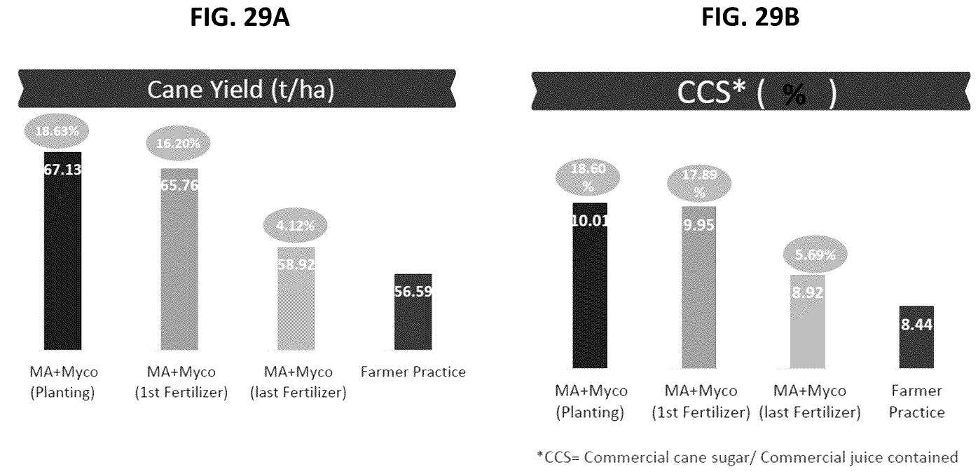

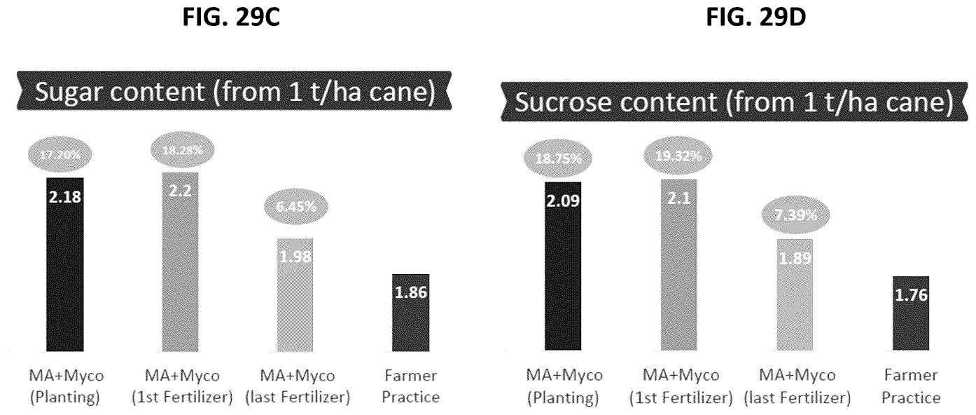

Application of the MA/Myco granules at all three time points resulted in improvements in all tested parameters. See FIG. 29A-D. The highest increases were observed for application at planting or first fertilizer time point. These results demonstrate significant and remarkable increases in cane yield (up to 18.63%), CCS (up to 18.60%), sugar content (up to 18.28%), and sucrose content (up to 19.32%) in sugar crops following administration of an illustrative MA/Myco granule composition of the disclosure.

### Example 20: Increase in Soil Microbial Content Following Application of Illustrative MA/Myco Granule Composition in Rice

### Materials & Methods

The MA/Myco bentonite granule composition of preceding examples comprising 2.5% DMS and 2.0% mycorrhizae was applied to the soil of paddy rice at a rate of 10 kg/ha at 12 DAT, 30 DAT, or 48 DAT. These conditions were compared to a control farmer practice condition without application of the MA/Myco granules.

Grain yield, total chlorophyl content, and soil microbial count were tested among the treatment groups. Soil samples were collected at time of harvest and observed under microscope to quantify microbial spore count.

### Results

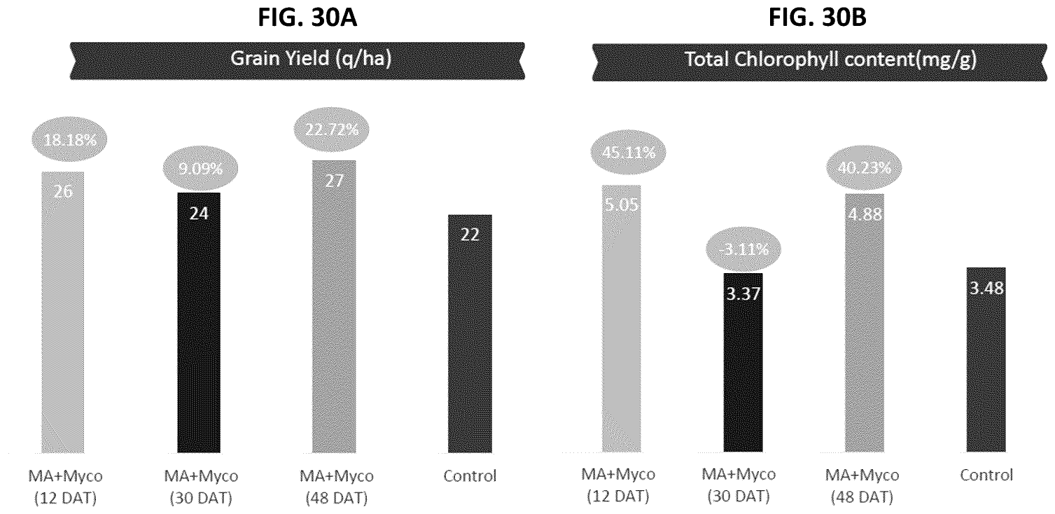

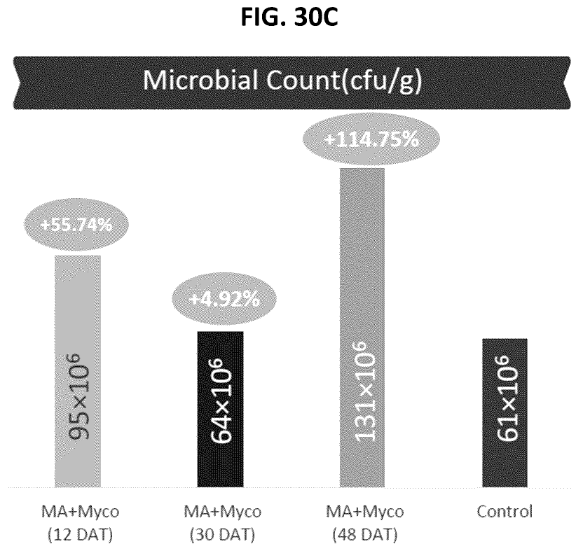

As shown in FIG. 30A, all three MA/Myco treatment conditions resulted in increased grain yield, with best results observed with application at 12 or 48 DAT. FIG. 30B shows increased chlorophyl content for both 12 and 48 DAT application conditions, while application at 30 DAT resulted in chlorophyl content comparable to control. Microbial count (FIG. 30C) was dramatically increased in the 12 DAT and 48 DAT application conditions. In particular, application of the MA/Myco granules at 48 DAT resulted in more than double the microbial count compared to control. These results demonstrate improved yield and soil health properties following application of an illustrative MA/Myco composition of the disclosure in paddy rice.

### Example 21: Preliminary Germination Data from Myco+WCMP Seed Coatings in Soybean Trial

### Materials & Methods

A powdered seed coating comprising 80% WCMP and 20% mycorrhizae was formulated according to Example 15. The mycorrhizae comprised 3000 spores/g. Application of Myco/WCMP was compared to WCMP alone and Myco alone conditions. These were applied to soybeans as a seed coating prior to planting. All three formulations were tested at normal dosing, half dosing, quarter dosing, eighth dosing, and double dosing levels. See Table 12, below.

TABLE 12
Treatments and seed coating dosages.

| Treatment | | |
|---|---|---|
| Number | Treatment Description | Dose in g/ha |
| 1 | Control | 0 |
| 2 | Myco (1x) | 20 |
| 3 | Myco (½) | 10 |
| 4 | Myco (¼) | 5 |
| 5 | Myco (⅛) | 2.5 |
| 6 | Myco (2x) | 40 |
| 7 | WCMP (1x) | 80 |
| 8 | WCMP (½) | 40 |
| 9 | WCMP (¼) | 20 |
| 10 | WCMP (⅛) | 10 |
| 11 | WCMP (2x) | 160 |
| 12 | MYCO + WCMP (1x) | 100 |
| 13 | MYCO + WCMP (½) | 50 |
| 14 | MYCO + WCMP (¼) | 25 |
| 15 | MYCO + WCMP (⅛) | 12.5 |
| 16 | MYCO + WCMP (2x) | 200 |

All conditions were measured for root length, root mass, aerial height, and aerial biomass at 15 and 30 days after emergence.

### Results

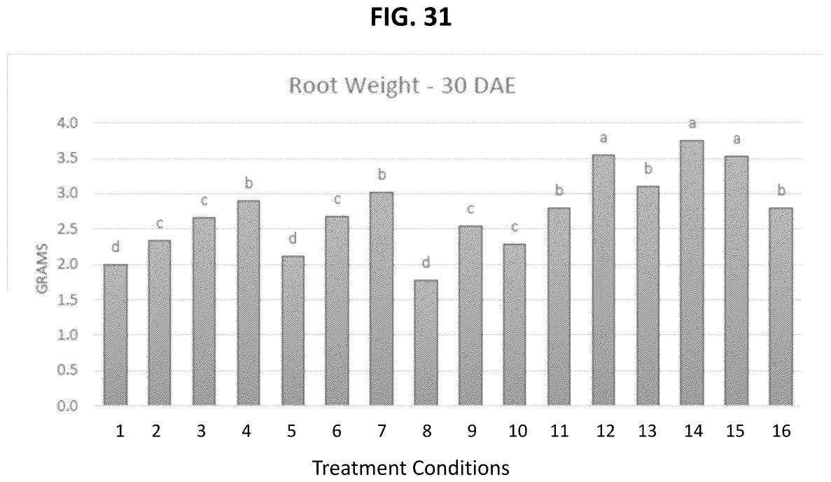

Root length was within variance for all treatment groups at 30 days after emergence. Aerial height and mass varied between treatment groups, without clear trends at this early stage of sampling. Root mass, however, showed a clear general increase in Myco+WCMP treatment groups compared to Myco or WCMP alone conditions at 30 DAE (FIG. 31).

These results demonstrate that powdered seed coatings comprising a combination of mycorrhizae and microalgae can improve soybean root development even early on in the growing cycle compared to either component alone.

### INCORPORATION BY REFERENCE

All references, articles, publications, patents, patent publications, and patent applications cited herein are incorporated by reference in their entireties for all purposes. However, mention of any reference, article, publication, patent, patent publication, and patent application cited herein is not, and should not be taken as an acknowledgment or any form of suggestion that they constitute valid prior art or form part of the common general knowledge in any country in the world.

NUMBERED EMBODIMENTS OF THE INVENTION

Notwithstanding the appended claims, the disclosure sets forth the following numbered embodiments:
1. An agricultural granule composition, comprising:
   a) microalgae:
   b) mycorrhizae; and
   c) a carrier granule.
2. The composition of embodiment 1, wherein the composition comprises multiple species of microalgae.
3. The composition of any one of embodiments 1-2, wherein the composition comprises microalgae from a phylum selected from the list consisting of: Chlorophyta, Cryptophyta, Cyanophyta, Euglenophyta, Heterokontophyta, or Rhodophyta.
4. The composition of any one of embodiments 1-3, wherein the composition comprises microalgae from a genus selected from the list consisting of: Chlorella, Scenedesmus, Nannochloropsis, Muriellopsis, Isochrysis, Tisochrysis, Desmodesmus, Haematococcus, Arthrospira, and Anabaena.
5. The composition of any one of embodiments 1-4, wherein the microalgae are dried and/or lysed.
6. The composition of any one of embodiments 1-5, wherein the composition comprises microalgae in the form of a digested microalgae solution (“DMS”) or whole-cell microalgae powder.
7. The composition of any one of embodiments 1-6, wherein the composition comprises about 0.5% to 5.0% w/w DMS.
8. The composition of any one of embodiments 1-7, wherein the composition comprises about 0.5% to 5.0% w/w DMS, and wherein the DMS comprises about 5% to 15% w/w dry matter.
9. The composition of any one of embodiments 1-8, wherein the dry weight of the composition comprises about 0.05% to 5% w/w microalgae dry matter.
10. The composition of any one of embodiments 1-9, wherein the dry weight of the composition comprises about 0.5-5.0% w/w mycorrhizae.
11. The composition of any one of embodiments 1-10, wherein the mycorrhizae comprise 100-10,000 spores/gram.
12. The composition of any one of embodiments 1-11, wherein the composition comprises 500-500,000 spores of mycorrhizae per kg of composition.
13. The composition of any one of embodiments 1-12, wherein the mycorrhizae comprise a combination of ectomycorrhizae and endomycorrhizae.
14. The composition of any one of embodiments 1-13, wherein the mycorrhizae comprise predominantly endomycorrhizae.
15. The composition of any one of embodiments 1-14, wherein the mycorrhizae comprise more than about 90% endomycorrhizae.
16. The composition of any one of embodiments 1-15, wherein the carrier granule is zeolite or bentonite.
17. The composition of any one of embodiments 1-16, wherein the carrier granule is zeolite, and wherein the dry weight of the composition comprises greater than 80% w/w zeolite.
18. The composition of any one of embodiments 1-17, wherein the composition is applied to an agricultural crop.
19. The composition of any one of embodiments 1-18, wherein the composition is applied to an agricultural crop that is a monocot or a dicot.
20. The composition of any one of embodiments 1-19, wherein the composition is applied to an agricultural crop selected from the list consisting of agronomical crops, horticultural crops, and ornamental crops.
21. The composition of any one of embodiments 1-20, wherein application of the composition to an agricultural crop results in an increase in a growth, production, or biostimulant parameter of the agricultural crop in comparison to a control agricultural crop without the composition.
22. The composition of any one of embodiments 1-21, wherein application of the composition to an agricultural crop results in an increase in a growth, production, or biostimulant parameter of the agricultural crop in comparison to a control agricultural crop without the composition, wherein the application occurs during or soon after planting.
23. The composition of any one of embodiments 1-22, wherein application of the composition to an agricultural crop results in an increase in a growth, production, or biostimulant parameter of the agricultural crop in comparison to a control agricultural crop without the composition, wherein the parameter is selected from the group consisting of: yield, height, nutrient concentration, and chlorophyl content of leaves.
24. The composition of any one of embodiments 1-23, wherein application of the composition to an agricultural crop results in an increase in the height of the agricultural crop in comparison to a control agricultural crop without the composition.
25. The composition of any one of embodiments 1-24, wherein application of the composition to an agricultural crop results in an increase in a nutrient concentration within the agricultural crop in comparison to a control agricultural crop without the composition.
26. The composition of any one of embodiments 1-25, wherein application of the composition to an agricultural crop results in an increase in a nutrient concentration within the agricultural crop in comparison to a control agricultural crop without the composition, wherein the nutrient is selected from the group consisting of: nitrogen content of leaves, magnesium content of roots, manganese content of roots, copper content of roots, and potassium content of roots.
27. The composition of any one of embodiments 1-26, wherein the combination of microalgae, mycorrhizae, and zeolite produces a synergistic improvement on a growth, production, or biostimulant parameter of an agricultural crop after application.
28. The composition of any one of embodiments 1-27, wherein the combination of the microalgae, mycorrhizae, and zeolite components of the compositions produces an improvement on a growth, production, or biostimulant parameter of an agricultural crop after application, wherein the improvement is greater than that observed for any one or two of the components alone.
29. A method for increasing the yield of an agricultural crop, the method comprising:
   a) applying the composition of any one of embodiments 1-28 to the agricultural crop.
30. A method for increasing the yield of an agricultural crop, the method comprising:
   a) applying an agricultural granule composition to the agricultural crop, the composition comprising microalgae, mycorrhizae, and a carrier granule.
31. A method for improving a production, growth, or biostimulant parameter of an agricultural crop, the method comprising:
   a) applying an agricultural granule composition to the agricultural crop, the composition comprising microalgae, mycorrhizae, and a carrier granule.
32. The method of any one of embodiments 29-31, wherein the composition comprises multiple species of microalgae.
33. The method of any one of embodiments 29-32, wherein the composition comprises microalgae from a phylum selected from the list consisting of: Chlorophyta, Cryptophyta, Cyanophyta, Euglenophyta, Heterokontophyta, or Rhodophyta.
34. The method of any one of embodiments 29-33, wherein the composition comprises microalgae from a genus selected from the list consisting of: Chlorella, Scenedesmus, Nannochloropsis, Muriellopsis, Isochrysis, Tisochrysis, Desmodesmus, Haematococcus, Arthrospira, and Anabaena.
35. The method of any one of embodiments 29-34, wherein the microalgae are dried and/or lysed.
36. The method of any one of embodiments 29-35, wherein the composition comprises microalgae in the form of a digested microalgae solution (“DMS”) or whole-cell microalgae powder.
37. The method of any one of embodiments 29-36, wherein the composition comprises about 0.5% to 5.0% w/w DMS.
38. The method of any one of embodiments 29-37, wherein the composition comprises about 0.5% to 5.0% w/w DMS, and wherein the DMS comprises about 5% to 15% w/w dry matter.
39. The method of any one of embodiments 29-38, wherein the dry weight of the composition comprises about 0.05% to 0.5% w/w microalgae dry matter.
40. The method of any one of embodiments 29-39, wherein the dry weight of the composition comprises about 0.5-5.0% w/w mycorrhizae.
41. The method of any one of embodiments 29-40, wherein the mycorrhizae comprise 100-10,000 spores/gram.
42. The method of any one of embodiments 29-41, wherein the composition comprises 500-500,000 spores of mycorrhizae per kg of composition.
43. The method of any one of embodiments 29-42, wherein the mycorrhizae comprise a combination of ectomycorrhizae and endomycorrhizae.
44. The method of any one of embodiments 29-43, wherein the mycorrhizae comprise predominantly endomycorrhizae.
45. The method of any one of embodiments 29-44, wherein the mycorrhizae comprise more than about 90% endomycorrhizae.
46. The method of any one of embodiments 29-45, wherein the carrier granule is zeolite or bentonite.
47. The method of any one of embodiments 29-46, wherein the dry weight of the composition comprises greater than 80% w/w carrier granule.
48. The method of any one of embodiments 29-47, wherein the agricultural crop is a monocot or a dicot.
49. The method of any one of embodiments 29-48, wherein the agricultural crop is selected from the list consisting of agronomical crops, horticultural crops, and ornamental crops.
50. The method of any one of embodiments 29-49, wherein application of the composition to the agricultural crop results in an increase in a growth, production, or biostimulant parameter of the agricultural crop in comparison to a control agricultural crop without the composition.
51. The method of any one of embodiments 29-50, wherein application of the composition to the agricultural crop results in an increase in a growth, production, or biostimulant parameter of the agricultural crop in comparison to a control agricultural crop without the composition, wherein the application occurs during or soon after planting.
52. The method of any one of embodiments 29-51, wherein application of the composition to the agricultural crop results in an increase in a growth, production, or biostimulant parameter of the agricultural crop in comparison to a control agricultural crop without the composition, wherein the parameter is selected from the group consisting of: yield, height, nutrient concentration, and chlorophyl content of leaves.
53. The method of any one of embodiments 29-52, wherein application of the composition to the agricultural crop results in an increase in the height of the agricultural crop in comparison to a control agricultural crop without the composition.
54. The method of any one of embodiments 29-53, wherein application of the composition to the agricultural crop results in an increase in a nutrient concentration within the agricultural crop in comparison to a control agricultural crop without the composition.
55. The method of any one of embodiments 29-54, wherein application of the composition to the agricultural crop results in an increase in a nutrient concentration within the agricultural crop in comparison to a control agricultural crop without the composition, wherein the nutrient is selected from the group consisting of: nitrogen content of leaves, magnesium content of roots, manganese content of roots, copper content of roots, and potassium content of roots.
56. The method of any one of embodiments 29-55, wherein the combination of microalgae, mycorrhizae, and zeolite produces a synergistic improvement on a growth, production, or biostimulant parameter of the agricultural crop after application.
57. The method of any one of embodiments 29-56, wherein the combination of the microalgae, mycorrhizae, and zeolite components of the compositions produces an improvement on a growth, production, or biostimulant parameter of the agricultural crop after application, wherein the improvement is greater than that observed for any one or two of the components alone.
58. The method of any one of embodiments 29-57, wherein the composition is applied to the soil around the agricultural crop.
59. The method of any one of embodiments 29-58, wherein the composition is applied to the soil around the agricultural crop via mechanized and/or hand broadcast.
60. The method of any one of embodiments 29-59, wherein the composition is applied to the soil around the agricultural crop at a rate of about 5-15 kg/ha or about 100,000-2,000,000 mycorrhizae spores/ha.
61. A powdered microbial seed coating composition, comprising:
   a) microalgae; and
   b) mycorrhizae and/or Rhizobium.
62. The composition of embodiment 61, wherein the composition comprises multiple species of microalgae.
63. The composition of any one of embodiments 61-62, wherein the composition comprises microalgae from a phylum selected from the list consisting of: Chlorophyta, Cryptophyta, Cyanophyta, Euglenophyta, Heterokontophyta, or Rhodophyta.
64. The composition of any one of embodiments 61-63, wherein the composition comprises microalgae from a genus selected from the list consisting of: Chlorella, Scenedesmus, Nannochloropsis, Muriellopsis, Isochrysis, Tisochrysis, Desmodesmus, Haematococcus, Arthrospira, and Anabaena.
65. The composition of any one of embodiments 61-64, wherein the microalgae are dried and ground.
66. The composition of any one of embodiments 61-65, wherein the microalgae comprises whole-cell microalgae powder.
67. The composition of any one of embodiments 61-66, wherein the microalgae comprises whole-cell microalgae powder having an average particle size of about 100-1,000 microns.
68. The composition of any one of embodiments 61-67, wherein the composition comprises about 10-90% w/w microalgae.
69. The composition of any one of embodiments 61-68, wherein the composition comprises about 80% w/w microalgae.
70. The composition of any one of embodiments 61-69, wherein the mycorrhizae comprise a combination of ectomycorrhizae and endomycorrhizae.
71. The composition of any one of embodiments 61-70, wherein the mycorrhizae comprise predominantly endomycorrhizae.
72. The composition of any one of embodiments 61-71, wherein the mycorrhizae comprise more than about 90% endomycorrhizae.
73. The composition of any one of embodiments 61-72, wherein the composition comprises about 10-90% w/w mycorrhizae.
74. The composition of any one of embodiments 61-73, wherein the composition comprises about 20% w/w mycorrhizae.
75. The composition of any one of embodiments 61-74, wherein the mycorrhizae comprise 100-10,000 spores/gram.
76. The composition of any one of embodiments 61-75, wherein the composition comprises about 10-9,000 spores of mycorrhizae per gram of composition.
77. The composition of any one of embodiments 61-76, wherein the mass ratio of microalgae to mycorrhizae is about 2:1, 3:1, 4:1, or 5:1.
78. The composition of any one of embodiments 61-77, wherein the mass ratio of microalgae to mycorrhizae is about 4:1.
79. The composition of any one of embodiments 61-78, wherein the composition comprises a diazotrophic bacterium.
80. The composition of any one of embodiments 61-79, wherein the composition comprises a bacterium of the genus Anabaena, Azoarcus, Azorhizobium, Azospirillum, Azotobacter, Bacillus, Bradyrhizobium, Burkholderia, Clostridium, Frankia, Gluconacetobacter, Herbaspirillum, Klebsiella, Mesorhizobium, Nitrosospira, Nostoc, Paenibacillus, Parasponia, Pseudomonas, Rhizobium, Rhodobacter, Sinorhizobium, Spirillum, or Xanthomonus.
81. The composition of any one of embodiments 61-80, wherein the composition comprises a bacterium of the genus Azospirillum, Rhizobium, or Bradyrhizobium.
82. The composition of any one of embodiments 61-81, wherein the composition comprises a bacterium of the species Bradyrhizobium japonicum.
83. The composition of any one of embodiments 61-82, wherein the composition comprises a binder.
84. The composition of any one of embodiments 61-83, wherein the composition comprises a binder, and wherein the binder is a hydrocolloid binder.
85. The composition of any one of embodiments 61-84, wherein the composition comprises a binder, and wherein the binder comprises about 10-30% of the composition.
86. The composition of any one of embodiments 61-85, wherein application of the composition to a seed of an agricultural crop prior to planting improves the agricultural crop's survival against abiotic stress.
87. The composition of any one of embodiments 61-86, wherein application of the composition to a seed of an agricultural crop prior to planting improves the agricultural crop's survival against abiotic stress, and wherein the abiotic stress is selected from temperature stress, water stress, and salt stress.
88. The composition of any one of embodiments 61-87, wherein application of the composition to a seed of an agricultural crop prior to planting improves a growing parameter, production parameter, or biostimulant parameter of the agricultural crop.
89. The composition of any one of embodiments 61-88, wherein application of the composition to a seed of an agricultural crop prior to planting improves a growing parameter, production parameter, or biostimulant parameter of the agricultural crop, and wherein the parameter is selected from the list consisting of: biomass, number of roots, root mass, number of secondary roots, uniformity of flowering, yield, productivity, chlorophyl content, carotenoid profile, water absorption capacity, nutrient absorption, and degree of inoculation by diazotrophic bacteria.
90. The composition of any one of embodiments 61-89, wherein the composition is comprised as a coating on a seed from an agricultural crop.
91. The composition of any one of embodiments 61-90, wherein the composition is comprised as a coating on a seed from an agricultural crop, and wherein the agricultural crop is a monocot or dicot.
92. The composition of any one of embodiments 61-91, wherein the composition is comprised as a coating on a seed from an agricultural crop, and wherein the agricultural crop is an agronomical crop, horticultural crop, or ornamental plant.
93. A seed of an agricultural crop comprising a composition according to any one of embodiments 61-92.
94. A method for increasing the yield of an agricultural crop, the method comprising:
   a) applying the composition of any one of embodiments 61-92 to a seed of the agricultural crop prior to planting.
95. A method for increasing the yield of an agricultural crop, the method comprising:
   a) applying a powdered microbial seed coating composition to a seed of the agricultural crop before planting, wherein the composition comprises microalgae and mycorrhizae.
96. A method for improving a production, growth, or biostimulant parameter of an agricultural crop, the method comprising:
   a) applying a powdered microbial seed coating composition to a seed of the agricultural crop before planting, wherein the composition comprises microalgae and mycorrhizae.
97. The method of any one of embodiments 94-96, wherein the composition comprises multiple species of microalgae.
98. The method of any one of embodiments 94-97, wherein the composition comprises microalgae from a phylum selected from the list consisting of: Chlorophyta, Cryptophyta, Cyanophyta, Euglenophyta, Heterokontophyta, or Rhodophyta.
99. The method of any one of embodiments 94-98, wherein the composition comprises microalgae from a genus selected from the list consisting of: Chlorella, Scenedesmus, Nannochloropsis, Muriellopsis, Isochrysis, Tisochrysis, Desmodesmus, Haematococcus, Arthrospira, and Anabaena.
100. The method of any one of embodiments 94-99, wherein the microalgae are dried and ground.
101. The method of any one of embodiments 94-100, wherein the microalgae comprises whole-cell microalgae powder.
102. The method of any one of embodiments 94-101, wherein the microalgae comprises whole-cell microalgae powder having an average particle size of about 100-1,000 microns.
103. The method of any one of embodiments 94-102, wherein the composition comprises about 10-90% w/w microalgae.
104. The method of any one of embodiments 94-103, wherein the composition comprises about 80% w/w microalgae.
105. The method of any one of embodiments 94-104, wherein the mycorrhizae comprise a combination of ectomycorrhizae and endomycorrhizae.
106. The method of any one of embodiments 94-105, wherein the mycorrhizae comprise predominantly endomycorrhizae.
107. The method of any one of embodiments 94-106, wherein the mycorrhizae comprise more than about 90% endomycorrhizae.
108. The method of any one of embodiments 94-107, wherein the composition comprises about 10-90% w/w mycorrhizae.
109. The method of any one of embodiments 94-108, wherein the composition comprises about 20% w/w mycorrhizae.
110. The method of any one of embodiments 94-109, wherein the mycorrhizae comprise 100-10,000 spores/gram.
111. The method of any one of embodiments 94-110, wherein the composition comprises about 10-9,000 spores of mycorrhizae per gram of composition.
112. The method of any one of embodiments 94-111, wherein the mass ratio of microalgae to mycorrhizae is about 2:1, 3:1, 4:1, or 5:1.
113. The method of any one of embodiments 94-112, wherein the mass ratio of microalgae to mycorrhizae is about 4:1.
114. The method of any one of embodiments 94-113, wherein the composition comprises a diazotrophic bacterium.
115. The method of any one of embodiments 94-114, wherein the composition comprises a bacterium of the genus Anabaena, Azoarcus, Azorhizobium, Azospirillum, Azotobacter, Bacillus, Bradyrhizobium, Burkholderia, Clostridium, Frankia, Gluconacetobacter, Herbaspirillum, Klebsiella, Mesorhizobium, Nitrosospira, Nostoc, Paenibacillus, Parasponia, Pseudomonas, Rhizobium, Rhodobacter, Sinorhizobium, Spirillum, or Xanthomonus.
116. The method of any one of embodiments 94-115, wherein the composition comprises a bacterium of the genus Azospirillum, Rhizobium, or Bradyrhizobium.
117. The method of any one of embodiments 94-116, wherein the composition comprises a bacterium of the species Bradyrhizobium japonicum.
118. The method of any one of embodiments 94-117, wherein the composition comprises a binder.
119. The method of any one of embodiments 94-118, wherein the composition comprises a binder, and wherein the binder is a hydrocolloid binder.
120. The method of any one of embodiments 94-119, wherein the composition comprises a binder, and wherein the binder comprises about 10-30% of the composition.
121. The method of any one of embodiments 94-120, wherein the method improves the agricultural crop's survival against abiotic stress.
122. The method of any one of embodiments 94-121, wherein the method improves the agricultural crop's survival against abiotic stress, and wherein the abiotic stress is selected from temperature stress, water stress, and salt stress.
123. The method of any one of embodiments 94-122, wherein the method improves a growing parameter, production parameter, or biostimulant parameter of the agricultural crop.
124. The method of any one of embodiments 94-123, wherein the method improves a growing parameter, production parameter, or biostimulant parameter of the agricultural crop, and wherein the parameter is selected from the list consisting of: biomass, number of roots, root mass, number of secondary roots, uniformity of flowering, yield, productivity, chlorophyl content, carotenoid profile, water absorption capacity, nutrient absorption, and degree of inoculation by diazotrophic bacteria.
125. The method of any one of embodiments 94-124, wherein the agricultural crop is a monocot or dicot.
126. The method of any one of embodiments 94-125, wherein the agricultural crop is an agronomical crop, horticultural crop, or ornamental plant.
127. The method of any one of embodiments 94-126, wherein the method comprises applying about 50-200 g of the composition per quantity of seeds to be planted in one hectare.
128. The method of any one of embodiments 94-127, wherein the method comprises applying an amount of composition sufficient to deliver about 1,000 to 1,000,000 spores per quantity of seeds to be planted in one hectare.
129. The method of any one of embodiments 94-128, wherein the method increases a production, growth, or biostimulant parameter is selected from the list consisting of: biomass, number of roots, root mass, number of secondary roots, uniformity of flowering, yield, productivity, chlorophyl content, carotenoid profile, water absorption capacity, nutrient absorption, and degree of inoculation by diazotrophic bacteria.
130. The method of any one of embodiments 94-129, wherein the method increases the yield of the agricultural crop.
131. The method of any one of embodiments 94-130, wherein the method increases the yield of the agricultural crop compared to a control agricultural crop whose seeds were not treated with the composition prior to planting.
132. The method of any one of embodiments 94-131, wherein the method increases the yield of the agricultural crop by 2-20% compared to a control agricultural crop whose seeds were not treated with the composition prior to planting.

What is claimed is:

1. An agricultural granule composition, comprising:
a) microalgae;
b) mycorrhizae; and
c) a carrier granule.

2. The composition of claim 1, wherein the composition comprises multiple species of microalgae, optionally wherein:
a) the composition comprises microalgae from a phylum selected from the list consisting of: Chlorophyta, Cryptophyta, Cyanophyta, Euglenophyta, Heterokontophyta, or Rhodophyta; and/or
b) the composition comprises microalgae from a genus selected from the list consisting of: Chlorella, Scenedesmus, Nannochloropsis, Muriellopsis, Isochrysis, Tisochrysis, Desmodesmus, Haematococcus, Arthrospira, and Anabaena.

3. The composition of claim 1, wherein the microalgae:
a) are dried and/or lysed.
b) are in the form of a digested microalgae solution (“DMS”) or whole-cell microalgae powder.

4. The composition of claim 1, wherein the composition comprises:
a) about 0.5% to 5.0% w/w DMS, optionally wherein the DMS comprises about 5% to 15% w/w dry matter;
b) about 0.05% to 5% w/w microalgae dry matter as a percentage of composition dry weight;
c) about 0.5-5.0% w/w mycorrhizae as a percentage of the composition dry weight; and/or
d) 500-500,000 spores of mycorrhizae per kg of composition.

5. The composition of claim 1, wherein the mycorrhizae comprise:
a) 100-10,000 spores/gram:
b) a combination of ectomycorrhizae and endomycorrhizae; and/or
c) predominantly endomycorrhizae, optionally more than about 90% endomycorrhizae.

6. The composition of claim 1, wherein the carrier granule is zeolite or bentonite, optionally wherein the carrier granule is zeolite, optionally wherein the dry weight of the composition comprises greater than 80% w/w zeolite.

7. The composition of claim 1, wherein the composition is applied to an agricultural crop, optionally wherein:
a) the agricultural crop is a monocot or a dicot: and/or
b) the agricultural crop is selected from the list consisting of agronomical crops, horticultural crops, and ornamental crops.

8. The composition of claim 1, wherein application of the composition to an agricultural crop results in an increase in a growth, production, or biostimulant parameter of the agricultural crop in comparison to a control agricultural crop without the composition, optionally wherein:
a) the application occurs during or soon after planting: and/or
b) the parameter is selected from the group consisting of: yield, height, nutrient concentration, and chlorophyl content of leaves.

9. The composition of claim 1, wherein application of the composition to an agricultural crop results in an increase in the height of the agricultural crop and/or a nutrient concentration within the agricultural crop in comparison to a control agricultural crop without the composition, optionally wherein the nutrient is selected from the group consisting of: nitrogen content of leaves, magnesium content of roots, manganese content of roots, copper content of roots, and potassium content of roots.

10. The composition of claim 1, wherein the combination of the microalgae, mycorrhizae, and zeolite components of the compositions produces an improvement on a growth, production, or biostimulant parameter of an agricultural crop after application, optionally wherein the improvement is greater than that observed for any one or two of the components alone and/or the improvement is synergistic.

11. A method for improving a production, growth, or biostimulant parameter of an agricultural crop, the method comprising:
a) applying the composition of claim 1 to the agricultural crop: or
b) applying an agricultural granule composition to the agricultural crop, the composition comprising microalgae, mycorrhizae, and a carrier granule, optionally wherein the production, growth, or biostimulant parameter is yield.

12. The method of claim 11, wherein the composition comprises multiple species of microalgae, optionally wherein:
a) the composition comprises microalgae from a phylum selected from the list consisting of: Chlorophyta, Cryptophyta, Cyanophyta, Euglenophyta, Heterokontophyta, or Rhodophytal and/or
b) the composition comprises microalgae from a genus selected from the list consisting of: Chlorella, Scenedesmus, Nannochloropsis, Muriellopsis, Isochrysis, Tisochrysis, Desmodesmus, Haematococcus, Arthrospira, and Anabaena.

13. The method of claim 11, wherein the microalgae are:
a) dried and/or lysed.
b) are in the form of a digested microalgae solution (“DMS”) or whole-cell microalgae powder.

14. The method of claim 11, wherein the composition comprises:
a) about 0.5% to 5.0% w/w DMS, optionally wherein the DMS comprises about 5% to 15% w/w dry matter; and/or
b) about 0.05% to 0.5% w/w microalgae dry matter as a percentage of composition dry weight.
c) about 0.5-5.0% w/w mycorrhizae as a percentage of composition dry weight: and/or
d) 500-500,000 spores of mycorrhizae per kg of composition.

15. The method of claim 11, wherein the mycorrhizae comprise:
a) 100-10,000 spores/gram:
b) a combination of ectomycorrhizae and endomycorrhizae; and/or
c) predominantly endomycorrhizae, optionally more than about 90% endomycorrhizae.

16. The method of claim 11, wherein the carrier granule is zeolite or bentonite and/or wherein the dry weight of the composition comprises greater than 80% w/w carrier granule.

17. The method of claim 11, wherein the agricultural crop:
a) is a monocot or a dicot; and/or
b) is selected from the list consisting of agronomical crops, horticultural crops, and ornamental crops.

18. The method of claim 11, wherein application of the composition to the agricultural crop results in:
a) an increase in a growth, production, or biostimulant parameter of the agricultural crop in comparison to a control agricultural crop without the composition, optionally wherein:
i) the application occurs during or soon after planting: and/or
ii) the parameter is selected from the group consisting of: yield, height, nutrient concentration, and chlorophyl content of leaves; and/or
b) an increase in the height of the agricultural crop and/or a nutrient concentration within the agricultural crop in comparison to a control agricultural crop without the composition, optionally wherein the nutrient is selected from the group consisting of: nitrogen content of leaves, magnesium content of roots, manganese content of roots, copper content of roots, and potassium content of roots.

19. The method of claim 11, wherein the combination of the microalgae, mycorrhizae, and zeolite components of the compositions produces an improvement on a growth, production, or biostimulant parameter of the agricultural crop after application, wherein the improvement is greater than that observed for any one or two of the components alone and/or wherein the improvement is synergistic.

20. The method of claim 11, wherein the composition is applied to the soil around the agricultural crop, optionally wherein:
a) the composition is applied via mechanized and/or hand broadcast.
b) the composition is applied at a rate of about 5-15 kg/ha or about 100,000-2,000,000 mycorrhizae spores/ha.

21. A powdered microbial seed coating composition, comprising:
a) microalgae: and
b) mycorrhizae and/or Rhizobium.

22. The composition of claim 21, wherein the composition comprises multiple species of microalgae, optionally wherein:
a) the composition comprises microalgae from a phylum selected from the list consisting of: Chlorophyta, Cryptophyta, Cyanophyta, Euglenophyta, Heterokontophyta, or Rhodophyta: and/or
b) the composition comprises microalgae from a genus selected from the list consisting of: Chlorella, Scenedesmus, Nannochloropsis, Muriellopsis, Isochrysis, Tisochrysis, Desmodesmus, Haematococcus, Arthrospira, and Anabaena.

23. The composition of claim 21, wherein the microalgae are:
a) dried and ground; and/or
b) comprise whole-cell microalgae powder, optionally wherein the microalgae powder has an average particle size of about 100-1,000 microns.

24. The composition of claim 21, wherein the composition comprises:
a) about 10-90% w/w microalgae, optionally about 80% w/w microalgae:
b) about 10-90% w/w mycorrhizae, optionally about 20% w/w mycorrhizae: and/or
c) about 10-9,000 spores of mycorrhizae per gram of composition.

25. The composition of claim 21, wherein the mycorrhizae comprise:
a) a combination of ectomycorrhizae and endomycorrhizae.
b) predominantly endomycorrhizae, optionally more than about 90% endomycorrhizae; and/or
c) 100-10,000 spores/gram.

26. The composition of claim 21, wherein the mass ratio of microalgae to mycorrhizae is about 2:1, 3:1, 4:1, or 5:1, optionally about 4:1.

27. The composition of claim 21, wherein the composition comprises:
a) a diazotrophic bacterium:
b) a bacterium of the genus Anabaena, Azoarcus, Azorhizobium, Azospirillum, Azotobacter, Bacillus, Bradyrhizobium, Burkholderia, Clostridium, Frankia, Gluconacetobacter, Herbaspirillum, Klebsiella, Mesorhizobium, Nitrosospira, Nostoc, Paenibacillus, Parasponia, Pseudomonas, Rhizobium, Rhodobacter, Sinorhizobium, Spirillum, or Xanthomonus;
c) a bacterium of the genus Azospirillum, Rhizobium, or Bradyrhizobium; and/or
d) a bacterium of the species Bradyrhizobium japonicum.

28. The composition of claim 21, wherein the composition comprises a binder, optionally wherein:
a) the binder is a hydrocolloid binder; and/or
b) the binder comprises about 10-30% of the composition.

29. The composition of claim 21, wherein application of the composition to a seed of an agricultural crop prior to planting improves:
a) the agricultural crop's survival against abiotic stress, optionally wherein the abiotic stress is selected from temperature stress, water stress, and salt stress: and/or
b) a growing parameter, production parameter, or biostimulant parameter of the agricultural crop, optionally wherein the parameter is selected from the list consisting of: biomass, number of roots, root mass, number of secondary roots, uniformity of flowering, yield, productivity, chlorophyl content, carotenoid profile, water absorption capacity, nutrient absorption, and degree of inoculation by diazotrophic bacteria.

30. The composition of claim 21, wherein the composition is comprised as a coating on a seed from an agricultural crop, optionally wherein:
a) the agricultural crop is a monocot or dicot: and/or
b) the agricultural crop is an agronomical crop, horticultural crop, or ornamental plant.

31. A seed of an agricultural crop comprising a composition according to any one of claims 21-30.

32. A method for improving a production, growth, or biostimulant parameter of an agricultural crop, the method comprising:
a) applying the composition of claim 21 to a seed of the agricultural crop prior to planting: or
b) applying a powdered microbial seed coating composition to a seed of the agricultural crop before planting, wherein the composition comprises microalgae and mycorrhizae, optionally wherein the production, growth, or biostimulant parameter is yield.

33. The method of claim 32, wherein the composition comprises multiple species of microalgae, optionally wherein:
a) the composition comprises microalgae from a phylum selected from the list consisting of: Chlorophyta, Cryptophyta, Cyanophyta, Euglenophyta, Heterokontophyta, or Rhodophyta: and/or
b) the composition comprises microalgae from a genus selected from the list consisting of: Chlorella, Scenedesmus, Nannochloropsis, Muriellopsis, Isochrysis, Tisochrysis, Desmodesmus, Haematococcus, Arthrospira, and Anabaena.

34. The method of claim 32, wherein the microalgae:
a) are dried and ground; and/or
b) comprise whole-cell microalgae powder, optionally wherein the whole-cell microalgae powder has an average particle size of about 100-1,000 microns.

35. The method of claim 32, wherein the composition comprises:
a) about 10-90% w/w microalgae, optionally wherein the composition comprises about 80% w/w microalgae:
b) about 10-90% w/w mycorrhizae, optionally about 20% w/w mycorrhizae; and/or
c) about 10-9,000 spores of mycorrhizae per gram of composition.

36. The method of claim 32, wherein the mycorrhizae comprise:
a) a combination of ectomycorrhizae and endomycorrhizae;
b) predominantly endomycorrhizae, optionally more than about 90% endomycorrhizae; and/or
c) 100-10,000 spores/gram

37. The method of claim 32, wherein the mass ratio of microalgae to mycorrhizae is about 2:1, 3:1, 4:1, or 5:1, optionally about 4:1.

38. The method of claim 32, wherein the composition comprises:
a) a diazotrophic bacterium;
b) a bacterium of the genus Anabaena, Azoarcus, Azorhizobium, Azospirillum, Azotobacter, Bacillus, Bradyrhizobium, Burkholderia, Clostridium, Frankia, Gluconacetobacter, Herbaspirillum, Klebsiella, Mesorhizobium, Nitrosospira, Nostoc, Paenibacillus, Parasponia, Pseudomonas, Rhizobium, Rhodobacter, Sinorhizobium, Spirillum, or Xanthomonus;
c) a bacterium of the genus Azospirillum, Rhizobium, or Bradyrhizobium; and/or
d) a bacterium of the species Bradyrhizobium japonicum.

39. The method of claim 32, wherein the composition comprises a binder, optionally wherein:
a) the binder is a hydrocolloid binder; and/or
b) the binder comprises about 10-30% of the composition.

40. The method of claim 32, wherein the agricultural crop:
a) is a monocot or dicot; and/or
b) is an agronomical crop, horticultural crop, or ornamental plant.

41. The method of claim 32, wherein the method comprises applying:
a about 50-200 g of the composition per quantity of seeds to be planted in one hectare; and/or
b) an amount of composition sufficient to deliver about 1,000 to 1,000,000 spores per quantity of seeds to be planted in one hectare.

42. The method of claim 32, wherein the method:
a) improves the agricultural crop's survival against abiotic stress, optionally wherein the abiotic stress is selected from temperature stress, water stress, and salt stress:
b) improves a growing parameter, production parameter, or biostimulant parameter of the agricultural crop, optionally wherein the parameter is selected from the list consisting of: biomass, number of roots, root mass, number of secondary roots, uniformity of flowering, yield, productivity, chlorophyl content, carotenoid profile, water absorption capacity, nutrient absorption, and degree of inoculation by diazotrophic bacteria:
c) increases a production, growth, or biostimulant parameter is selected from the list consisting of: biomass, number of roots, root mass, number of secondary roots, uniformity of flowering, yield, productivity, chlorophyl content, carotenoid profile, water absorption capacity, nutrient absorption, and degree of inoculation by diazotrophic bacteria:
d) increases the yield of the agricultural crop:
e) increases the yield of the agricultural crop compared to a control agricultural crop whose seeds were not treated with the composition prior to planting: and/or
f) increases the yield of the agricultural crop by 2-20% compared to a control agricultural crop whose seeds were not treated with the composition prior to planting.

43. A method for reducing reliance on exogenous macronutrient supplementation in an agricultural crop, optionally while increasing yield, the method comprising:
a) applying an agricultural granule composition to the agricultural crop, the composition comprising microalgae, mycorrhizae, and a carrier granule; or
b) applying a composition according to any one of claims 1-10 to the agricultural crop.

44. A method for increasing the soil content of a macronutrient, optionally organic carbon, optionally while reducing exogenous application of the macronutrient to an agricultural crop, the method comprising:
a) applying an agricultural granule composition to the agricultural crop, the composition comprising microalgae, mycorrhizae, and a carrier granule: or
b) applying a composition according to any one of claims 1-10 to the agricultural crop.

45. The method of claim 43 or 44, wherein the macronutrient is nitrogen or phosphorous.

46. The method of claim 43 or 44, wherein the method produces:
a) the same or higher yield of the agricultural crop compared to a control crop without application of the agricultural granule composition;
b) the same or higher yield of the agricultural crop with less than the recommended dose of the macronutrient compared to a control crop with the recommended dose of the macronutrient, wherein the composition is not applied to the control crop; and/or
c) the same or higher yield of the agricultural crop with only about 70%, 80% or 90% of the recommended dose of the macronutrient compared to a control crop with 100% of the recommended dose of the macronutrient, wherein the composition is not applied to the control crop.

47. The method of claim 43 or 44, wherein the composition comprises multiple species of microalgae, optionally wherein:
a) the composition comprises microalgae from a phylum selected from the list consisting of: Chlorophyta, Cryptophyta, Cyanophyta, Euglenophyta, Heterokontophyta, or Rhodophyta; and/or
b) the composition comprises microalgae from a genus selected from the list consisting of: Chlorella, Scenedesmus, Nannochloropsis, Muriellopsis, Isochrysis, Tisochrysis, Desmodesmus, Haematococcus, Arthrospira, and Anabaena.

48. The method of claim 43 or 44, wherein the microalgae:
a) are dried and/or lysed; and/or
b) are in the form of a digested microalgae solution (“DMS”) or whole-cell microalgae powder.

49. The method of claim 43 or 44, wherein:
a) the composition comprises about 0.5% to 5.0% w/w DMS, optionally wherein the DMS comprises about 5% to 15% w/w dry matter;
b) the dry weight of the composition comprises about 0.05% to 0.5% w/w microalgae dry matter;
c) the dry weight of the composition comprises about 0.5-5.0% w/w mycorrhizae; and/or
d) the composition comprises 500-500,000 spores of mycorrhizae per kg of composition.

50. The method of claim 43 or 44, wherein the mycorrhizae comprise
a) 100-10,000 spores/gram;
b) a combination of ectomycorrhizae and endomycorrhizae.
c) the mycorrhizae comprise predominantly endomycorrhizae, optionally more than about 90% endomycorrhizae.

51. The method of claim 43 or 44, wherein:
a) the carrier granule is zeolite or bentonite; and/or
b) the dry weight of the composition comprises greater than 80% w/w carrier granule.

52. The method of claim 43 or 44, wherein the agricultural crop is a monocot or a dicot and/or the agricultural crop is selected from the list consisting of agronomical crops, horticultural crops, and ornamental crops.
